(19) United States
(12) Patent Application Publication
(10) Pub. No.: US 2024/0077809 A1
(43) Pub. Date: Mar. 7, 2024

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Tomoya SASAKI, Kanagawa (JP); Ryosuke FUJII, Kanagawa (JP); Hiroko KOBAYASHI, Kanagawa (JP); Yuto OKAZAKI, Kanagawa (JP); Kosuke NARITA, Kanagawa (JP)

(73) Assignee: FUJIFILM Business Innovation Corp., Tokyo (JP)

(21) Appl. No.: 18/300,348

(22) Filed: Apr. 13, 2023

(30) Foreign Application Priority Data
Aug. 9, 2022 (JP) 2022-127392

(51) Int. Cl. G03G 5/05; G03G 5/047; G03G 21/18

(52) U.S. Cl. CPC G03G 5/056; G03G 5/047; G03G 5/0564; G03G 21/1814

(57) ABSTRACT

An electrophotographic photoreceptor includes a conductive substrate, and a lamination type photosensitive layer disposed on the conductive substrate and including a charge generation layer and a charge transport layer, in which the charge transport layer contains a charge transport material, at least one of a polyester resin (PEz) or a polycarbonate resin (PCz) that has at least one of a structure (Z1) represented by Formula (Z1) or a structure (Z2) represented by Formula (Z2) at at least one terminal, and a resin (X) that has at least one of a unit (X1) represented by Formula (X1) or a unit (X2) represented by Formula (X2), a mass proportion of the resin (X) in a total amount of the polyester resin (PEz), the polycarbonate resin (PCz), and the resin (X) in the charge transport layer is 0.5% by mass or greater and 30% by mass or less, and the charge transport layer has an average thickness of greater than 30 μm and less than 50 μm,

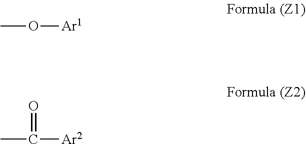

in Formula (Z1), Ar¹ represents an aromatic ring that may have a substituent,
in Formula (Z2), Ar² represents an aromatic ring that may have a substituent,

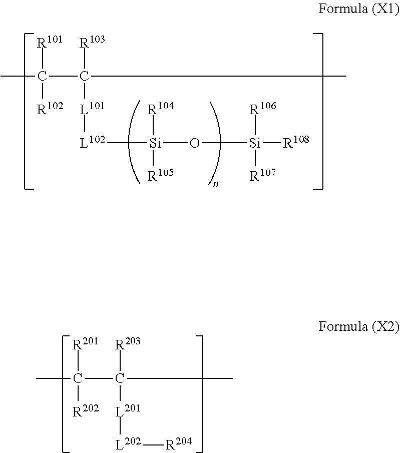

in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), R¹⁰⁹, R¹¹⁰, R¹¹¹, R¹², and R¹¹³ each independently represent an alkyl group having 1 or more and 5 or less carbon atoms, and m represents an integer of 0 or greater and 20 or less,
in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

### CROSS-REFERENCE TO RELATED APPLICATIONS

This application is based on and claims priority under 35 USC 119 from Japanese Patent Application No. 2022-127392 filed Aug. 9, 2022.

### BACKGROUND

### (i) Technical Field

The present invention relates to an electrophotographic photoreceptor, a process cartridge, and an image forming apparatus.

### (ii) Related Art

JP2012-208268A discloses an electrophotographic photoreceptor which includes a photosensitive layer containing a resin having a polysiloxane component and a polyarylate resin as binder resins and contains 0.08% by mass or greater of free silicone with respect to the amount of the binder resins.

JP2014-137561A describes an electrophotographic photoreceptor including a surface layer that contains (a) at least one resin selected from the group consisting of a polycarbonate resin having no siloxane structure at a terminal and a polyester resin having no siloxane structure at a terminal, (0) at least one resin selected from the group consisting of a polycarbonate resin having a siloxane structure at a terminal, a polyester resin having a siloxane structure at a terminal, and an acrylic resin having a siloxane structure at a terminal, and (y) at least one compound selected from the group consisting of propylene carbonate, γ-butyrolactone, δ-valerolactone, and F-caprolactone.

### SUMMARY

Aspects of non-limiting embodiments of the present disclosure relate to an electrophotographic photoreceptor that includes a lamination type photosensitive layer and has excellent image quality stability as compared with an electrophotographic photoreceptor in which the mass proportion of a resin (X) in the total amount of a polyester resin (PEz), a polycarbonate resin (PCz), and the resin (X) in a charge transport layer is less than 0.5% by mass or greater than 30% by mass.

Aspects of non-limiting embodiments of the present disclosure relate to an electrophotographic photoreceptor that includes a single layer type photosensitive layer and has excellent image quality stability as compared with an electrophotographic photoreceptor in which the mass proportion of a resin (X) in the total amount of a polyester resin (PEz), a polycarbonate resin (PCz), and the resin (X) in a single layer type photosensitive layer is less than 0.5% by mass or greater than 30% by mass.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

Specific means for achieving the above-described object includes the following aspect.

According to an aspect of the present disclosure, there is provided an electrophotographic photoreceptor including: a conductive substrate; and a lamination type photosensitive layer disposed on the conductive substrate and including a charge generation layer and a charge transport layer, in which the charge transport layer contains a charge transport material, at least one of a polyester resin (PEz) or a polycarbonate resin (PCz) that has at least one of a structure (Z1) represented by Formula (Z1) or a structure (Z2) represented by Formula (Z2) at at least one terminal, and a resin (X) that has at least one of a unit (X1) represented by Formula (X1) or a unit (X2) represented by Formula (X2), a mass proportion of the resin (X) in a total amount of the polyester resin (PEz), the polycarbonate resin (PCz), and the resin (X) in the charge transport layer is 0.5% by mass or greater and 30% by mass or less, and the charge transport layer has an average thickness of greater than 30 μm and less than 50 μm.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to a first exemplary embodiment;

FIG. 2 is a partial cross-sectional view showing an example of a layer configuration of an electrophotographic photoreceptor according to a second exemplary embodiment;

FIG. 3 is a schematic configuration view showing an example of an image forming apparatus according to the present exemplary embodiment; and

FIG. 4 is a schematic configuration view showing another example of an image forming apparatus according to the present exemplary embodiment.

### DETAILED DESCRIPTION

Hereinafter, exemplary embodiments of the present disclosure will be described. The following descriptions and examples merely illustrate the exemplary embodiments, and do not limit the scope of the exemplary embodiments.

In the present disclosure, a numerical range shown using “to” indicates a range including numerical values described before and after “to” as a minimum value and a maximum value.

In a numerical range described in a stepwise manner in the present disclosure, an upper limit value or a lower limit value described in a certain numerical range may be replaced with an upper limit value or a lower limit value in another numerical range described in a stepwise manner. Further, in a numerical range described in the present disclosure, an upper limit value or a lower limit value described in the numerical range may be replaced with a value shown in Examples.

In the present disclosure, the meaning of the term “step” includes not only an independent step but also a step whose intended purpose is achieved even in a case where the step is not clearly distinguished from other steps.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of kinds of substances corresponding to each component. In the present disclosure, in a case where a plurality of kinds of substances corresponding to each component in a composition are present, the amount of each component in the composition indicates the total amount of the plurality of kinds of substances present in the composition unless otherwise specified.

In the present disclosure, each component may include a plurality of kinds of particles corresponding to each component. In a case where a plurality of kinds of particles corresponding to each component are present in a composition, the particle diameter of each component indicates the value of a mixture of the plurality of kinds of particles present in the composition, unless otherwise specified.

In the present disclosure, an alkyl group and an alkylene group are any of linear, branched, or cyclic unless otherwise specified.

In the present disclosure, a hydrogen atom in an organic group, an aromatic ring, a linking group, an alkyl group, an alkylene group, an aryl group, an aralkyl group, an alkoxy group, or an aryloxy group may be substituted with a halogen atom.

Electrophotographic Photoreceptor

The present disclosure provides a first exemplary embodiment and a second exemplary embodiment of an electrophotographic photoreceptor (hereinafter, also referred to as “photoreceptor”).

The photoreceptor according to the first exemplary embodiment includes a conductive substrate, and a lamination type photosensitive layer disposed on the conductive substrate and including a charge generation layer and a charge transport layer. The charge transport layer of the photoreceptor according to the first exemplary embodiment contains a charge transport material, a polyester resin (PEz) and/or a polycarbonate resin (PCz), and a resin (X).

The photoreceptor according to the first exemplary embodiment may further include other layers (for example, an undercoat layer and an interlayer) in addition to the lamination type photosensitive layer. In the photoreceptor according to the first exemplary embodiment, for example, it is preferable that the charge transport layer is a surface layer.

The photoreceptor according to the second exemplary embodiment includes a conductive substrate, and a single layer type photosensitive layer disposed on the conductive substrate. The single layer type photosensitive layer of the photoreceptor according to the second exemplary embodiment contains a charge transport material, a polyester resin (PEz) and/or a polycarbonate resin (PCz), and a resin (X).

The photoreceptor according to the second exemplary embodiment may further include other layers (for example, an undercoat layer and an interlayer) in addition to the single layer type photosensitive layer. In the photoreceptor according to the second exemplary embodiment, for example, it is preferable that the single layer type photosensitive layer is a surface layer.

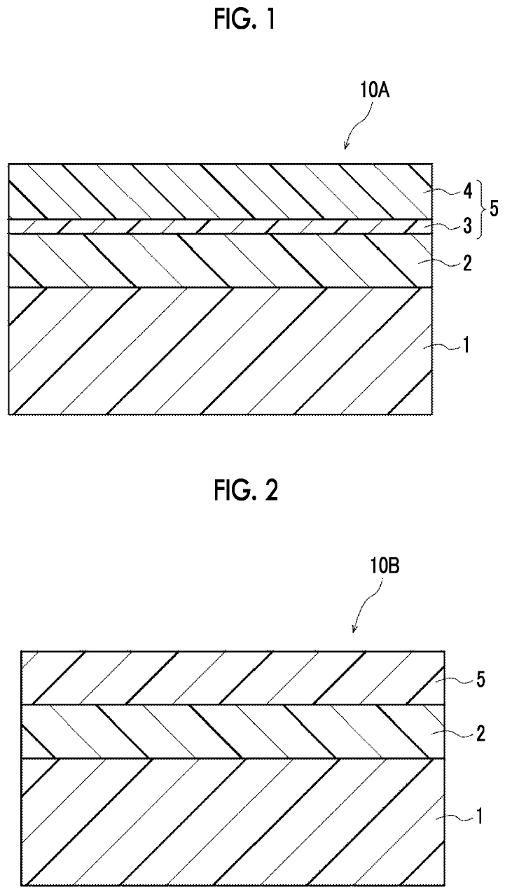

FIG. 1 is a partial cross-sectional view schematically showing an example of the layer configuration of the photoreceptor according to the first exemplary embodiment. A photoreceptor 10A shown in FIG. 1 includes a lamination type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation type photosensitive layer). The photoreceptor 10A may include an interlayer (not shown) between the undercoat layer 2 and the charge generation layer 3.

FIG. 2 is a partial cross-sectional view schematically showing an example of the layer configuration of the photoreceptor according to the second exemplary embodiment. A photoreceptor 10B shown in FIG. 2 includes a single layer type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5.

Hereinafter, in a case of description common to the first exemplary embodiment and the second exemplary embodiment, both exemplary embodiments are collectively referred to as the present exemplary embodiment. In a case where items common to the charge transport layer and the single layer type photosensitive layer are described, both layers are collectively referred to as a photosensitive layer.

The polyester resin and the polycarbonate resin are used as the main resin of the photosensitive layer of the photoreceptor. It is known that in a photoreceptor having this photosensitive layer as the outermost layer, a lubricant is added to the photosensitive layer for the purpose of decreasing the friction coefficient of the photoreceptor in order to improve the life (abrasion life) affected by abrasion of the photoreceptor and maintain the image quality stability.

An object for adding a lubricant to the photosensitive layer serving as the outermost layer is to maintain the state in which the lubricant is constantly present on the outermost surface even in a case where the photoreceptor is abraded. In a case where a material having a siloxane structure or a long-chain alkyl structure is added as the lubricant, it is substantial to impart compatibility with the main resin to the material.

In regard to this object, it is known that a lubricating resin obtained by introducing a siloxane structure or a long-chain alkyl structure to a side chain of a polyester resin or a polycarbonate resin of the same type as the main resin is added to the photosensitive layer. In this case, for example, the compatibility between the main resin and the lubricating resin is satisfactory, and the siloxane structure or the long-chain alkyl structure can be constantly exposed to the outermost surface even in a case where the photosensitive layer is abraded.

A satisfactory lubricating function is exhibited in a case where the siloxane structure and the long-chain alkyl structure of the lubricating resin are collected, but the siloxane structure and the long-chain alkyl structure of the lubricating resin are dispersed in a case where the compatibility between the main resin and the lubricating resin is extremely satisfactory, and thus the lubricating effect is insufficient and the image quality stability is degraded. The concept of image quality stability includes a difference in image quality due to a difference in the temperature, the humidity, or the image density and a difference in image quality before and after image formation over a long period of time. The image quality stability is affected by the abrasion resistance of the photoreceptor and changes in lubricity and electrical properties during the process in which the photoreceptor is gradually abraded.

Further, in a case where the compatibility between the main resin and the lubricating resin is extremely satisfactory, the film hardness which is the original function of the main resin and the dispersibility of the charge transport material are degraded, and the abrasion resistance and the electrical properties are degraded. This effect is notable in a case where the layer thickness of the photosensitive layer is set to greater than 30 μm (less than 50 μm) in order to increase the abrasion life. As a result, the image quality stability is degraded.

On the contrary, the reason why the image quality stability is improved by the present exemplary embodiment is assumed as follows.

A resin (X) having at least one of a siloxane structure or a long-chain alkyl structure, which is a vinyl-based resin of a type different from the type of a polyester resin or a polycarbonate resin serving as the main resin, is used as the lubricating resin. The resin (X) is not extremely dispersed in the main resin while appropriately exhibiting compatibility with the main resin, and the siloxane structure and/or the long-chain alkyl structure of the resin (X) is collected. In this manner, the original lubricating function of the resin (X) is sufficiently exhibited, and the image quality stability is improved.

Further, in the present exemplary embodiment, the main resin is defined as a polyester resin (PEz) and/or a polycarbonate resin (PCz) that has an aromatic ring at a terminal. In this manner, the interaction between the main resins and the interaction between the main resin and the charge transport material are improved, the film hardness and the dispersibility of the charge transport material are improved, the abrasion resistance and the electrical properties are improved, and thus the image quality stability is improved.

With the above-described configuration, even in a case where the average layer thickness of the photosensitive layer is set to greater than 30 μm (less than 50 μm), the lubricity can be improved further than in the related art and thus the image quality stability can be improved without degrading the abrasion resistance and the electrical properties.

In the first exemplary embodiment, the average thickness of the charge transport layer is greater than 30 μm and less than 50 μm.

In a case where the average thickness of the charge transport layer is 30 μm or less, the life of the photoreceptor is shortened due to abrasion of the outer peripheral surface of the photoreceptor. From the viewpoint of suppressing this phenomenon, the average thickness of the charge transport layer is greater than 30 μm, for example, preferably greater than 32 μm, more preferably greater than 35 μm, and still more preferably greater than 38 μm.

In a case where the average thickness of the charge transport layer is 50 μm or greater, the residual potential of the electrical properties is extremely high. From the viewpoint of suppressing this phenomenon, the average thickness of the charge transport layer is less than 50 m, for example, preferably less than 48 μm, more preferably less than 45 μm, and still more preferably less than 43 am.

In the second exemplary embodiment, the average thickness of the single layer type photosensitive layer is greater than 30 μm and less than 50 μm.

In a case where the average thickness of the single layer type photosensitive layer is 30 μm or less, the life of the photoreceptor is shortened due to abrasion of the outer peripheral surface of the photoreceptor. From the viewpoint of suppressing this phenomenon, the average thickness of the single layer type photosensitive layer is greater than 30 μm, for example, preferably greater than 32 μm, more preferably greater than 35 μm, and still more preferably greater than 38 μm.

In a case where the average thickness of the single layer type photosensitive layer is 50 μm or greater, the residual potential of the electrical properties is extremely high. From the viewpoint of suppressing this phenomenon, the average thickness of the single layer type photosensitive layer is less than 50 μm, for example, preferably less than 48 μm, more preferably less than 45 μm, and still more preferably less than 43 μm.

In the first exemplary embodiment, the average thickness of the charge transport layer is a value obtained by measuring the layer thicknesses at a total of 40 sites, 10 sites evenly divided in the axial direction and 4 equal parts (by 90°) in the circumferential direction of the photoreceptor, using an eddy current film thickness meter and arithmetically averaging the obtained thicknesses.

In the second exemplary embodiment, the average thickness of the single layer type photosensitive layer is acquired similarly by replacing “charge transport layer” described above with “single layer type photosensitive layer”.

In the first exemplary embodiment, the mass proportion of the resin (X) in the total amount of the polyester resin (PEz), the polycarbonate resin (PCz), and the resin (X) in the charge transport layer is 0.5% by mass or greater and 30% by mass or less.

In a case where the mass proportion of the resin (X) in the charge transport layer is less than 0.5% by mass, the lubricity due to the resin (X) is insufficient. From the viewpoint of suppressing this phenomenon, the mass proportion of the resin (X) is 0.5% by mass or greater, for example, preferably 1% by mass or greater, more preferably 5% by mass or greater, and still more preferably 10% by mass or greater.

In a case where the mass proportion of the resin (X) in the charge transport layer is greater than 30% by mass, the abrasion resistance of the layer is insufficient. From the viewpoint of suppressing this phenomenon, the mass proportion of the resin (X) is 30% by mass or less, for example, preferably 28% by mass or less, more preferably 25% by mass or less, and still more preferably 20% by mass or less.

In the second exemplary embodiment, the mass proportion of the resin (X) in the total amount of the polyester resin (PEz), the polycarbonate resin (PCz), and the resin (X) in the single layer type photosensitive layer is 0.5% by mass or greater and 30% by mass or less.

In a case where the mass proportion of the resin (X) in the single layer type photosensitive layer is less than 0.5% by mass, the lubricity due to the resin (X) is insufficient. From the viewpoint of suppressing this phenomenon, the mass proportion of the resin (X) is 0.5% by mass or greater, for example, preferably 1% by mass or greater, more preferably 5% by mass or greater, and still more preferably 10% by mass or greater.

In a case where the mass proportion of the resin (X) in the single layer type photosensitive layer is greater than 30% by mass, the abrasion resistance of the layer is insufficient. From the viewpoint of suppressing this phenomenon, the mass proportion of the resin (X) is 30% by mass or less, for example, preferably 28% by mass or less, more preferably 25% by mass or less, and still more preferably 20% by mass or less.

In the first exemplary embodiment, in a case where the mass of the resin (X) in the charge transport layer is defined as M_{X} and the total mass of a structure (Z1) and a structure (Z2) of the polyester resin (PEz) and the polycarbonate resin (PCz) in the charge transport layer is defined as M_{Z}, for example, M_{Z}/M_{X}×100 is preferably 1 or greater and 400 or less. In a case where M_{Z}/M_{X}×100 is 1 or greater, the film hardness and the dispersibility of the charge transport material are improved, the abrasion resistance and the electrical properties are improved, and thus the image quality stability is improved. In a case where M_{Z}/M_{X}×100 is 400 or less, the lubricating function due to the resin (X) is sufficiently exhibited, and the image quality stability is improved.

From the above-described viewpoint, M_{Z}/M_{X}×100 is, for example, more preferably 2 or greater and 200 or less and still more preferably 5 or greater and 150 or less.

In the second exemplary embodiment, in a case where the mass of the resin (X) in the single layer type photosensitive layer is defined as M_{X} and the total mass of a structure (Z1) and a structure (Z2) of the polyester resin (PEz) and the polycarbonate resin (PCz) in the single layer type photosensitive layer is defined as M_{Z}, for example, M_{Z}/M_{X}×100 is preferably 1 or greater and 400 or less. In a case where M_{Z}/M_{X}×100 is 1 or greater, the film hardness and the dispersibility of the charge transport material are improved, the abrasion resistance and the electrical properties are improved, and thus the image quality stability is improved. In a case where M_{Z}/M_{X}×100 is 400 or less, the lubricating function due to the resin (X) is sufficiently exhibited, and the image quality stability is improved.

From the above-described viewpoint, M_{Z}/M_{X}×100 is, for example, more preferably 2 or greater and 200 or less and still more preferably 5 or greater and 150 or less.

Hereinafter, the polyester resin (PEz), the polycarbonate resin (PCz), and the resin (X) in the photosensitive layer, and each layer of the photoreceptor will be described in detail.

Structure (Z1) and Structure (Z2)

First, the structure (Z1) and the structure (Z2) of the polyester resin (PEz) and the polycarbonate resin (PCz) will be described.

The structure (Z1) is a structure represented by Formula (Z1) and positioned at a terminal of the resin. The structure (Z2) is a structure represented by Formula (Z2) and positioned at a terminal of the resin.

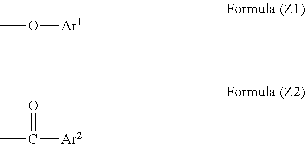

In Formula (Z1), Ar¹ represents an aromatic ring that may have a substituent.

In Formula (Z2), Ar² represents an aromatic ring that may have a substituent.

The aromatic ring of the aromatic ring that may have a substituent in the structure (Z1) and the structure (Z2) may be any of a monocycle or a polycycle. Examples of the aromatic ring include a benzene ring, a naphthalene ring, an anthracene ring, and a phenanthrene ring. Among these, for example, a benzene ring and a naphthalene ring are preferable, and a benzene ring is more preferable.

The hydrogen atom of the aromatic ring may be substituted with an alkyl group, an aryl group, an aralkyl group, an alkoxy group, an aryloxy group, a halogen atom, lower alkyl ester, an aryl ester, or the like. As the substituent used to substitute the aromatic ring, for example, an alkyl group having 1 or more and 5 or less carbon atoms, an alkoxy group having 1 or more and 5 or less carbon atoms, or a phenyl group is preferable, an alkyl group having 1 or more and 3 or less carbon atoms or an alkoxy group having 1 or more and 3 or less carbon atoms is more preferable, a methyl group or a methoxy group is still more preferable, and a methyl group is particularly preferable.

It is preferable that the structure (Z1) is, for example, a structure (Z1-1) represented by Formula (Z1-1). It is preferable that the structure (Z2) is, for example, a structure (Z2-1) represented by Formula (Z2-1).

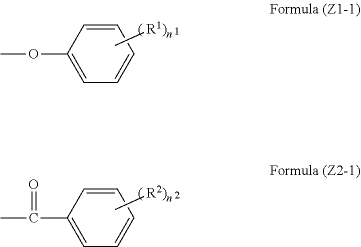

In Formula (Z1-1), n¹ represents an integer of 0 or greater and 5 or less, and n¹ number of R¹'s each independently represent an alkyl group having 1 or more and 5 or less carbon atoms, an alkoxy group having 1 or more and 5 or less carbon atoms, or a phenyl group.

In Formula (Z2-1), n² represents an integer of 0 or greater and 5 or less, and n² number of R²'s each independently represent an alkyl group having 1 or more and 5 or less carbon atoms, an alkoxy group having 1 or more and 5 or less carbon atoms, or a phenyl group.

n¹ represents an integer of 0 or greater and 5 or less, for example, preferably an integer of 1 or greater and 4 or less, more preferably an integer of 1 or greater and 3 or less, and still more preferably 2 or 3.

The alkyl group having 1 or more and 5 or less carbon atoms as R¹ may be any of linear, branched, or cyclic. The number of carbon atoms of the alkyl group is, for example, preferably 1 or more and 4 or less, more preferably 1 or more and 3 or less, still more preferably 1 or 2, and particularly preferably 1.

The alkyl group in the alkoxy group having 1 or more and 5 or less carbon atoms as R¹ may be any of linear, branched, or cyclic. The number of carbon atoms of the alkyl group in the alkoxy group having 1 or more and 5 or less carbon atoms is, for example, preferably 1 or more and 4 or less, more preferably 1 or more and 3 or less, still more preferably 1 or 2, and particularly preferably 1.

Examples of the linear alkoxy group having 1 or more and 5 or less carbon atoms include a methoxy group, an ethoxy group, an n-propoxy group, an n-butoxy group, and an n-pentyloxy group.

Examples of the branched alkoxy group having 3 or more and 5 or less carbon atoms include an isopropoxy group, an isobutoxy group, a sec-butoxy group, a tert-butoxy group, an isopentyloxy group, a neopentyloxy group, and a tert-pentyloxy group.

Examples of the cyclic alkoxy group having 3 or more and 5 or less carbon atoms include a cyclopropoxy group, a cyclobutoxy group, and a cyclopentyloxy group.

n¹ number of R¹'s each independently represent, for example, preferably a linear or branched alkyl group having 1 or more and 5 or less carbon atoms and more preferably a methyl group, an ethyl group, an n-propyl group, an isopropyl group, an n-butyl group, an isobutyl group, a sec-butyl group, or a tert-butyl group.

n² represents an integer of 0 or greater and 5 or less, for example, preferably an integer of 0 or greater and 3 or less, more preferably an integer of 0 or greater and 2 or less, and still more preferably 0 or 1.

The alkyl group having 1 or more and 5 or less carbon atoms as R² may be any of linear, branched, or cyclic. The number of carbon atoms of the alkyl group is, for example, preferably 1 or more and 4 or less, more preferably 1 or more and 3 or less, still more preferably 1 or 2, and particularly preferably 1.

The alkyl group in the alkoxy group having 1 or more and 5 or less carbon atoms as R² may be any of linear, branched, or cyclic. The number of carbon atoms of the alkyl group in the alkoxy group having 1 or more and 5 or less carbon atoms is, for example, preferably 1 or more and 4 or less, more preferably 1 or more and 3 or less, still more preferably 1 or 2, and particularly preferably 1.

Examples of the linear alkoxy group having 1 or more and 5 or less carbon atoms include a methoxy group, an ethoxy group, an n-propoxy group, an n-butoxy group, and an n-pentyloxy group.

Examples of the branched alkoxy group having 3 or more and 5 or less carbon atoms include an isopropoxy group, an isobutoxy group, a sec-butoxy group, a tert-butoxy group, an isopentyloxy group, a neopentyloxy group, and a tert-pentyloxy group.

Examples of the cyclic alkoxy group having 3 or more and 5 or less carbon atoms include a cyclopropoxy group, a cyclobutoxy group, and a cyclopentyloxy group.

n² number of R²'s each independently represent, for example, preferably a linear or branched alkyl group having 1 or more and 5 or less carbon atoms and more preferably a methyl group, an ethyl group, an n-propyl group, an isopropyl group, an n-butyl group, an isobutyl group, a sec-butyl group, or a tert-butyl group.

Specific examples of the structure (Z1-1) will be shown below, but the structure (Z1-1) is not limited thereto.

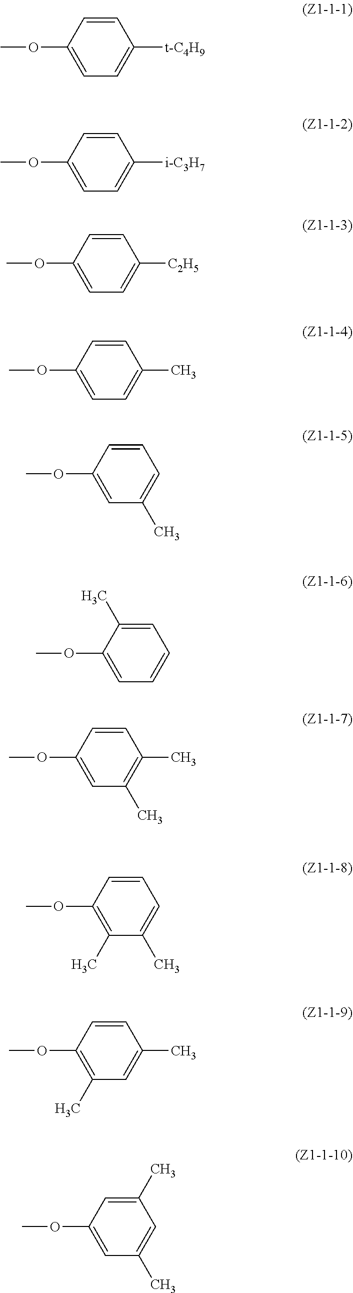

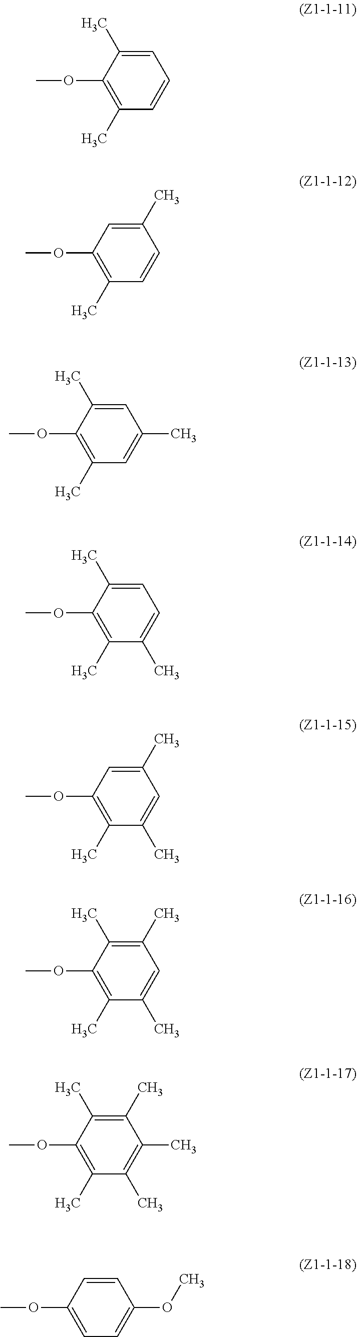

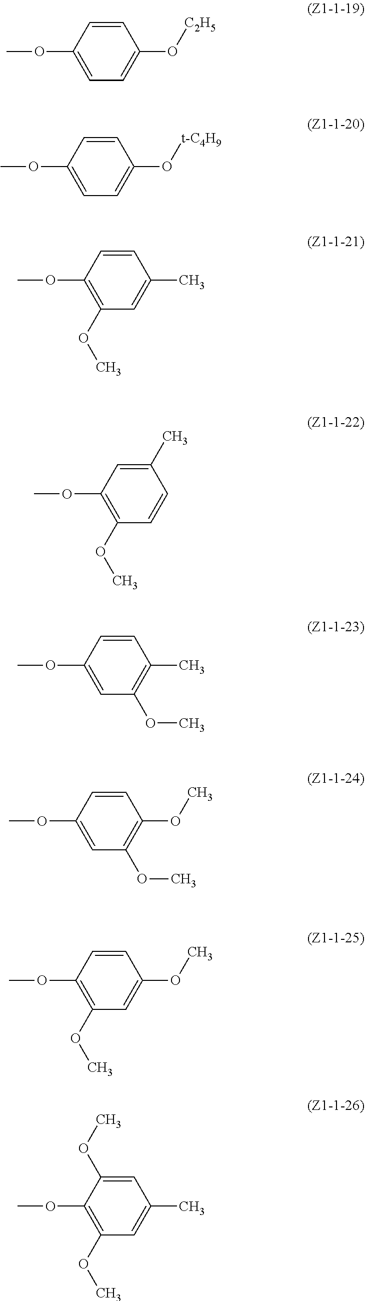

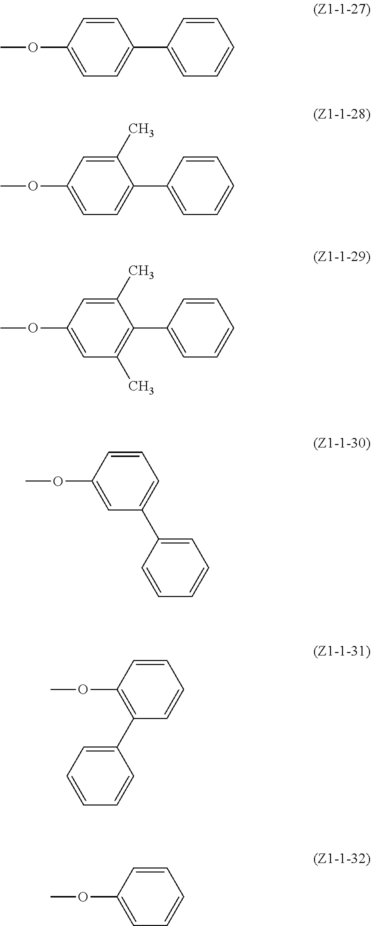

Specific examples of the structure (Z1) other than the structure (Z1-1) will be shown below, but the structure (Z1) is not limited thereto.

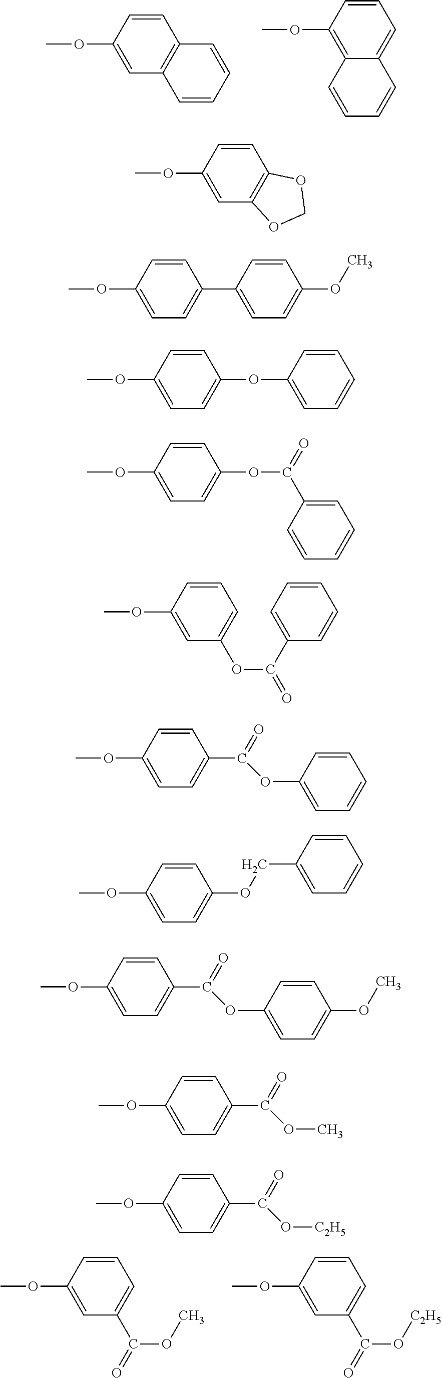

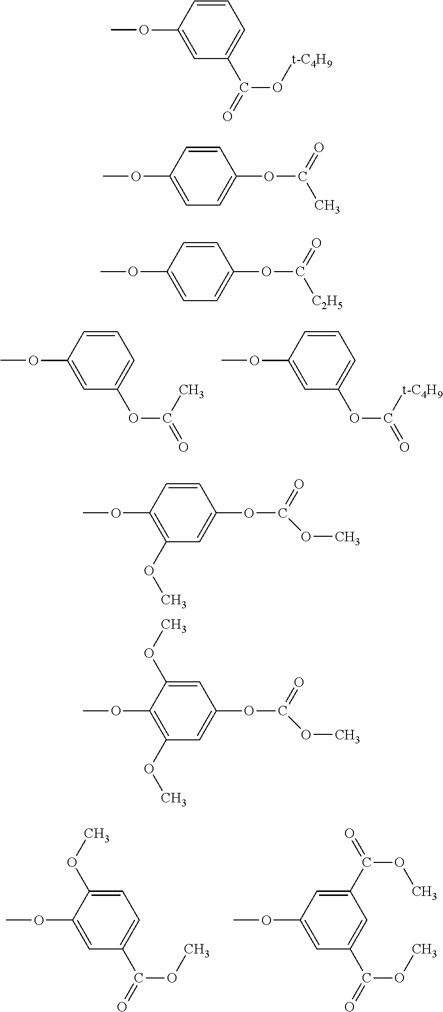

Specific examples of the structure (Z2-1) will be shown below, but the structure (Z2-1) is not limited thereto.

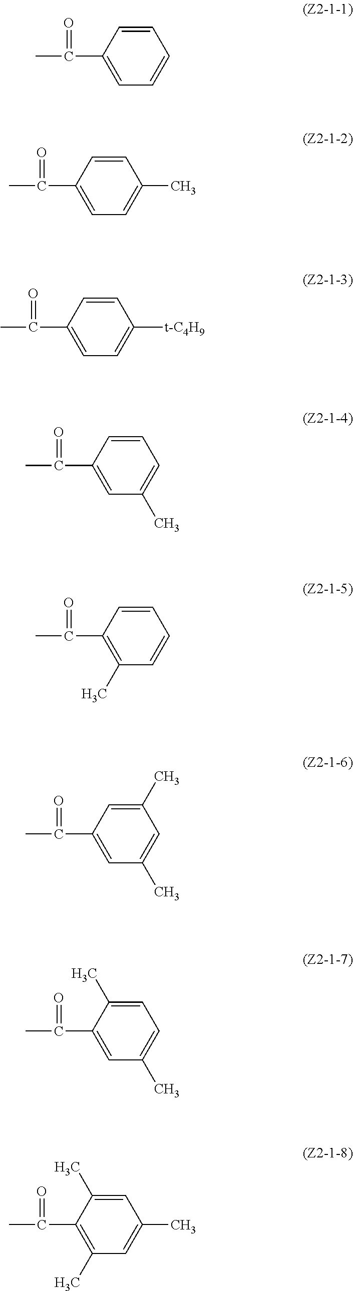

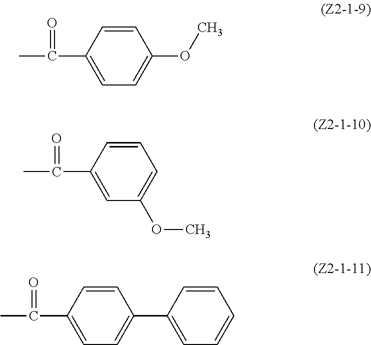

Specific examples of the structure (Z2) other than the structure (Z2-1) will be shown below, but the structure (Z2) is not limited thereto.

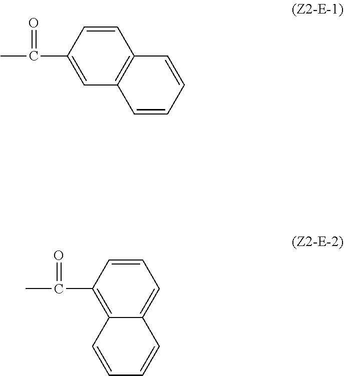

Examples of a method of introducing the structure (Z1) or the structure (Z2) to a terminal of the polyester resin (PEz) or the polycarbonate resin (PCz) include a method of using a terminal-sealing agent having an aromatic ring or a molecular weight modifier having an aromatic ring during the production of the resin. Examples of the terminal-sealing agent having an aromatic ring or the molecular weight modifier having an aromatic ring include monohydric phenol, monovalent aromatic carboxylic acid, and monovalent aromatic acid chloride.

Examples of the monohydric phenol include phenol, o-cresol, m-cresol, p-cresol, o-ethylphenol, m-ethylphenol, p-ethylphenol, o-propylphenol, m-propylphenol, p-propylphenol, o-tert-butylphenol, m-tert-butylphenol, p-tert-butylphenol, pentylphenol, hexylphenol, octylphenol, nonylphenol, a 2,6-dimethylphenol derivative, a 2-methylphenol derivative, o-phenylphenol, m-phenylphenol, p-phenylphenol, o-methoxyphenol, m-methoxyphenol, p-methoxyphenol, 2,3,5-trimethylphenol, 2,3,6-trimethylphenol, 2,3-xylenol, 2,4-xylenol, 2,5-xylenol, 2,6-xylenol, 3,4-xylenol, 3,5-xylenol, 2-phenyl-2-(4-hydroxyphenyl)propane, 2-phenyl-2-(2-hydroxyphenyl)propane, and 2-phenyl-2-(3-hydroxyphenyl)propane.

Examples of the monovalent aromatic carboxylic acid include benzoic acid, toluic acid, and p-tert-butylbenzoic acid.

Examples of the monovalent aromatic acid chloride include benzoyl chloride, benzoic acid chloride, methanesulfonyl chloride, phenylchloroformate, benzenesulfonyl chloride, benzenesulfinyl chloride, and benzenephosphonyl chloride.

Polyester Resin (PEz)

The polyester resin (PEz) has at least one of the structure (Z1) or the structure (Z2) at least one terminal. Details of the structure (Z1) and the structure (Z2) are as described above.

The polyester resin (PEz) may have the structure (Z1) or the structure (Z2) at only one terminal, may have the structure (Z1) at one terminal and the structure (Z2) at the other terminal, or may have the structure (Z1) at both terminals or the structure (Z2) at both terminals.

In a case where the polyester resin (PEz) has the structure (Z1), for example, it is preferable that the structure (Z1) is bonded to the dicarboxylic acid unit.

In a case where the polyester resin (PEz) has the structure (Z2), for example, it is preferable that the structure (Z2) is bonded to the diol unit.

The total mass proportion of the structure (Z1) and the structure (Z2) in the entire polyester resin (PEz) is, for example, preferably 0.1% by mass or greater and 10% by mass or less, more preferably 0.2% by mass or greater and 7% by mass or less, and still more preferably 0.4% by mass or greater and 5% by mass or less.

As the polyester resin (PEz), for example, a polyester resin (1z) having a dicarboxylic acid unit (A) and a diol unit (B) and having at least one of the structure (Z1) or the structure (Z2) at at least one terminal is preferable.

In a case where the polyester resin (1z) has the structure (Z1), for example, it is preferable that the structure (Z1) is bonded to the dicarboxylic acid unit (A).

In a case where the polyester resin (1z) has the structure (Z2), for example, it is preferable that the structure (Z2) is bonded to the diol unit (B).

The total mass proportion of the structure (Z1) and the structure (Z2) in the entire polyester resin (1z) is, for example, preferably 0.1% by mass or greater and 10% by mass or less, more preferably 0.2% by mass or greater and 7% by mass or less, and 0.4% by mass or greater and 5% by mass or less.

The dicarboxylic acid unit (A) is a constitutional unit represented by Formula (A).

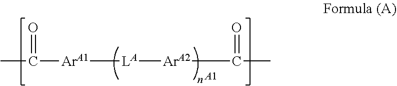

In Formula (A), Ar^{A1} and Ar^{A2} each independently represent an aromatic ring that may have a substituent, L^{A} represents a single bond or a divalent linking group, and n^{A1} represents 0, 1, or 2.

The aromatic ring as Ar^{A1} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{A1} may be substituted with an alkyl group, an aryl group, an aralkyl group, an alkoxy group, an aryloxy group, a halogen atom, or the like. As the substituent in a case where the aromatic ring as Ar^{A1} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The aromatic ring of Ar^{A2} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{A2} may be substituted with an alkyl group, an aryl group, an aralkyl group, an alkoxy group, an aryloxy group, a halogen atom, or the like. As the substituent in a case where the aromatic ring as Ar^{A2} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

In a case where L^{A} represents a divalent linking group, examples of the divalent linking group include an oxygen atom, a sulfur atom, and —C(Ra¹)(Ra²)—. Here, Ra¹ and Ra² each independently represent a hydrogen atom, an alkyl group having 1 or more and 10 or less carbon atoms, an aryl group having 6 or more and 12 or less carbon atoms, or an aralkyl group having 7 or more and 20 or less carbon atoms, and Ra¹ and Ra² may be bonded to each other to form a cyclic alkyl group.

The alkyl group having 1 or more and 10 or less carbon atoms as Ra¹ and Ra² may be any of linear, branched, or cyclic. The number of carbon atoms of the alkyl group is, for example, preferably 1 or more and 6 or less, more preferably 1 or more and 4 or less, and still more preferably 1 or 2.

The aryl group having 6 or more and 12 or less carbon atoms as Ra¹ and Ra² may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Ra¹ and Ra² may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2.

The aryl group in the aralkyl group having 7 or more and 20 or less carbon atoms as Ra¹ and Ra² may be any of a monocycle or a polycycle. The number of carbon atoms of the aryl group is, for example, preferably 6 or more and 10 or less and more preferably 6.

It is preferable that the dicarboxylic acid unit (A) includes, for example, at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), and a dicarboxylic acid unit (A4) represented Formula (A4).

The dicarboxylic acid unit (A) includes, for example, more preferably at least one selected from the group consisting of a dicarboxylic acid unit (A2), a dicarboxylic acid unit (A3), and a dicarboxylic acid unit (A4) and still more preferably a dicarboxylic acid unit (A2).

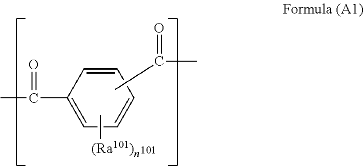

In Formula (A1), n¹⁰¹ represents an integer of 0 or greater and 4 or less, and n¹⁰¹ number of Ra¹⁰¹'s each independently represent an alkyl group having 1 or more and 10 or less carbon atoms, an aryl group having 6 or more and 12 or less carbon atoms, or an alkoxy group having 1 or more and 6 or less carbon atoms.

n¹⁰¹ represents, for example, preferably 0, 1, or 2, more preferably 0 or 1, and still more preferably 0.

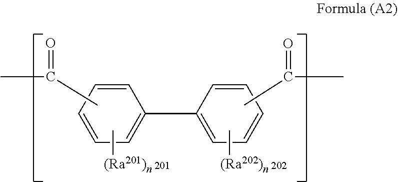

In Formula (A2), n²⁰¹ and n²⁰² each independently represent an integer of 0 or greater and 4 or less, and n²⁰¹ number of Ra²⁰¹'s and n²⁰² number of Ra²⁰²'s each independently represent an alkyl group having 1 or more and 10 or less carbon atoms, an aryl group having 6 or more and 12 or less carbon atoms, or an alkoxy group having 1 or more and 6 or less carbon atoms.

n²⁰¹ represents, for example, preferably 0, 1, or 2, more preferably 0 or 1, and still more preferably 0.

n²⁰² represents, for example, preferably 0, 1, or 2, more preferably 0 or 1, and still more preferably 0.

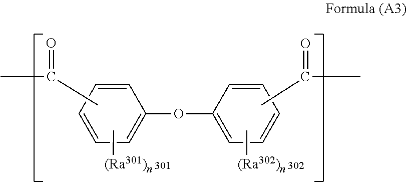

In Formula (A3), n³⁰¹ and n³⁰² each independently represent an integer of 0 or greater and 4 or less, and n³⁰¹ number of Ra³⁰¹'s and n³⁰² number of Ra³⁰²'s each independently represent an alkyl group having 1 or more and 10 or less carbon atoms, an aryl group having 6 or more and 12 or less carbon atoms, or an alkoxy group having 1 or more and 6 or less carbon atoms.

n³⁰¹ represents, for example, preferably 0, 1, or 2, more preferably 0 or 1, and still more preferably 0.

n³⁰² represents, for example, preferably 0, 1, or 2, more preferably 0 or 1, and still more preferably 0.

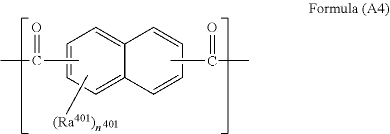

In Formula (A4), n⁴⁰¹ represents an integer of 0 or greater and 6 or less, and n⁴⁰¹ number of Ra⁴⁰¹'s each independently represent an alkyl group having 1 or more and 10 or less carbon atoms, an aryl group having 6 or more and 12 or less carbon atoms, or an alkoxy group having 1 or more and 6 or less carbon atoms.

n⁴⁰¹ represents, for example, preferably an integer of 0 or greater and 4 or less, more preferably 0, 1, or 2, and still more preferably 0.

The specific forms and the preferable forms of Ra¹⁰¹ in Formula (A1), Ra²⁰¹ and Ra²⁰² in Formula (A2), Ra³⁰¹ and Ra³⁰² in Formula (A3), and Ra⁴⁰¹ in Formula (A4) are the same as each other, and hereinafter, Ra³⁰¹, Ra²⁰¹, Ra²⁰², Ra³⁰¹, Ra³⁰², and Ra⁴⁰¹ will be collectively referred to as “Ra”.

The alkyl group having 1 or more and 10 or less carbon atoms as Ra may be any of linear, branched, or cyclic. The number of carbon atoms of the alkyl group is, for example, preferably 1 or more and 6 or less, more preferably 1 or more and 4 or less, and still more preferably 1 or 2.

Examples of the linear alkyl group having 1 or more and 10 or less carbon atoms include a methyl group, an ethyl group, an n-propyl group, an n-butyl group, an n-pentyl group, an n-hexyl group, an n-heptyl group, an n-octyl group, an n-nonyl group, and an n-decyl group.

Examples of the branched alkyl group having 3 or more and 10 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, and a tert-decyl group.

Examples of the cyclic alkyl group having 3 or more and 10 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and polycyclic (for example, bicyclic, tricyclic, or spirocyclic) alkyl groups to which these monocyclic alkyl groups are linked.

The aryl group having 6 or more and 12 or less carbon atoms as Ra may be any of a monocycle or a polycycle. The number of carbon atoms of the aryl group is, for example, preferably 6 or more and 10 or less and more preferably 6.

Examples of the aryl group having 6 or more and 12 or less carbon atoms include a phenyl group, a biphenyl group, a 1-naphthyl group, and a 2-naphthyl group.

The alkyl group in the alkoxy group having 1 or more and 6 or less carbon atoms as Ra may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Hereinafter, dicarboxylic acid units (A1-1) to (A1-9) are shown as specific examples of the dicarboxylic acid unit (A1). The dicarboxylic acid unit (A1) is not limited thereto.

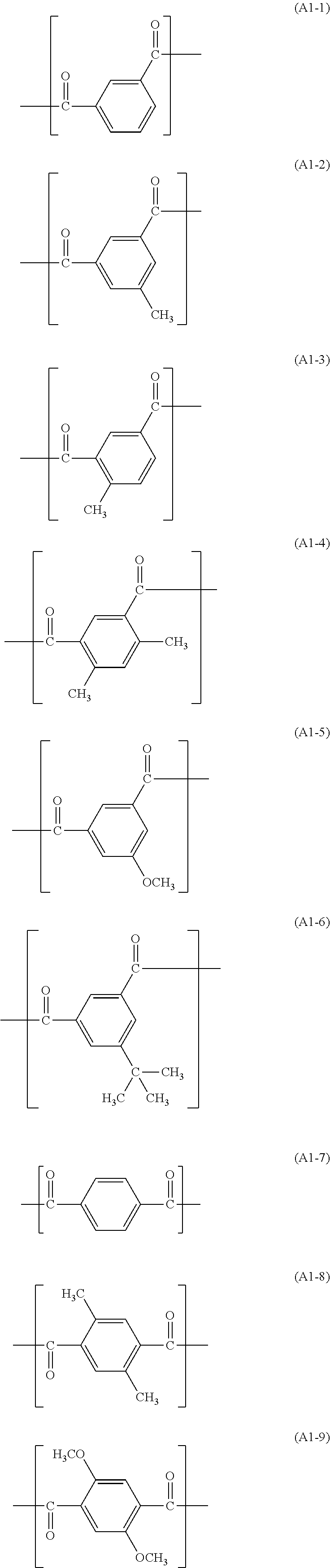

Hereinafter, dicarboxylic acid units (A2-1) to (A2-3) are shown as specific examples of the dicarboxylic acid unit (A2). The dicarboxylic acid unit (A2) is not limited thereto.

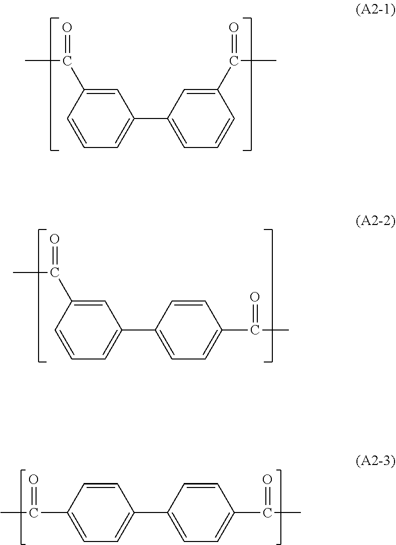

Hereinafter, dicarboxylic acid units (A3-1) and (A3-2) are shown as specific examples of the dicarboxylic acid unit (A3). The dicarboxylic acid unit (A3) is not limited thereto.

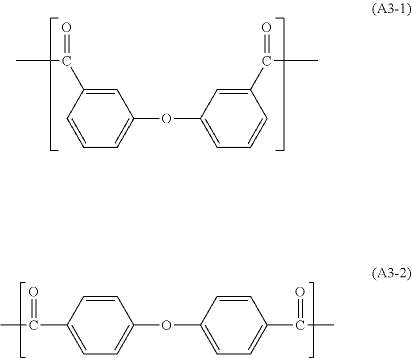

Hereinafter, dicarboxylic acid units (A4-1) to (A4-3) are shown as specific examples of the dicarboxylic acid unit (A4). The dicarboxylic acid unit (A4) is not limited thereto.

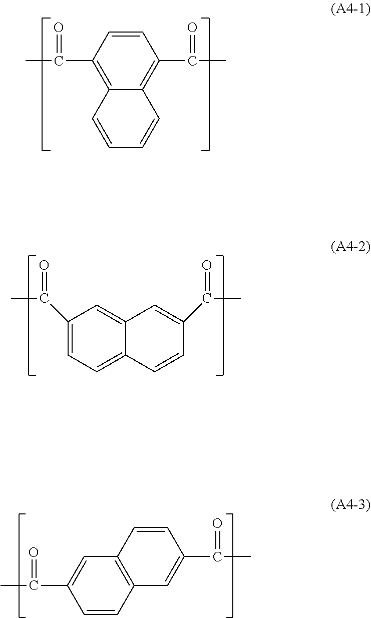

The polyester resin has, for example, preferably at least one selected from the group consisting of (A1-1), (A1-7), (A2-3), (A3-2), and (A4-3), more preferably at least one selected from the group consisting of (A2-3), (A3-2), and (A4-3), and still more preferably at least (A2-3) as the dicarboxylic acid unit (A).

The total mass proportion of the dicarboxylic acid units (A1) to (A4) in the polyester resin (1) is, for example, preferably 15% by mass or greater and 60% by mass or less.

In a case where the total mass proportion of the dicarboxylic acid units (A1) to (A4) is 15% by mass or greater, the abrasion resistance of the photosensitive layer is enhanced. From this viewpoint, the total mass proportion of the dicarboxylic acid units (A1) to (A4) is, for example, more preferably 20% by mass or greater and still more preferably 25% by mass or greater.

In a case where the total mass proportion of the dicarboxylic acid units (A1) to (A4) is 60% by mass or less, peeling of the photosensitive layer can be suppressed. From this viewpoint, the total mass proportion of the dicarboxylic acid units (A1) to (A4) is, for example, more preferably 55% by mass or less and still more preferably 50% by mass or less.

The dicarboxylic acid units (A1) to (A4) contained in the polyester resin (1z) may be used alone or in combination of two or more kinds thereof.

Examples of other dicarboxylic acid units (A) in addition to the dicarboxylic acid units (A1) to (A4) include aliphatic dicarboxylic acid (such as oxalic acid, malonic acid, maleic acid, fumaric acid, citraconic acid, itaconic acid, glutaconic acid, succinic acid, alkenyl succinic acid, adipic acid, and sebacic acid) units, alicyclic dicarboxylic acid (such as cyclohexanedicarboxylic acid) units, and lower (for example, having 1 or more and 5 or less carbon atoms) alkyl ester units thereof. These dicarboxylic acid units contained in the polyester resin (1z) may be used alone or in combination of two or more kinds thereof.

The dicarboxylic acid unit (A) contained in the polyester resin (1z) may be used alone or in combination of two or more kinds thereof.

The diol unit (B) is a constitutional unit represented by Formula (B).

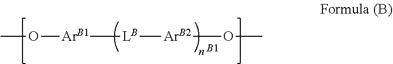

In Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2. Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

The aromatic ring as Ar^{B1} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{B1} may be substituted with an alkyl group, an aryl group, an aralkyl group, an alkoxy group, an aryloxy group, a halogen atom, or the like. As the substituent in a case where the aromatic ring as Ar^{B1} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The aromatic ring as Ar^{B2} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{B2} may be substituted with an alkyl group, an aryl group, an aralkyl group, an alkoxy group, an aryloxy group, a halogen atom, or the like. As the substituent in a case where the aromatic ring as Ar^{B2} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The alkyl group having 1 or more and 20 or less carbon atoms as Rb¹ and Rb² may be linear, branched, or cyclic. The number of carbon atoms of the alkyl group is, for example, preferably 1 or more and 18 or less, more preferably 1 or more and 14 or less, and still more preferably 1 or more and 10 or less.

The aryl group having 6 or more and 12 or less carbon atoms as Rb¹ and Rb² may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Rb¹ and Rb² may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2.

The aryl group in the aralkyl group having 7 or more and 20 or less carbon atoms as Rb¹ and Rb² may be any of a monocycle or a polycycle. The number of carbon atoms of the aryl group is, for example, preferably 6 or more and 10 or less and more preferably 6.

It is preferable that the diol unit (B) includes, for example, at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).

The diol unit (B) includes, for example, more preferably at least one selected from the group consisting of a diol unit (B1) represented by Formula (B1), a diol unit (B2) represented by Formula (B2), a diol unit (B4) represented by Formula (B4), a diol unit (B5) represented by Formula (B5), and a diol unit (B6) represented by Formula (B6), still more preferably at least one selected from the group consisting of a diol unit (B1) represented by Formula (B1), a diol unit (B2) represented by Formula (B2), a diol unit (B5) represented by Formula (B5), and a diol unit (B6) represented by Formula (B6), even still more preferably at least one selected from the group consisting of a diol unit (B1) represented by Formula (B1), a diol unit (B2) represented by Formula (B2), and a diol unit (B6) represented by Formula (B6), and most preferably at least one selected from the group consisting of a diol unit (B1) represented by Formula (B1) and a diol unit (B2) represented by Formula (B2).

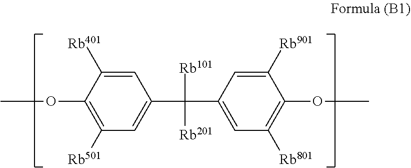

In Formula (B1), Rb¹⁰¹ represents a branched alkyl group having 4 or more and 20 or less carbon atoms, Rb²⁰¹ represents a hydrogen atom or an alkyl group having 1 or more and 3 or less carbon atoms, and Rb⁴⁰¹, Rb⁵⁰¹, Rb⁸⁰¹, and Rb⁹⁰¹ each independently represent a hydrogen atom, an alkyl group having 1 or more and 4 or less carbon atoms, an alkoxy group having 1 or more and 6 or less carbon atoms, or a halogen atom.

The number of carbon atoms of the branched alkyl group having 4 or more and 20 or less carbon atoms as Rb¹⁰¹ is, for example, preferably 4 or more and 16 or less, more preferably 4 or more and 12 or less, and still more preferably 4 or more and 8 or less. Specific examples of Rb¹⁰¹ include an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

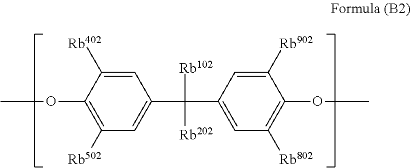

In Formula (B2), Rb¹⁰² represents a linear alkyl group having 4 or more and 20 or less carbon atoms, Rb²⁰² represents a hydrogen atom or an alkyl group having 1 or more and 3 or less carbon atoms, and Rb⁴⁰², Rb⁵⁰², Rb⁸⁰², and Rb⁹⁰² each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 4 or more and 20 or less carbon atoms as Rb¹⁰² is, for example, preferably 4 or more and 16 or less, more preferably 4 or more and 12 or less, and still more preferably 4 or more and 8 or less. Specific examples of Rb¹⁰² include an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

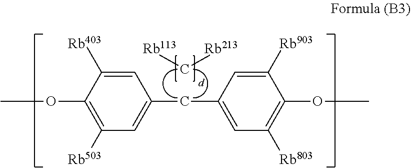

In Formula (B3), Rb¹¹³ and Rb²¹³ each independently represent a hydrogen atom, a linear alkyl group having 1 or more and 3 or less carbon atoms, an alkoxy group having 1 or more and 4 or less carbon atoms, or a halogen atom, d represents an integer of 7 or greater and 15 or less, and Rb⁴⁰³, Rb⁵⁰³, Rb⁸⁰³, and Rb⁹⁰³ each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 1 or more and 3 or less carbon atoms as Rb¹¹³ and Rb²¹³ is, for example, preferably 1 or 2 and more preferably 1. Specific examples of such a group include a methyl group, an ethyl group, and an n-propyl group.

The alkyl group in the alkoxy group having 1 or more and 4 or less carbon atoms as Rb¹¹³ and Rb²¹³ may be any of linear, branched, or cyclic. The number of carbon atoms of the alkyl group in the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹³ and Rb²¹³ include a fluorine atom, a chlorine atom, a bromine atom, and an iodine atom.

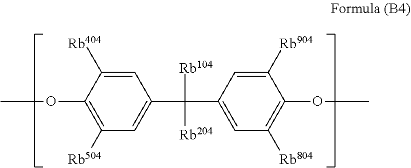

In Formula (B4), Rb¹⁰⁴ and Rb²⁰⁴ each independently represent a hydrogen atom, an alkyl group having 1 or more and 3 or less carbon atoms, and Rb⁴⁰⁴, Rb⁵⁰⁴, Rb⁸⁰⁴, and Rb⁹⁰⁴ each independently represent a hydrogen atom, an alkyl group having 1 or more and 4 or less carbon atoms, an alkoxy group having 1 or more and 6 or less carbon atoms, or a halogen atom.

The alkyl group having 1 or more and 3 or less carbon atoms as Rb¹⁰⁴ may be any of linear, branched, or cyclic. The number of carbon atoms of the alkyl group is, for example, preferably 1 or 2 and more preferably 1. Specific examples of Rb¹⁰⁴ include a methyl group, an ethyl group, an n-propyl group, an isopropyl group, and a cyclopropyl group.

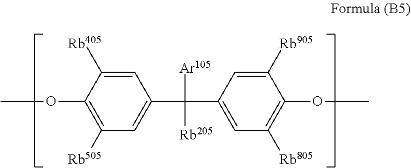

In Formula (B5), Ar¹⁰⁵ represents an aryl group having 6 or more and 12 or less carbon atoms or an aralkyl group having 7 or more and 20 or less carbon atoms, Rb²⁰⁵ represents a hydrogen atom or an alkyl group having 1 or more and 3 or less carbon atoms, and Rb⁴⁰⁵, Rb⁵⁰⁵, Rb⁸⁰⁵, and Rb⁹⁰⁵ each independently represent a hydrogen atom, an alkyl group having 1 or more and 4 or less carbon atoms, an alkoxy group having 1 or more and 6 or less carbon atoms, or a halogen atom.

The aryl group having 6 or more and 12 or less carbon atoms as Ar¹⁰⁵ may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Ar¹⁰⁵ may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2. The aryl group in the aralkyl group having 7 or more and 20 or less carbon atoms as Ar¹⁰⁵ may be any of a monocycle or a polycycle. The number of carbon atoms of the aryl group is, for example, preferably 6 or more and 10 or less and more preferably 6. Examples of the aralkyl group having 7 or more and 20 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

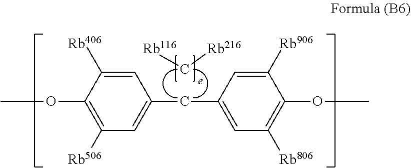

In Formula (B6), Rb¹¹⁶ and Rb²¹⁶ each independently represent a hydrogen atom, a linear alkyl group having 1 or more and 3 or less carbon atoms, an alkoxy group having 1 or more and 4 or less carbon atoms, or a halogen atom, e represents an integer of 4 or greater and 6 or less, and Rb⁴⁰⁶, Rb⁵⁰⁶, Rb⁸⁰⁶, and Rb⁹⁰⁶ each independently represent a hydrogen atom, an alkyl group having 1 or more and 4 or less carbon atoms, an alkoxy group having 1 or more and 6 or less carbon atoms, or a halogen atom.

The number of carbon atoms of the linear alkyl group having 1 or more and 3 or less carbon atoms as Rb¹¹⁶ and Rb²¹⁶ is, for example, preferably 1 or 2 and more preferably 1. Specific examples of such a group include a methyl group, an ethyl group, and an n-propyl group.

The alkyl group in the alkoxy group having 1 or more and 4 or less carbon atoms as Rb¹¹⁶ and Rb²¹⁶ may be linear, branched, or cyclic. The number of carbon atoms of the alkyl group in the alkoxy group having 1 or more and 4 or less carbon atoms is, for example, preferably 1 or more and 3 or less, more preferably 1 or 2, and still more preferably 1. Specific examples of such a group include a methoxy group, an ethoxy group, an n-propoxy group, an n-butoxy group, an isopropoxy group, an isobutoxy group, a sec-butoxy group, a tert-butoxy group, a cyclopropoxy group, and a cyclobutoxy group.

Examples of the halogen atom as Rb¹¹⁶ and Rb²¹⁶ include a fluorine atom, a chlorine atom, a bromine atom, and an iodine atom.

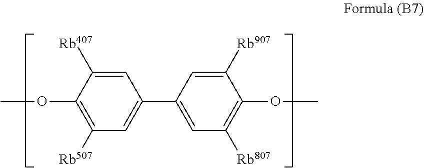

In Formula (B7), Rb⁴⁰⁷, Rb⁵⁰⁷, Rb⁸⁰⁷, and Rb⁹⁰⁷ each independently represent a hydrogen atom, an alkyl group having 1 or more and 4 or less carbon atoms, an alkoxy group having 1 or more and 6 or less carbon atoms, or a halogen atom.

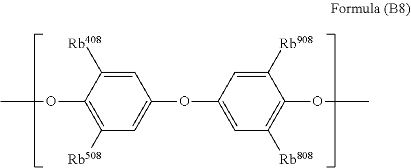

In Formula (B8), Rb⁴⁰⁸, Rb⁵⁰⁸, Rb⁸⁰⁸, and Rb⁹⁰⁸ each independently represent a hydrogen atom, an alkyl group having 1 or more and 4 or less carbon atoms, an alkoxy group having 1 or more and 6 or less carbon atoms, or a halogen atom.

The specific forms and the preferable forms of Rb²⁰¹ in Formula (B1), Rb²⁰² in Formula (B2), Rb²⁰⁴ in Formula (B4), and Rb²⁰⁵ in Formula (B5) are the same as each other, and hereinafter, Rb²⁰¹, Rb²⁰², Rb²⁰⁴, and Rb²⁰⁵ will be collectively referred to as “Rb²⁰⁰”.

The alkyl group having 1 or more and 3 or less carbon atoms as Rb²⁰⁰ may be any of linear, branched, or cyclic. The number of carbon atoms of the alkyl group is, for example, preferably 1 or 2 and more preferably 1.

The alkyl group having 1 or more and 3 or less carbon atoms includes a methyl group, an ethyl group, an n-propyl group, an isopropyl group, and a cyclopropyl group.

The specific forms and the preferable forms of Rb⁴⁰¹ in Formula (B1), Rb⁴⁰² in Formula (B2), Rb⁴⁰³ in Formula (B3), Rb⁴⁰⁴ in Formula (B4), Rb⁴⁰⁵ in Formula (B5), Rb⁴⁰⁶ in Formula (B6), Rb⁴⁰⁷ in Formula (B7), and Rb⁴⁰⁸ in Formula (B8) are the same as each other, and hereinafter, Rb⁴⁰¹, Rb⁴⁰², Rb⁴⁰³, Rb⁴⁰⁴, Rb⁴⁰⁵, Rb⁴⁰⁶, Rb⁴⁰⁷, and Rb⁴⁰⁸ will be collectively referred to as “Rb⁴⁰⁰”.

The alkyl group having 1 or more and 4 or less carbon atoms as Rb⁴⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁴⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁴⁰⁰ include a fluorine atom, a chlorine atom, a bromine atom, and an iodine atom.

The specific forms and the preferable forms of Rb⁵⁰¹ in Formula (B1), Rb⁵⁰² in Formula (B2), Rb⁵⁰³ in Formula (B3), Rb⁵⁰⁴ in Formula (B4), Rb⁵⁰⁵ in Formula (B5), Rb⁵⁰⁶ in Formula (B6), Rb⁵⁰⁷ in Formula (B7), and Rb⁵⁰⁸ in Formula (B8) are the same as each other, and hereinafter, Rb⁵⁰¹, Rb⁵⁰², Rb⁵⁰³, Rb⁵⁰⁴, Rb⁵⁰⁵, Rb⁵⁰⁶, Rb⁵⁰⁷, and Rb⁵⁰⁸ will be collectively referred to as “Rb⁵⁰⁰”.

The alkyl group having 1 or more and 4 or less carbon atoms as Rb⁵⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁵⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁵⁰⁰ include a fluorine atom, a chlorine atom, a bromine atom, and an iodine atom.

The specific forms and the preferable forms of Rb⁸⁰¹ in Formula (B1), Rb⁸⁰² in Formula (B2), Rb⁸⁰³ in Formula (B3), Rb⁸⁰⁴ in Formula (B4), Rb⁸⁰⁵ in Formula (B5), Rb⁸⁰⁶ in Formula (B6), Rb⁸⁰⁷ in Formula (B7), and Rb⁸⁰⁸ in Formula (B8) are the same as each other, and hereinafter, Rb⁸⁰¹, Rb⁸⁰², Rb⁸⁰³, Rb⁸⁰⁴, Rb⁸⁰⁵, Rb⁸⁰⁶, Rb⁸⁰⁷, and Rb⁸⁰⁸ will be collectively referred to as “Rb⁸⁰⁰”.

The alkyl group having 1 or more and 4 or less carbon atoms as Rb⁸⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁸⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁸⁰⁰ include a fluorine atom, a chlorine atom, a bromine atom, and an iodine atom.

The specific forms and the preferable forms of Rb⁹⁰¹ in Formula (B1), Rb⁹⁰² in Formula (B2), Rb⁹⁰³ in Formula (B3), Rb⁹⁰⁴ in Formula (B4), Rb⁹⁰⁵ in Formula (B5), Rb⁹⁰⁶ in Formula (B6), Rb⁹⁰⁷ in Formula (B7), and Rb⁹⁰⁸ in Formula (B8) are the same as each other, and hereinafter, Rb⁹⁰¹, Rb⁹⁰², Rb⁹⁰³, Rb⁹⁰⁴, Rb⁹⁰⁵, Rb⁹⁰⁶, Rb⁹⁰⁷, and Rb⁹⁰⁸ will be collectively referred to as “Rb⁹⁰⁰”.

The alkyl group having 1 or more and 4 or less carbon atoms as Rb⁹⁰⁰ may be any of linear, branched, or cyclic. The number of carbon atoms of the alkyl group is, for example, preferably 1 or more and 3 or less, more preferably 1 or 2, and still more preferably 1.

Examples of the linear alkyl group having 1 or more and 4 or less carbon atoms include a methyl group, an ethyl group, an n-propyl group, and an n-butyl group.

Examples of the branched alkyl group having 3 or 4 carbon atoms include an isopropyl group, an isobutyl group, a sec-butyl group, and a tert-butyl group.

Examples of the cyclic alkyl group having 3 or 4 carbon atoms include a cyclopropyl group and a cyclobutyl group.

The alkyl group in the alkoxy group having 1 or more and 6 or less carbon atoms as Rb⁹⁰⁰ may be any of linear, branched, or cyclic. The number of carbon atoms of the alkyl group in the alkoxy group having 1 or more and 6 or less carbon atoms is, for example, preferably 1 or more and 4 or less, more preferably 1 or more and 3 or less, and still more preferably 1 or 2.

Examples of the linear alkoxy group having 1 or more and 6 or less carbon atoms include a methoxy group, an ethoxy group, an n-propoxy group, an n-butoxy group, an n-pentyloxy group, and an n-hexyloxy group.

Examples of the branched alkoxy group having 3 or more and 6 or less carbon atoms include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, and a tert-hexyloxy group.

Examples of the cyclic alkoxy group having 3 or more and 6 or less carbon atoms include a cyclopropoxy group, a cyclobutoxy group, a cyclopentyloxy group, and a cyclohexyloxy group.

Examples of the halogen atom as Rb⁹⁰⁰ include a fluorine atom, a chlorine atom, a bromine atom, and an iodine atom.

Hereinafter, diol units (B1-1) to (B1-6) are shown as specific examples of the diol unit (B1). The diol unit (B1) is not limited thereto.

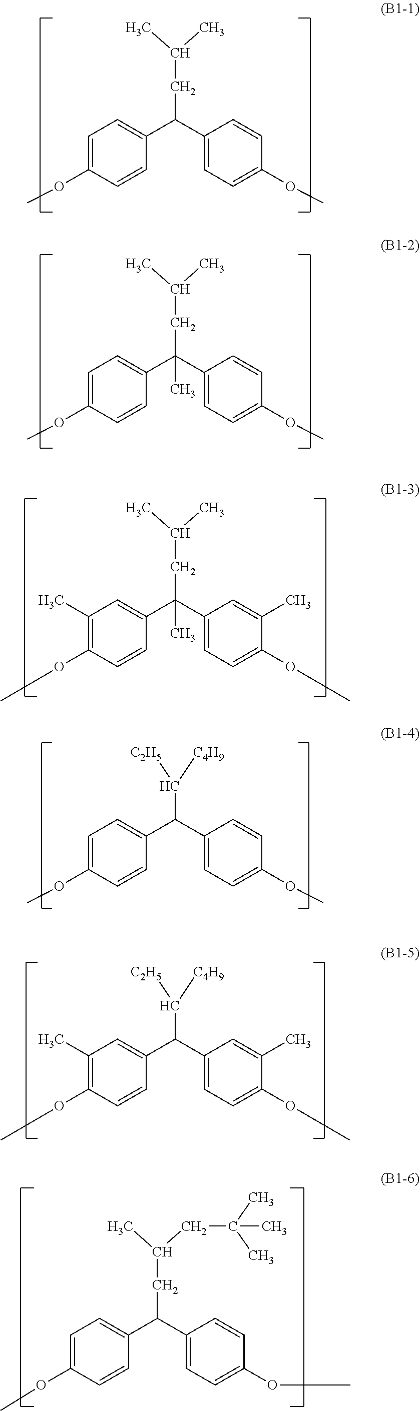

Hereinafter, diol units (B2-1) to (B2-11) are shown as specific examples of the diol unit (B2). The diol unit (B2) is not limited thereto.

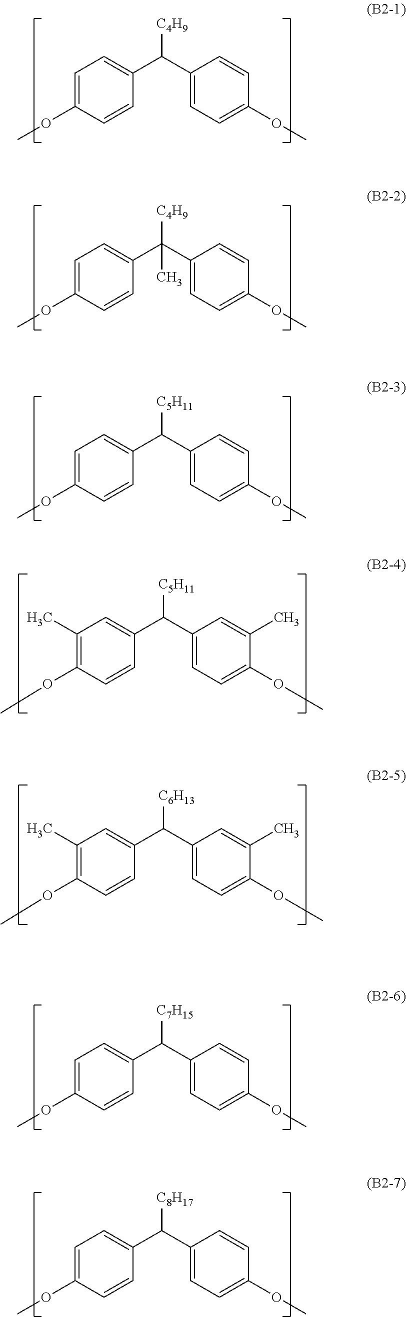

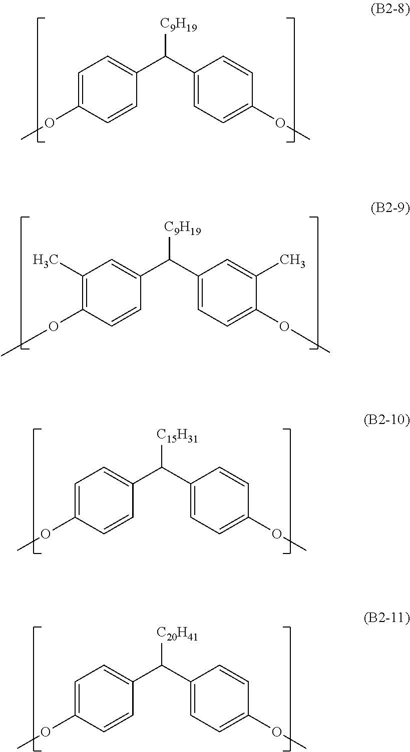

Hereinafter, diol units (B3-1) to (B3-4) are shown as specific examples of the diol unit (B3). The diol unit (B3) is not limited thereto.

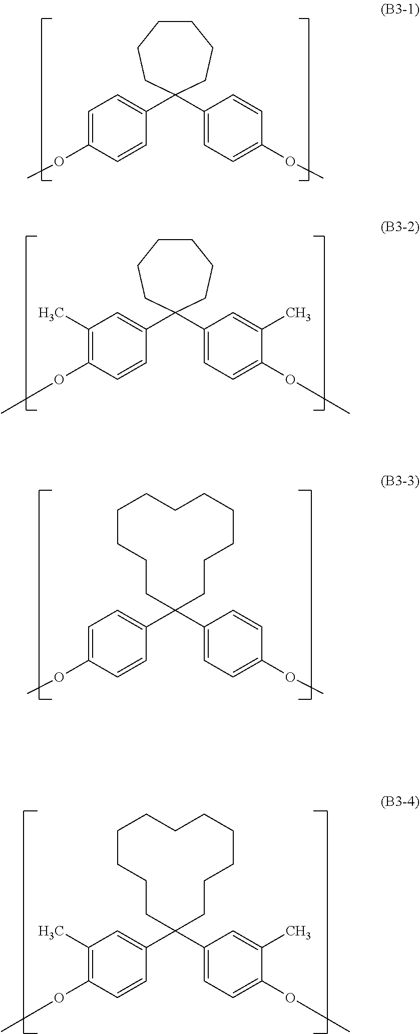

Hereinafter, diol units (B4-1) to (B4-7) are shown as specific examples of the diol unit (B4). The diol unit (B4) is not limited thereto.

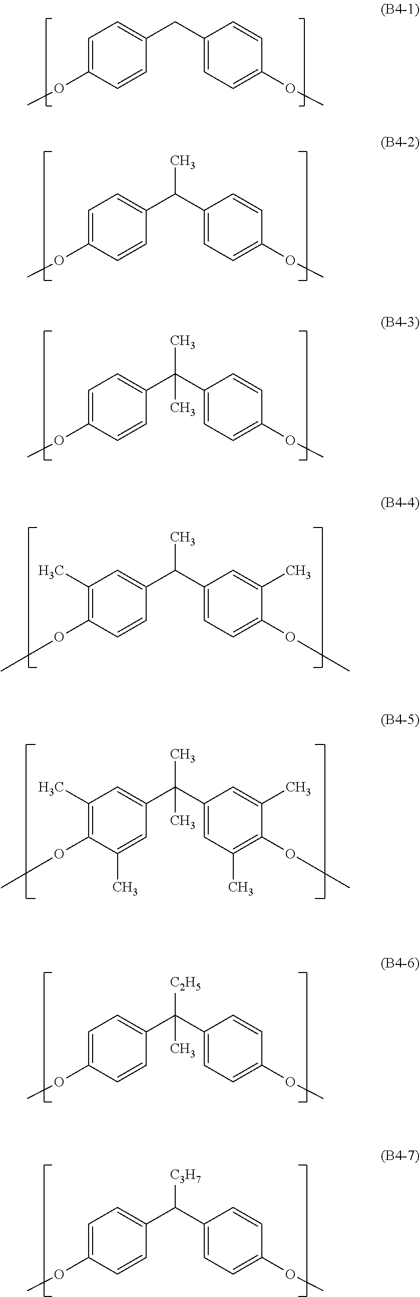

Hereinafter, diol units (B5-1) to (B5-6) are shown as specific examples of the diol unit (B5). The diol unit (B5) is not limited thereto.

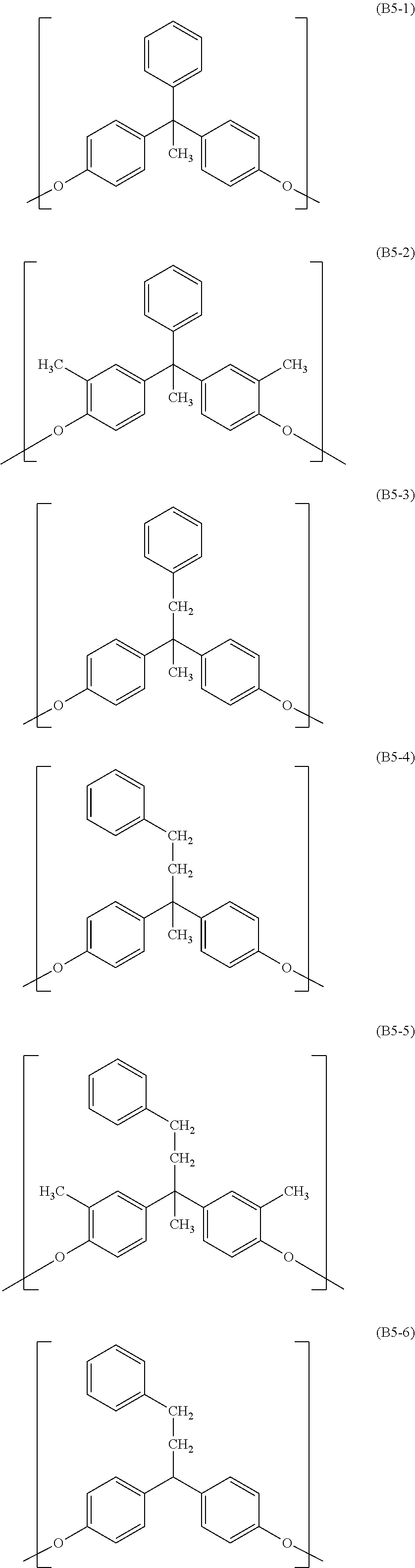

Hereinafter, diol units (B6-1) to (B6-4) are shown as specific examples of the diol unit (B6). The diol unit (B6) is not limited thereto.

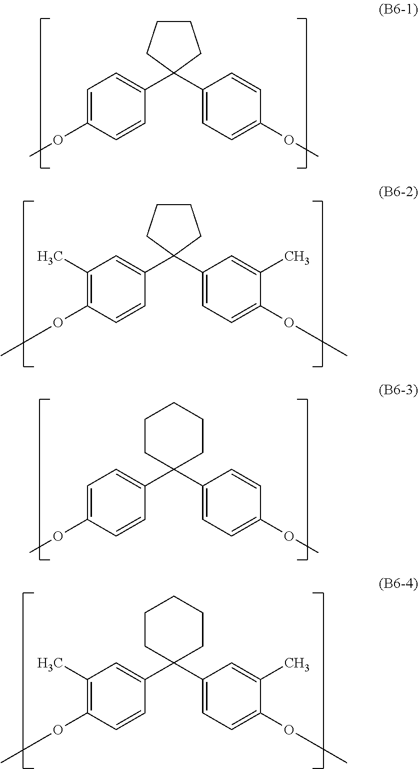

Hereinafter, diol units (B7-1) to (B7-3) are shown as specific examples of the diol unit (B7). The diol unit (B7) is not limited thereto.

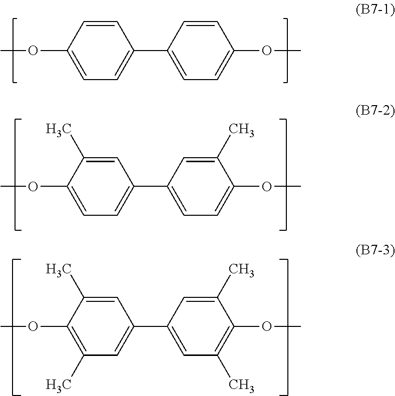

Hereinafter, diol units (B8-1) to (B8-3) are shown as specific examples of the diol unit (B8). The diol unit (B8) is not limited thereto.

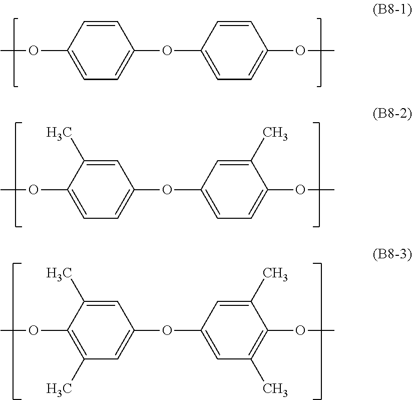

The diol unit (B) contained in the polyester resin (1z) may be used alone or in combination of two or more kinds thereof.

The mass proportion of the diol unit (B) in the polyester resin (1z) is, for example, preferably 25% by mass or greater and 80% by mass or less.

In a case where the mass proportion of the diol unit (B) is 25% by mass or greater, peeling of the photosensitive layer can be further suppressed. From this viewpoint, the mass proportion of the diol unit (B) is, for example, more preferably 30% by mass or greater and still more preferably 35% by mass or greater.

In a case where the mass proportion of the diol unit (B) is 80% by mass or less, the solubility in a coating solution for forming the photosensitive layer is maintained, and thus the abrasion resistance can be improved. From this viewpoint, the mass proportion of the diol unit (B) is, for example, more preferably 75% by mass or less and still more preferably 70% by mass or less.

Examples of other diol units in addition to the diol unit (B) include aliphatic diol (such as ethylene glycol, diethylene glycol, triethylene glycol, propylene glycol, butanediol, hexanediol, and neopentyl glycol) units and alicyclic diol (such as cyclohexanediol, cyclohexane dimethanol, and hydrogenated bisphenol A) units. These diol units contained in the polyester resin (1z) may be used alone or in combination of two or more kinds thereof.

It is preferable that the terminals of the polyester resin (PEz) and the polyester resin (1z) are, for example, sealed or modified with a terminal-sealing agent or a molecular weight modifier during the production of the resin. As the terminal-sealing agent or the molecular weight modifier, for example, the terminal-sealing agent having an aromatic ring or the molecular weight modifier having an aromatic ring described above is preferable.

The weight-average molecular weight of the polyester resin (PEz) and the polyester resin (1z) is, for example, preferably 50,000 or greater and 300,000 or less, more preferably 70,000 or greater and 250,000 or less, and still more preferably 80,000 or greater and 200,000 or less. The molecular weight of the polyester resin is a molecular weight measured by gel permeation chromatography (GPC) in terms of polystyrene. The measurement according to GPC is performed by a method of the related art using, for example, tetrahydrofuran or chloroform as an eluent.

The polyester resin (PEz) and the polyester resin (1z) can be obtained, for example, by polycondensing a monomer providing a dicarboxylic acid unit and a monomer providing a diol unit by a method of the related art. In the reaction, for example, it is preferable to use the terminal-sealing agent having an aromatic ring or the molecular weight modifier having an aromatic ring described above. Examples of the method of polycondensing monomers include an interfacial polymerization method, a solution polymerization method, and a melt polymerization method. The interfacial polymerization method is a polymerization method of mixing a divalent carboxylic acid halide dissolved in an organic solvent that is incompatible with water and dihydric alcohol dissolved in an alkali aqueous solution to obtain polyester. Examples of documents related to the interfacial polymerization method include W. M. EARECKSON, J. Poly. Sci., XL399, 1959, and JP1965-1959B (JP S40-1959B). Since the interfacial polymerization method enables the reaction to proceed faster than the reaction carried out by the solution polymerization method and also enables suppression of hydrolysis of the divalent carboxylic acid halide, as a result, a high-molecular-weight polyester resin can be obtained.

Polycarbonate Resin (PCz)

The polycarbonate resin (PCz) has at least one of the structure (Z1) or the structure (Z2) at at least one terminal. Details of the structure (Z1) and the structure (Z2) are as described above.

The polycarbonate resin (PCz) may have the structure (Z1) or the structure (Z2) at only one terminal, may have the structure (Z1) at one terminal and the structure (Z2) at the other terminal, or may have the structure (Z1) at both terminals or the structure (Z2) at both terminals.

In a case where the polycarbonate resin (PCz) has the structure (Z1), for example, it is preferable that the structure (Z1) is bonded to a side of “—O—C(═O)—” in the constitutional unit.

In a case where the polycarbonate resin (PCz) has the structure (Z2), for example, it is preferable that the structure (Z2) is bonded to a side of “—O—” in the constitutional unit.

The total mass proportion of the structure (Z1) and the structure (Z2) in the entire polycarbonate resin (PCz) is, for example, preferably 0.1% by mass or greater and 10% by mass or less, more preferably 0.2% by mass or greater and 7% by mass or less, and still more preferably 0.4% by mass or greater and 5% by mass or less.

As the polycarbonate resin (PCz), for example, a polycarbonate resin (1z) having a constitutional unit (C) and having at least one of the structure (Z1) or the structure (Z2) at at least one terminal is preferable.

In a case where the polycarbonate resin (1z) has the structure (Z1), for example, it is preferable that the structure (Z1) is bonded to a side of “—O—C(═O)—” in the constitutional unit (C).

In a case where the polycarbonate resin (1z) has the structure (Z2), for example, it is preferable that the structure (Z2) is bonded to a side of “—O—” in the constitutional unit (C).

The total mass proportion of the structure (Z1) and the structure (Z2) in the entire polycarbonate resin (1z) is, for example, preferably 0.1% by mass or greater and 10% by mass or less, more preferably 0.2% by mass or greater and 7% by mass or less, and still more preferably 0.4% by mass or greater and 5% by mass or less.

The constitutional unit (C) is a constitutional unit represented by Formula (C).

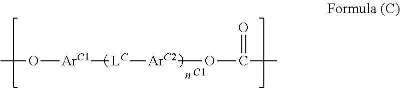

In Formula (C), Ar^{C1} and Ar^{C2} each independently represent an aromatic ring that may have a substituent, L^{C} represents a single bond or a divalent linking group, and n^{C1} represents 0, 1, or 2.

The aromatic ring as Ar^{C1} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Arci may be substituted with an alkyl group, an aryl group, an aralkyl group, an alkoxy group, an aryloxy group, a halogen atom, or the like. As the substituent in a case where the aromatic ring as Arci is substituted, for example, an alkyl group having 1 or more and 10 or less carbon atoms, an aryl group having 6 or more and 12 or less carbon atoms, and an alkoxy group having 1 or more and 6 or less carbon atoms are preferable.

The aromatic ring as Ar^{C2} may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom on the aromatic ring as Ar^{C2} may be substituted with an alkyl group, an aryl group, an aralkyl group, an alkoxy group, an aryloxy group, a halogen atom, or the like. As the substituent in a case where the aromatic ring as Ar^{C2} is substituted, for example, an alkyl group having 1 or more and 10 or less carbon atoms, an aryl group having 6 or more and 12 or less carbon atoms, and an alkoxy group having 1 or more and 6 or less carbon atoms are preferable.

In a case where L^{C} represents a divalent linking group, examples of the divalent linking group include an oxygen atom, a sulfur atom, and —C(Rc¹)(Rc²)—. Here, Rc¹ and Rc² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rc¹ and Rc² may be bonded to each other to form a cyclic alkyl group.

The alkyl group having 1 or more and 20 or less carbon atoms as Rc¹ and Rc² may be linear, branched, or cyclic. The number of carbon atoms of the alkyl group is, for example, preferably 1 or more and 18 or less, more preferably 1 or more and 14 or less, and still more preferably 1 or more and 10 or less.

The aryl group having 6 or more and 12 or less carbon atoms as Rc¹ and Rc² may be any of a monocycle or a polycycle. The number of carbon atoms of the aryl group is, for example, preferably 6 or more and 10 or less and more preferably 6.

The alkyl group in the aralkyl group having 7 or more and 20 or less carbon atoms as Rc¹ and Rc² may be any of linear, branched, or cyclic. The number of carbon atoms of the alkyl group in the aralkyl group having 7 or more and 20 or less carbon atoms is, for example, preferably 1 or more and 4 or less, more preferably 1 or more and 3 or less, and still more preferably 1 or 2.

The aryl group in the aralkyl group having 7 or more and 20 or less carbon atoms as Rc¹ and Rc² may be any of a monocycle or a polycycle. The number of carbon atoms of the aryl group is, for example, preferably 6 or more and 10 or less and more preferably 6.

It is preferable that the constitutional unit (C) includes, for example, at least one selected from the group consisting of a constitutional unit (Cb1) represented by Formula (Cb1), a constitutional unit (Cb2) represented by Formula (Cb2), a constitutional unit (Cb3) represented by Formula (Cb3), a constitutional unit (Cb4) represented by Formula (Cb4), a constitutional unit (Cb5) represented by Formula (Cb5), a constitutional unit (Cb6) represented by Formula (Cb6), a constitutional unit (Cb7) represented by Formula (Cb7), and a constitutional unit (Cb8) represented by Formula (Cb8).

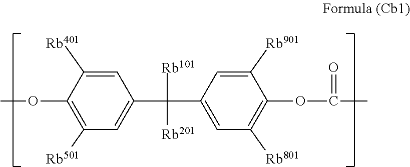

In Formula (Cb1), Rb¹⁰¹ represents a branched alkyl group having 4 or more and 20 or less carbon atoms, Rb²⁰¹ represents a hydrogen atom or an alkyl group having 1 or more and 3 or less carbon atoms, and Rb⁴⁰¹, Rb⁵⁰¹, Rb⁸⁰¹, and Rb⁹⁰¹ each independently represent a hydrogen atom, an alkyl group having 1 or more and 4 or less carbon atoms, an alkoxy group having 1 or more and 6 or less carbon atoms, or a halogen atom.

Rb¹⁰¹, Rb²⁰¹, Rb⁴⁰¹, Rb⁵⁰¹, Rb⁸⁰¹, and Rb⁹⁰¹ in Formula (Cb1) each have the same definition as that for R¹⁰¹, Rb²⁰¹, Rb⁴⁰¹, Rb⁵⁰¹, Rb⁸⁰¹, and Rb⁹⁰¹ in Formula (B1), and the specific forms thereof are also the same as each other.

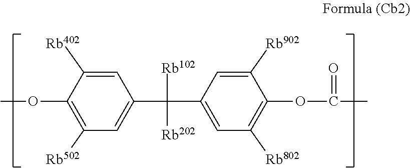

In Formula (Cb2), Rb¹⁰² represents a linear alkyl group having 4 or more and 20 or less carbon atoms, Rb²⁰² represents a hydrogen atom or an alkyl group having 1 or more and 3 or less carbon atoms, and Rb⁴⁰², Rb⁵⁰², Rb⁸⁰², and Rb⁹⁰² each independently represent a hydrogen atom, an alkyl group having 1 or more and 4 or less carbon atoms, an alkoxy group having 1 or more and 6 or less carbon atoms, or a halogen atom.

Rb¹⁰², Rb²⁰², Rb⁴⁰², Rb⁵⁰², Rb⁸⁰², and Rb⁹⁰² in Formula (Cb2) each have the same definition as that for Rb¹⁰², Rb²⁰², Rb⁴⁰², Rb⁵⁰², Rb⁸⁰², and Rb⁹⁰² in Formula (B2), and the specific forms thereof are also the same as each other.

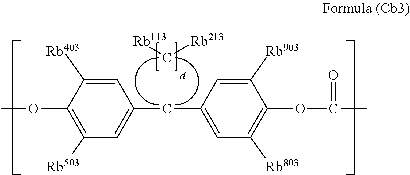

In Formula (Cb3), Rb¹¹³ and Rb²¹³ each independently represent a hydrogen atom, a linear alkyl group having 1 or more and 3 or less carbon atoms, an alkoxy group having 1 or more and 4 or less carbon atoms, or a halogen atom, d represents an integer of 7 or greater and 15 or less, and Rb⁴⁰³, Rb⁵⁰³, Rb⁸⁰³, and Rb⁹⁰³ each independently represent a hydrogen atom, an alkyl group having 1 or more and 4 or less carbon atoms, an alkoxy group having 1 or more and 6 or less carbon atoms, or a halogen atom.

Rb¹¹³, Rb²¹³, d, Rb⁴⁰³, Rb⁵⁰³, Rb⁸⁰³, and Rb⁹⁰³ in Formula (Cb3) each have the same definition as that for Rb¹¹³, Rb²¹³, d, Rb⁴⁰³, Rb⁵⁰³, Rb⁸⁰³, and Rb⁹⁰³ in Formula (B3), and the specific forms thereof are also the same as each other.

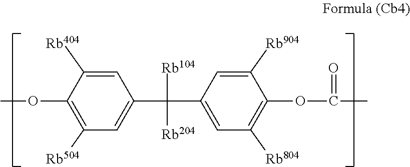

In Formula (Cb4), Rb¹⁰⁴ and Rb²⁰⁴ each independently represent a hydrogen atom, an alkyl group having 1 or more and 3 or less carbon atoms, and Rb⁴⁴, Rb⁵⁰⁴, Rb⁸⁰⁴, and Rb⁹⁰⁴ each independently represent a hydrogen atom, an alkyl group having 1 or more and 4 or less carbon atoms, an alkoxy group having 1 or more and 6 or less carbon atoms, or a halogen atom.

Rb¹⁰⁴, Rb²⁰⁴, Rb⁴⁰⁴, Rb⁵⁰⁴, Rb⁸⁰⁴, and Rb⁹⁰⁴ in Formula (Cb4) each have the same definition as that for Rb¹⁰⁴, Rb²⁰⁴, Rb⁴⁴, Rb⁵⁰⁴, Rb⁸⁰⁴ and Rb⁹⁰⁴ in Formula (B4), and the specific forms thereof are also the same as each other.

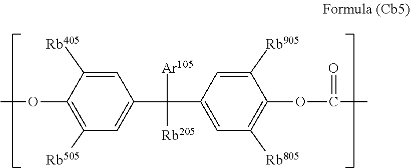

In Formula (Cb5), Ar¹⁰⁵ represents an aryl group having 6 or more and 12 or less carbon atoms or an aralkyl group having 7 or more and 20 or less carbon atoms, Rb²⁰⁵ represents a hydrogen atom or an alkyl group having 1 or more and 3 or less carbon atoms, and Rb⁴⁵, Rb⁵⁰⁵, Rb⁸⁰⁵, and Rb⁹⁰⁵ each independently represent a hydrogen atom, an alkyl group having 1 or more and 4 or less carbon atoms, an alkoxy group having 1 or more and 6 or less carbon atoms, or a halogen atom.

Ar¹⁰⁵, Rb²⁰⁵, Rb⁴⁰⁵, Rb⁵⁰⁵, Rb⁸⁰⁵, and Rb⁹⁰⁵ in Formula (Cb5) each have the same definition as that for Ar¹⁰⁵, Rb²⁰⁵, Rb⁴⁰⁵, Rb⁵⁰⁵, Rb⁸⁰⁵, and Rb⁹⁰⁵ in Formula (B5), and the specific forms thereof are also the same as each other.

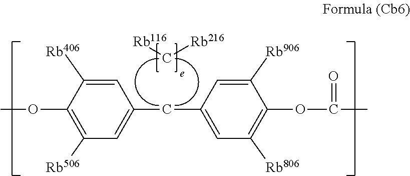

In Formula (Cb6), Rb¹¹⁶ and Rb²¹⁶ each independently represent a hydrogen atom, a linear alkyl group having 1 or more and 3 or less carbon atoms, an alkoxy group having 1 or more and 4 or less carbon atoms, or a halogen atom, e represents an integer of 4 or greater and 6 or less, and Rb⁴⁰⁶, Rb⁵⁰⁶, Rb⁸⁰⁶, and Rb⁹⁰⁶ each independently represent a hydrogen atom, an alkyl group having 1 or more and 4 or less carbon atoms, an alkoxy group having 1 or more and 6 or less carbon atoms, or a halogen atom.

Rb¹¹⁶, Rb²¹⁶, e, Rb⁴⁰⁶, Rb⁵⁰⁶, Rb⁸⁰⁶, and Rb⁹⁰⁶ in Formula (Cb6) each have the same definition as that for Rb¹¹⁶, Rb²¹⁶, e, Rb⁴⁰⁶, Rb⁵⁰⁶, Rb⁸⁰⁶, and Rb⁹⁰⁶ in Formula (B6), and the specific forms thereof are also the same as each other.

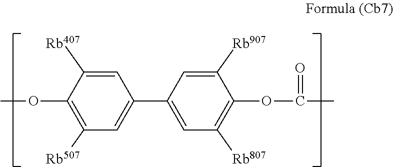

In Formula (Cb7), Rb⁴⁰⁷, Rb⁵⁰⁷, Rb⁸⁰⁷, and Rb⁹⁰⁷ each independently represent a hydrogen atom, an alkyl group having 1 or more and 4 or less carbon atoms, an alkoxy group having 1 or more and 6 or less carbon atoms, or a halogen atom.

Rb⁴⁰⁷, Rb⁵⁰⁷, Rb⁸⁰⁷, and Rb⁹⁰⁷ in Formula (Cb7) each have the same definition as that for Rb⁴⁰⁷, Rb⁵⁰⁷, Rb⁸⁰⁷, and Rb⁹⁰⁷ in Formula (B7), and the specific forms thereof are also the same as each other.

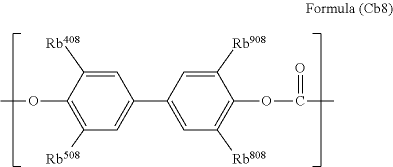

In Formula (Cb8), Rb⁴⁰⁸, Rb⁵⁰⁸, Rb⁸⁰⁸, and Rb⁹⁰⁸ each independently represent a hydrogen atom, an alkyl group having 1 or more and 4 or less carbon atoms, an alkoxy group having 1 or more and 6 or less carbon atoms, or a halogen atom.

Rb⁴⁰⁸, Rb⁵⁰⁸, Rb⁸⁰⁸, and Rb⁹⁰⁸ in Formula (Cb8) each have the same definition as that for Rb⁴⁰⁸, Rb⁵⁰⁸, Rb⁸⁰⁸, and Rb⁹⁰⁸ in Formula (B8), and the specific forms thereof are also the same as each other.

Hereinafter, constitutional units (Cb1-1) to (Cb1-6) are shown as specific examples of the constitutional unit (Cb1). The constitutional unit (Cb1) is not limited thereto.

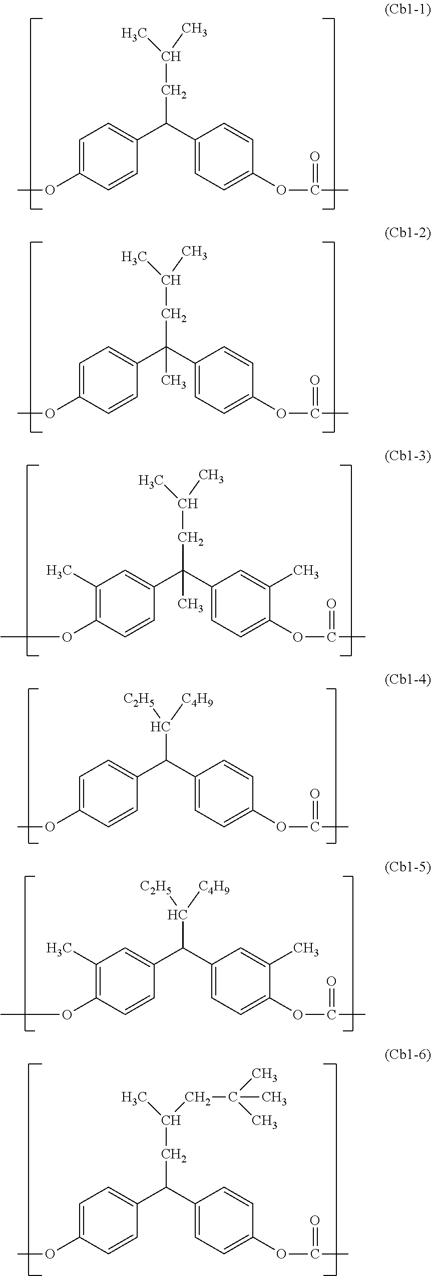

Hereinafter, constitutional units (Cb2-1) to (Cb2-11) are shown as specific examples of the constitutional unit (Cb2). The constitutional unit (Cb2) is not limited thereto.

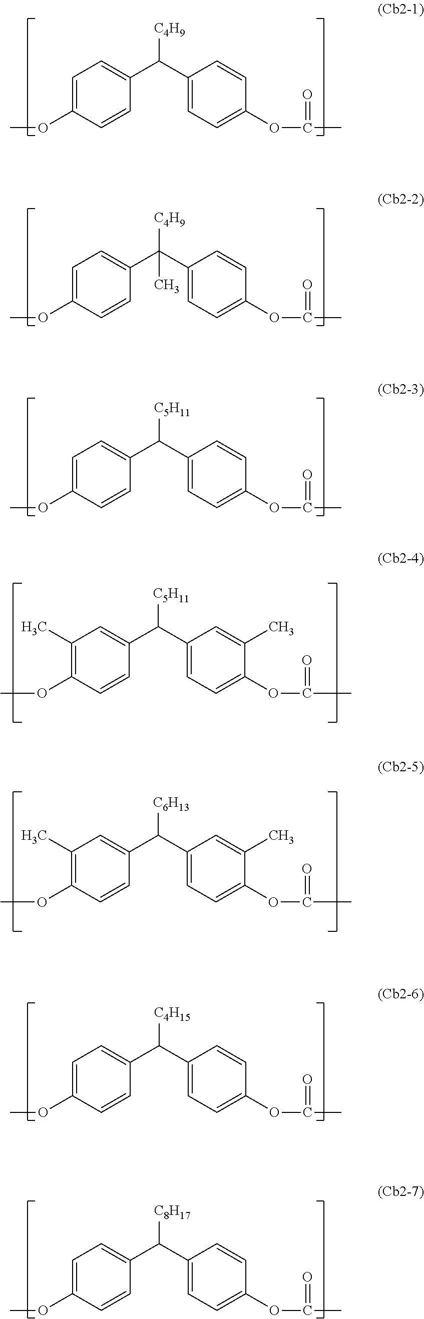

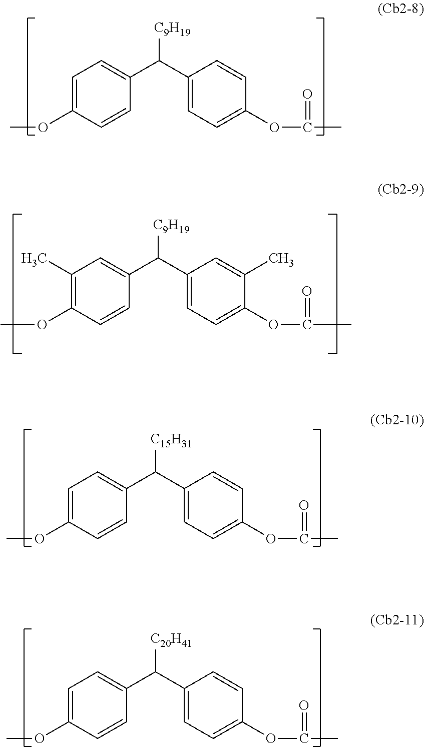

Hereinafter, constitutional units (Cb3-1) to (Cb3-4) are shown as specific examples of the constitutional unit (Cb3). The constitutional unit (Cb3) is not limited thereto.

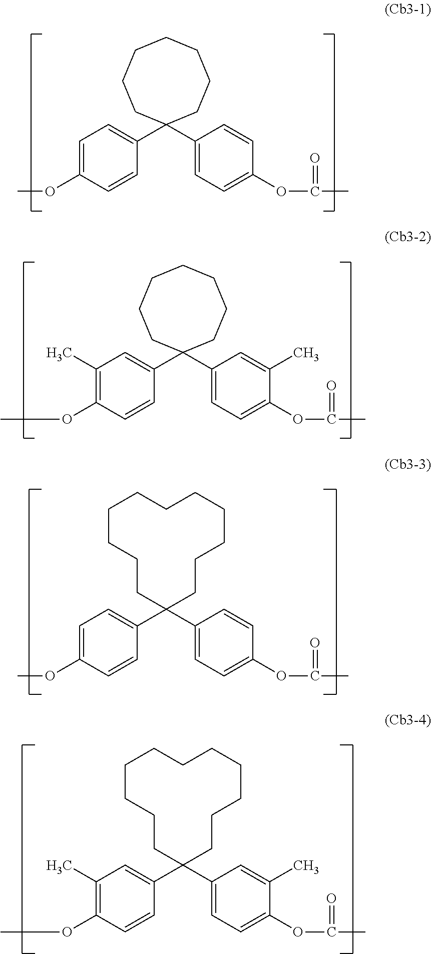

Hereinafter, constitutional units (Cb4-1) to (Cb4-7) are shown as specific examples of the constitutional unit (Cb4). The constitutional unit (Cb4) is not limited thereto.

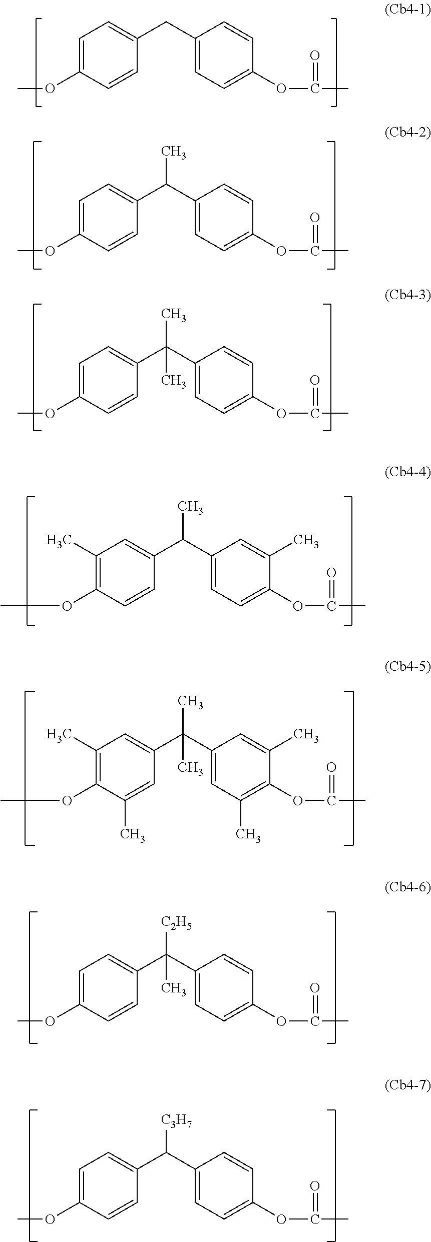

Hereinafter, constitutional units (Cb5-1) to (Cb5-6) are shown as specific examples of the constitutional unit (Cb5). The constitutional unit (Cb5) is not limited thereto.

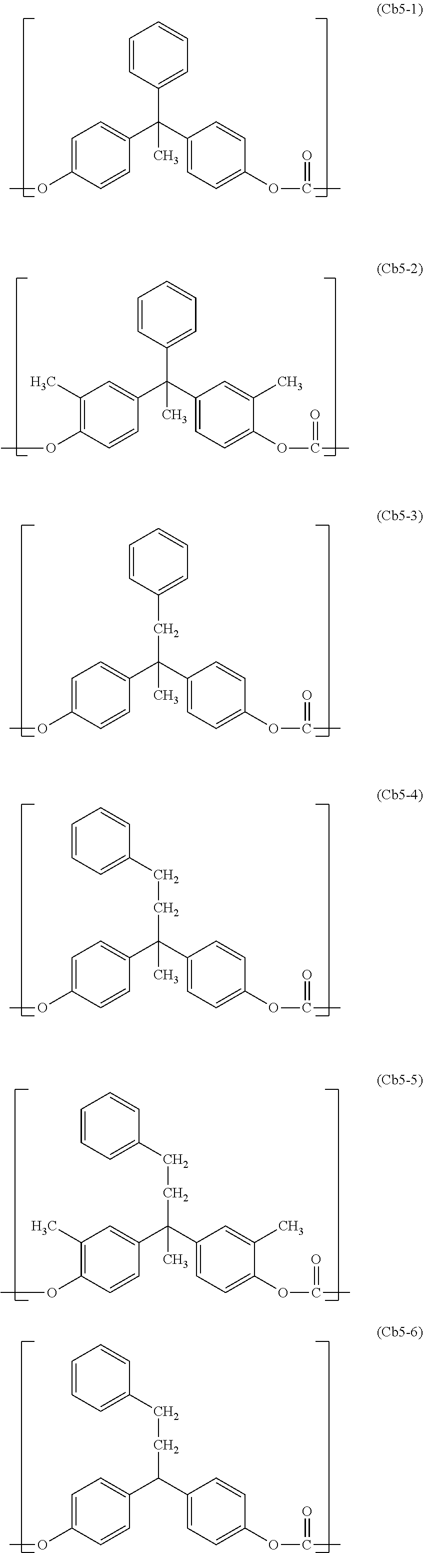

Hereinafter, constitutional units (Cb6-1) to (Cb6-4) are shown as specific examples of the constitutional unit (Cb6). The constitutional unit (Cb6) is not limited thereto.

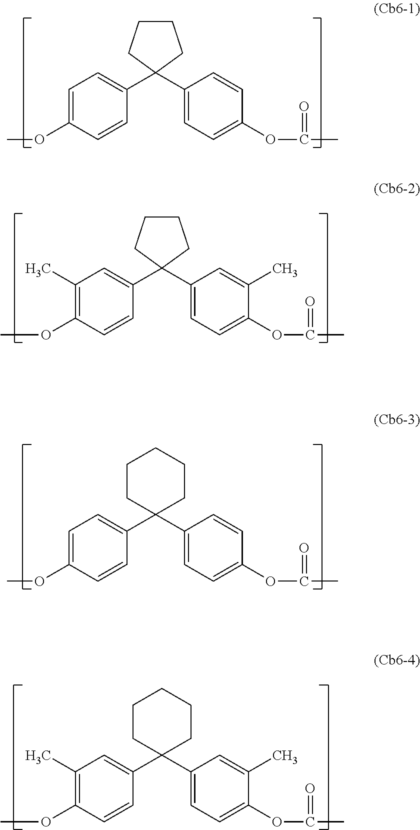

Hereinafter, constitutional units (Cb7-1) to (Cb7-3) are shown as specific examples of the constitutional unit (Cb7). The constitutional unit (Cb7) is not limited thereto.

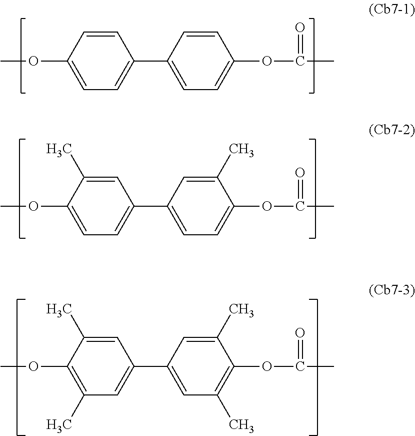

Hereinafter, constitutional units (Cb8-1) to (Cb8-3) are shown as specific examples of the constitutional unit (Cb8). The constitutional unit (Cb8) is not limited thereto.

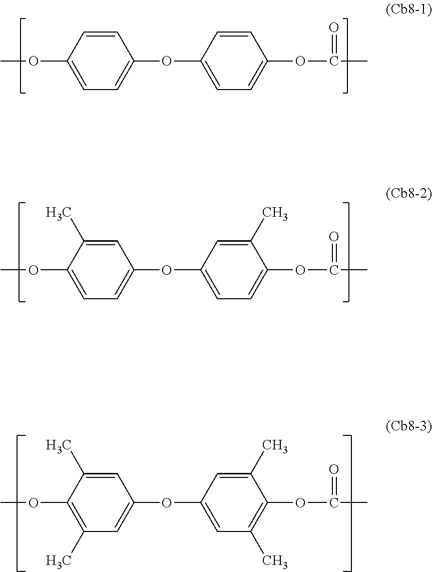

The constitutional unit (C) of the polycarbonate resin (1z) may be used alone or in combination of two or more kinds thereof.

The polycarbonate resin (1z) may have other constitutional units in addition to the constitutional unit (C). Examples of other constitutional units include a constitutional unit derived from an aliphatic diol (such as ethylene glycol, diethylene glycol, triethylene glycol, propylene glycol, butanediol, hexanediol, or neopentyl glycol) and phosgene, and a constitutional unit derived from an alicyclic diol (such as cyclohexanediol, cyclohexane dimethanol, or hydrogenated bisphenol A) and phosgene. These constitutional units of the polycarbonate resin (1z) may be used alone or in combination of two or more kinds thereof.

The mass proportion of the constitutional unit (C) in the mass of the polycarbonate resin (1z) is, for example, preferably 80% by mass or greater and 100% by mass or less, more preferably 90% by mass or greater and 100% by mass or less, and still more preferably 95% by mass or greater and 100% by mass or less.

It is preferable that the terminals of the polyester resin (PCz) and the polyester resin (1z) are, for example, sealed or modified with a terminal-sealing agent or a molecular weight modifier during the production of the resin. As the terminal-sealing agent or the molecular weight modifier, for example, the terminal-sealing agent having an aromatic ring or the molecular weight modifier having an aromatic ring described above is preferable.

The weight-average molecular weight of the polycarbonate resin (PCz) and the polycarbonate resin (1z) is, for example, preferably 50,000 or greater and 300,000 or less, more preferably 70,000 or greater and 250,000 or less, and still more preferably 80,000 or greater and 200,000 or less. The molecular weight of the polycarbonate resin is a molecular weight measured by gel permeation chromatography (GPC) in terms of polystyrene. The measurement according to GPC is performed by a method of the related art using, for example, tetrahydrofuran or chloroform as an eluent.

Examples of a method of producing the polycarbonate resin (PCz) and the polycarbonate resin (1z) include known polymerization methods (such as an interfacial polymerization method, a solution polymerization method, and a melt polymerization method). Specific examples of the polymerization reaction include a polymerization reaction in which a diol reacts with a carbonate precursor such as phosgene or carbonic acid diester. In the reaction, for example, it is preferable to use the terminal-sealing agent having an aromatic ring or the molecular weight modifier having an aromatic ring described above.

Each of the constitutional units (Cb1) to (Cb8) of the polycarbonate resin (1z) can be introduced to the polycarbonate resin by using, for example, a diol that provides any of the diol units (B1) to (B8) in the polymerization.

Resin (X)

The resin (X) has at least one of a unit (X1) or a unit (X2). The resin (X) may have other constitutional units in addition to the unit (X1) and the unit (X2).

Since the resin (X) has at least one of the unit (X1) or the unit (X2), the resin (X) has a siloxane chain or a long-chain alkyl group in a side chain, and thus the lubricity can be imparted to the photosensitive layer.

The unit (X1) is a constitutional unit represented by Formula (X1).

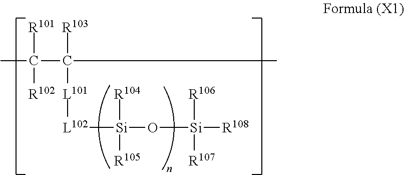

In Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R⁰)O]ₘ—Si(R¹¹¹)(R¹¹²)(R¹¹³), R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less.

The alkyl group having 1 or more and 5 or less carbon atoms as R¹⁰¹, R¹⁰², and R¹⁰³ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

R¹⁰¹ and R¹⁰² each independently represent, for example, preferably a hydrogen atom or a methyl group and more preferably a hydrogen atom.

It is preferable that R¹⁰³ represents, for example, a hydrogen atom or a methyl group.

The alkylene group having 1 or more and 5 or less carbon atoms as L¹⁰¹ and L¹⁰² may be linear, branched, or cyclic. The number of carbon atoms of the alkylene group is, for example, preferably 2 or more and 5 or less, more preferably 2 or more and 4 or less, and still more preferably 3.

Examples of the linear alkylene group having 1 or more and 5 or less carbon atoms include a methylene group, an ethylene group, an n-propylene group, an n-butylene group, and an n-pentylene group.

Examples of the branched alkylene group having 3 or more and 5 or less carbon atoms include an isopropylene group, an isobutylene group, a sec-butylene group, a tert-butylene group, an isopentylene group, a neopentylene group, and a tert-pentylene group.

Examples of the cyclic alkylene group having 3 or more and 5 or less carbon atoms include a cyclopropylene group, a cyclobutylene group, and a cyclopentylene group.

The aromatic ring of the aromatic ring that may have a substituent as L¹⁰¹ may be a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom of the aromatic ring may be substituted with an alkyl group, an aryl group, an aralkyl group, an alkoxy group, an aryloxy group, a halogen atom, or the like. As the substituent used to substitute the aromatic ring, for example, an alkyl group having 1 or more and 5 or less carbon atoms is preferable, an alkyl group having 1 or more and 3 or less carbon atoms is more preferable, and a methyl group is still more preferable.

L¹⁰¹ represents, for example, preferably —C(═O)O— or an aromatic ring that may have a substituent, more preferably —C(═O)O— or a benzene ring that may have a substituent, and still more preferably —C(═O)O— or a benzene ring.

L¹⁰² represents, for example, preferably a single bond, a linear alkylene group having 1 or more and 5 or less carbon atoms, —O—, —C(═O)—, —C(═O)O—, or a combination thereof and more preferably a linear alkylene group having 2 or more and 4 or less carbon atoms, —O—, —C(═O)—, —C(═O)O—, or a combination thereof.

The alkyl group having 1 or more and 5 or less carbon atoms as R¹⁰⁴ and R¹⁰⁵ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

R¹⁰⁴ and R¹⁰⁵ each independently represent, for example, preferably have a linear alkyl group having 1 or more and 5 or less carbon atoms, more preferably a linear alkyl group having 1 or more and 4 or less carbon atoms, and still more preferably a methyl group.

n represents an integer of 0 or greater and 300 or less, for example, preferably an integer of 1 or greater and 250 or less, more preferably an integer of 3 or greater and 200 or less, and still more preferably an integer of 5 or greater and 150 or less.

The alkyl group having 1 or more and 5 or less carbon atoms as R¹⁰⁶, R¹⁰⁷, R¹⁰⁸, R¹⁰⁹, R¹¹⁰, R¹¹¹, R¹¹², and R¹¹³ may be linear, branched, or cyclic. The number of carbon atoms of the alkyl group is, for example, preferably 1 or more and 4 or less, more preferably 1 or more and 3 or less, still more preferably 1 or 2, and particularly preferably 1.

In a case where R¹⁰⁶, R¹⁰⁷, and R¹⁰⁸ each independently represent an alkyl group having 1 or more and 5 or less carbon atoms, R¹⁰⁶, R¹⁰⁷, and R¹⁰⁸ each independently represent, for example, a linear alkyl group having 1 or more and 5 or less carbon atoms, more preferably a linear alkyl group having 1 or more and 4 or less carbon atoms, and still more preferably a methyl group.

R¹⁰⁹, R¹¹⁰, R¹¹¹, R¹¹², and R¹¹³ each independently represent, for example, preferably have a linear alkyl group having 1 or more and 5 or less carbon atoms, more preferably a linear alkyl group having 1 or more and 4 or less carbon atoms, and still more preferably a methyl group.

m represents an integer of 0 or greater and 20 or less, for example, preferably an integer of 0 or greater and 15 or less, more preferably an integer of 0 or greater and 10 or less, and still more preferably an integer of 0 or greater and 5 or less.

It is preferable that the unit (X1) is, for example, at least one of a unit (X1-1) represented by Formula (X1-1) or a unit (X1-2) represented by Formula (X1-2).

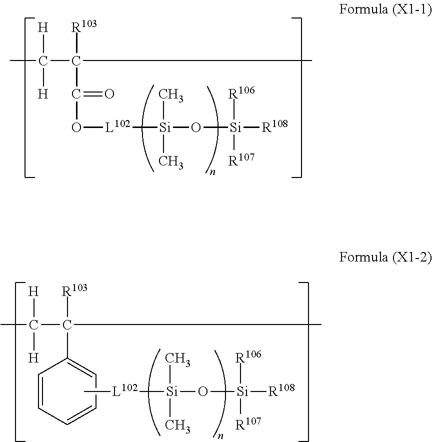

In Formulae (X1-1) and (X1-2), R¹⁰³ represents a hydrogen atom or a methyl group, L¹⁰² represents a single bond, an alkylene group having 1 or more and 5 or less carbon atoms, —O—, —C(═O)—, —C(═O)O—, or a combination thereof, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), and R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less.

R¹⁰³ n, R¹⁰⁶, R¹⁰⁷, R¹⁰⁸, R¹⁰⁹, R¹¹⁰, R¹¹¹, R¹¹², R¹¹³, and m in Formulae (X1-1) and (X1-2) each have the same definition as that for R¹⁰³, n, R¹⁰⁶, R¹⁰⁷, R¹⁰⁸, R¹⁰⁹, R¹¹⁰, R¹¹¹, R¹¹², R¹¹³, and m in Formula (X1), and the preferable forms thereof are the same as each other.

In Formula (X1-1), L¹⁰² represents, for example, preferably a linear alkylene group having 1 or more and 5 or less carbon atoms or a combination of a linear alkylene group having 1 or more and 5 or less carbon atoms and —O—, more preferably a linear alkylene group having 2 or more and 4 or less carbon atoms or a combination of a linear alkylene group having 2 or more and 4 or less carbon atoms and —O—, and still more preferably a linear alkylene group having 2 or 3 carbon atoms or a combination of a linear alkylene group having 2 or 3 carbon atoms and —O—.

Among the atoms forming L¹⁰², the number of atoms connecting “O” of —C(═O)O— and “Si” of —(Si(CH₃)₂O)n- in Formula (X1-1) at the shortest distance is, for example, preferably 1 or more and 5 or less, more preferably 2 or more and 4 or less, and still more preferably 3 or 4.

In Formula (X1-2), L¹⁰² represents, for example, preferably a linear alkylene group having 1 or more and 5 or less carbon atoms, —O—, —C(═O)—, —C(═O)O—, or a combination thereof, more preferably a linear alkylene group having 1 or more and 4 or less carbon atoms, —O—, —C(═O)—, —C(═O)O—, or a combination thereof, and still more preferably a linear alkylene group having 1 or more and 3 or less carbon atoms, —O—, —C(═O)—, —C(═O)O—, or a combination thereof.

Among the atoms forming L¹⁰², the number of atoms connecting the benzene ring and “Si” of —(Si(CH₃)₂O)n- in Formula (X1-2) at the shortest distance is, for example, preferably 1 or more and 7 or less, more preferably 1 or more and 6 or less, and still more preferably 1 or more and 5 or less.

Specific examples of the unit (X1-1) will be shown below, but the unit (X1-1) is not limited thereto. Me represents a methyl group, and n-flu represents a normal butyl group.

| | R¹⁰³ | L¹⁰² | n | R¹⁰⁶ | R¹⁰⁷ | R¹⁰⁸ |
|---|---|---|---|---|---|---|
| X1-1-1 | H | —(CH₂)₂— | 5 | Me | Me | Me |
| X1-1-2 | Me | —(CH₂)₂—O—(CH₂)₃— | 35 | Me | Me | Me |
| X1-1-3 | Me | —(CH₂)₂—O—(CH₂)₃— | 61 | Me | Me | Me |
| X1-1-4 | Me | —(CH₂)₃— | 1 | Me | Me | Me |
| X1-1-5 | Me | —(CH₂)₃— | 2 | Me | Me | Me |
| X1-1-6 | Me | —(CH₂)₃— | 3 | Me | Me | Me |
| X1-1-7 | Me | —(CH₂)₃— | 4 | Me | Me | Me |
| X1-1-8 | Me | —(CH₂)₃— | 5 | Me | Me | Me |
| X1-1-9 | Me | —(CH₂)₃— | 6 | Me | Me | Me |
| X1-1-10 | Me | —(CH₂)₃— | 7 | Me | Me | Me |
| X1-1-11 | Me | —(CH₂)₃— | 8 | Me | Me | Me |
| X1-1-12 | Me | —(CH₂)₃— | 9 | Me | Me | Me |
| X1-1-13 | Me | —(CH₂)₃— | 10 | Me | Me | Me |
| X1-1-14 | Me | —(CH₂)₃— | 28 | Me | Me | Me |
| X1-1-15 | Me | —(CH₂)₃— | 29 | Me | Me | Me |
| X1-1-16 | Me | —(CH₂)₃— | 59 | Me | Me | Me |
| X1-1-17 | Me | —(CH₂)₃— | 60 | Me | Me | Me |
| X1-1-18 | Me | —(CH₂)₃— | 65 | Me | Me | Me |
| X1-1-19 | Me | —(CH₂)₃— | 132 | Me | Me | Me |
| X1-1-20 | Me | —(CH₂)₃— | 159 | Me | Me | Me |
| X1-1-21 | Me | —(CH₂)₃— | 160 | Me | Me | Me |
| X1-1-22 | Me | —(CH₂)₃— | 267 | Me | Me | Me |
| X1-1-23 | Me | —(CH₂)₃— | 10 | n-Bu | Me | Me |
| X1-1-24 | Me | —(CH₂)₃— | 11 | n-Bu | Me | Me |
| X1-1-25 | Me | —(CH₂)₃— | 64 | n-Bu | Me | Me |
| X1-1-26 | Me | —(CH₂)₃— | 65 | n-Bu | Me | Me |
| X1-1-27 | Me | —(CH₂)₃— | 131 | n-Bu | Me | Me |
| X1-1-28 | Me | —(CH₂)₃— | 132 | n-Bu | Me | Me |
| X1-1-29 | Me | —(CH₂)₃— | 0 | —O—SiMe₃ | —O—SiMe₃ | —O—SiMe₃ |
| X1-1-30 | Me | —(CH₂)₃— | 5 | n-Bu | Me | Me |
| X1-1-31 | Me | —(CH₂)₃— | 7 | n-Bu | Me | Me |
| X1-1-32 | Me | —(CH₂)₃— | 8 | n-Bu | Me | Me |
| X1-1-33 | Me | —(CH₂)₃— | 10 | n-Bu | Me | Me |
| X1-1-34 | Me | —(CH₂)₃— | 11 | n-Bu | Me | Me |
| X1-1-35 | Me | —(CH₂)₃— | 131 | n-Bu | Me | Me |
| X1-1-36 | Me | —(CH₂)₃— | 132 | n-Bu | Me | Me |
| X1-1-37 | Me | —(CH₂)₃— | 0 | —O—SiMe₃ | —O—SiMe₃ | Me |
| X1-1-38 | Me | —(CH₂)₃— | 0 | —O—(SiMe₂O)₃—Si (n-Bu) Me₂ | —O—(SiMe₂O)₃—Si | Me |
| | | | | | (n-Bu) Me₂ | |
| X1-1-39 | Me | —(CH₂)₃— | 0 | —O—(SiMe₂O)₄—Si (n-Bu) Me₂ | —O—(SiMe₂O)₄—Si | Me |
| | | | | | (n-Bu) Me₂ | |
| X1-1-40 | Me | —(CH₂)₃— | 0 | —O—(SiMe₂O)₁—SiMe₃ | —O—(SiMe₂O)₁—SiMe₃ | —O—(SiMe₂O)₁—SiMe₃ |
| X1-1-41 | H | —(CH₂)₃— | 0 | —O—(SiMe₂O)₁—SiMe₃ | —O—(SiMe₂O)₁—SiMe₃ | —O—(SiMe₂O)₁—SiMe₃ |
| X1-1-42 | H | —(CH₂)₃— | 0 | —O—(SiMe₂O)₂—SiMe₃ | —O—(SiMe₂O)₂—SiMe₃ | —O—(SiMe₂O)₂—SiMe₃ |

Specific examples of the unit (X1-2) will be shown below, but the unit (X1-2) is not limited thereto. Me represents a methyl group, and n-flu represents a normal butyl group.

| | R¹⁰³ | L¹⁰² | n | R¹⁰⁶ | R¹⁰⁷ | R¹⁰⁸ |
|---|---|---|---|---|---|---|
| X1-2-1 | H | —O— | 0 | Me | Me | Me |
| X1-2-2 | H | —O— | 1 | Me | Me | Me |
| X1-2-3 | H | —O— | 2 | Me | Me | Me |
| X1-2-4 | H | —O— | 3 | Me | Me | Me |
| X1-2-5 | H | —O— | 4 | Me | Me | Me |
| X1-2-6 | H | —O— | 8 | Me | Me | Me |
| X1-2-7 | H | —O— | 10 | Me | Me | Me |
| X1-2-8 | H | —O— | 20 | Me | Me | Me |
| X1-2-9 | H | —(C═O)O—(CH₂)₂—O— (CH₂)₃— | 35 | Me | Me | Me |
| X1-2-10 | H | —(C═O)O—(CH₂)₂—O—(CH₂)₃— | 61 | Me | Me | Me |
| X1-2-11 | H | —O(C═O)—(CH₂)₂— | 18 | Me | Me | Me |
| X1-2-12 | H | —CH₂—O(C═O)—(CH₂)₂— | 18 | Me | Me | Me |
| X1-2-13 | H | —(C═O)O—(CH₂)₂—O—(CH₂)₃— | 11 | n-Bu | Me | Me |
| X1-2-14 | H | —(C═O)O—(CH₂)₂—O—(CH₂)₃— | 65 | n-Bu | Me | Me |
| X1-2-15 | H | —(C═O)O—(CH₂)₂—O—(CH₂)₃— | 132 | n-Bu | Me | Me |
| X1-2-16 | H | —(C═O)O—(CH₂)₃— | 0 | —O—SiMe₃ | —O—SiMe₃ | Me |

Specific examples of the unit (X1) other than the unit (X1-1) and the unit (X1-2) will be shown below, but the unit (X1) is not limited thereto. Me represents a methyl group, Et represents an ethyl group, and Ph represents a phenyl group.

| | R [symbol] | R [symbol] | R¹⁰³ | L [symbol] | L¹⁰² | n | R¹⁰⁴ | R¹⁰⁵ | R [symbol] | R¹⁰⁷ | R¹⁰⁸ |
|---|---|---|---|---|---|---|---|---|---|---|---|
| X1-E-1 | H | H | H | [symbol] | [symbol] | 72 | Me | Me | Me | Me | Me |
| X1-E-2 | H | H | H | [symbol] | [symbol] | 86 | Me | Me | Me | Me | Me |
| X1-E-3 | H | H | H | [symbol] | [symbol] | 0 | — | — | Me | Me | Me |
| X1-E-4 | H | H | H | [symbol] | [symbol] | 0 | — | — | Et | Et | Et |
| X1-E-5 | H | H | H | [symbol] | [symbol] | 0 | — | — | —O—SiMe₃ | —O—SiMe [symbol] | —O—SiMe₃ |
| X1-E-6 | H | H | H | [symbol] | [symbol] | 1 | Me | Me | Me | Me | Me |
| X1-E-7 | H | H | H | [symbol] | [symbol] | 0 | — | — | Me | Me | Ph |

[symbol]

indicates data missing or illegible when filed

The unit (X2) is a constitutional unit represented by Formula (X2).

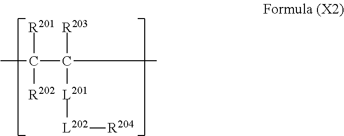

In Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

The alkyl group having 1 or more and 5 or less carbon atoms as R²⁰¹, R²⁰², and R²⁰³ may be any of linear, branched, or cyclic. The number of carbon atoms of the alkyl group is, for example, preferably 1 or more and 4 or less, more preferably 1 or more and 3 or less, still more preferably 1 or 2, and particularly preferably 1.

R²⁰¹ and R²⁰² each independently represent, for example, preferably a hydrogen atom or a methyl group and more preferably a hydrogen atom.

It is preferable that R²⁰³ represents, for example, a hydrogen atom or a methyl group.

The alkylene group having 1 or more and 5 or less carbon atoms as L²⁰¹ and L²⁰² may be linear, branched, or cyclic. The number of carbon atoms of the alkylene group is, for example, preferably 2 or more and 5 or less, more preferably 2 or more and 4 or less, and still more preferably 3.

Examples of the linear alkylene group having 1 or more and 5 or less carbon atoms include a methylene group, an ethylene group, an n-propylene group, an n-butylene group, and an n-pentylene group.

Examples of the branched alkylene group having 3 or more and 5 or less carbon atoms include an isopropylene group, an isobutylene group, a sec-butylene group, a tert-butylene group, an isopentylene group, a neopentylene group, and a tert-pentylene group.

Examples of the cyclic alkylene group having 3 or more and 5 or less carbon atoms include a cyclopropylene group, a cyclobutylene group, and a cyclopentylene group.

The aromatic ring of the aromatic ring that may have a substituent as L²⁰¹ may be any of a monocycle or a polycycle. Examples of the aromatic ring include a benzene ring, a naphthalene ring, an anthracene ring, and a phenanthrene ring. Among these, for example, a benzene ring and a naphthalene ring are preferable.

The hydrogen atom of the aromatic ring may be substituted with an alkyl group, an aryl group, an aralkyl group, an alkoxy group, an aryloxy group, a halogen atom, or the like. As the substituent used to substitute the aromatic ring, for example, an alkyl group having 1 or more and 5 or less carbon atoms is preferable, an alkyl group having 1 or more and 3 or less carbon atoms is more preferable, and a methyl group is still more preferable.

L²⁰¹ represents, for example, preferably —C(═O)O— or an aromatic ring that may have a substituent, more preferably —C(═O)O— or a benzene ring that may have a substituent, and still more preferably —C(═O)O— or a benzene ring.

L²⁰² represents, for example, preferably a single bond, a linear alkylene group having 1 or more and 4 or less carbon atoms, —O—, —C(═O)—, —C(═O)O—, or a combination thereof and more preferably a single bond, a linear alkylene group having 1 or more and 3 or less carbon atoms, —O—, —C(═O)—, —C(═O)O—, or a combination thereof.

The alkyl group having 6 or more and 30 or less carbon atoms as R²⁰4 may be linear, branched, or cyclic and is, for example, preferably linear or branched. The number of carbon atoms of the alkyl group is, for example, preferably 8 or more and 28 or less, more preferably 9 or more and 26 or less, and still more preferably 10 or more and 25 or less.

Examples of the linear alkyl group having 6 or more and 30 or less carbon atoms include an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, an n-icosyl group, and an n-docosyl group.

Examples of the branched alkyl group having 6 or more and 30 or less carbon atoms include an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 6 or more and 30 or less carbon atoms include a cyclohexyl group, a cycloheptyl group, a cyclooctyl group, a cyclononyl group, a cyclodecyl group, and polycyclic (such as bicyclic, tricyclic, or spirocyclic) alkyl groups formed by these monocyclic alkyl groups being linked to each other.

R²⁰⁴ represents, for example, preferably a linear alkyl group or a branched alkyl group having 6 or more and 30 or less carbon atoms, more preferably a linear alkyl group or a branched alkyl group having 8 or more and 28 or less carbon atoms, still more preferably a linear alkyl group or a branched alkyl group having 9 or more and 26 or less carbon atoms, and particularly preferably a linear alkyl group or a branched alkyl group having 10 or more and 25 or less carbon atoms.

It is preferable that the unit (X2) is, for example, at least one of a unit (X2-1) represented by Formula (X2-1) or a unit (X2-2) represented by Formula (X2-2).

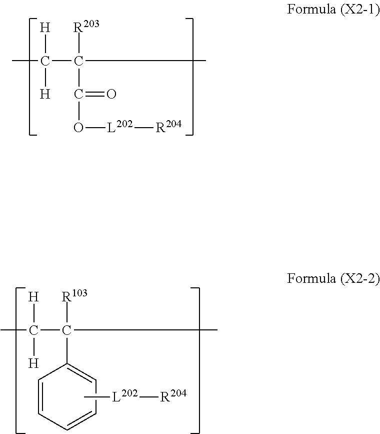

In Formulae (X2-1) and (X2-2), R²⁰³ represents a hydrogen atom or a methyl group, L²⁰² represents a single bond, an alkylene group having 1 or more and 5 or less carbon atoms, —O—, —C(═O)—, —C(═O)O—, or a combination thereof, and R²⁰⁴ represents an alkyl group having 6 or more and 30 or less carbon atoms.

R²⁰³ and R²⁰⁴ in Formulae (X2-1) and (X2-2) each have the same definition as that for R²⁰³, L²⁰², and R²⁰⁴ in Formula (X2), and the preferable forms thereof are the same as each other.

It is preferable that L²⁰² in Formula (X2-1) represents a single bond.

In Formula (X2-2), L²⁰² represents, for example, preferably a single bond, a linear alkylene group having 1 or more and 4 or less carbon atoms, —O—, —C(═O)—, —C(═O)O—, or a combination thereof and more preferably a single bond, a linear alkylene group having 1 or more and 3 or less carbon atoms, —O—, —C(═O)—, —C(═O)O—, or a combination thereof.

Among the atoms forming L²⁰², the number of atoms connecting the benzene ring and R²⁰⁴ in Formula (X2-2) at the shortest distance is, for example, preferably 1 or more and 5 or less, more preferably 1 or more and 3 or less, and still more preferably 1 or 2.

Specific examples of the unit (X2-1) will be shown below, but the unit (X2-1) is not limited thereto. Me represents a methyl group.

| | R [symbol] | L [symbol] | R [symbol] |
|---|---|---|---|
| X2-1-1 | H | Single bond | n-C [symbol] H [symbol] |
| X2-1-2 | Me | Single bond | n-C [symbol] H [symbol] |
| X2-1-3 | H | Single bond | n-C [symbol] H [symbol] |
| X2-1-4 | Me | Single bond | n-C [symbol] H [symbol] |
| X2-1-5 | H | Single bond | n-C [symbol] H [symbol] |
| X2-1-6 | Me | Single bond | n-C [symbol] H [symbol] |
| X2-1-7 | H | Single bond | n-C [symbol] H [symbol] |
| X2-1-8 | Me | Single bond | n-C [symbol] H [symbol] |
| X2-1-9 | H | Single bond | n-C [symbol] H [symbol] |
| X2-1-10 | Me | Single bond | n-C [symbol] H [symbol] |
| X2-1-11 | H | Single bond | n-C [symbol] H [symbol] |
| X2-1-12 | Me | Single bond | n-C [symbol] H [symbol] |
| X2-1-13 | H | Single bond | n-C [symbol] H [symbol] |
| X2-1-14 | Me | Single bond | n-C [symbol] H [symbol] |
| X2-1-15 | H | Single bond | —CH₂—CH(C [symbol] H [symbol] )—n-C [symbol] H [symbol] |
| X2-1-16 | Me | Single bond | —CH₂—CH(C [symbol] H [symbol] )—n-C [symbol] H [symbol] |
| X2-1-17 | H | Single bond | n-C [symbol] H [symbol] |
| X2-1-18 | Me | Single bond | n-C [symbol] H [symbol] |
| X2-1-19 | H | Single bond | n-C [symbol] H [symbol] |
| X2-1-20 | Me | Single bond | n-C [symbol] H [symbol] |
| X2-1-21 | H | Single bond | n-C [symbol] H [symbol] |
| X2-1-22 | Me | Single bond | n-C [symbol] H [symbol] |
| X2-1-23 | H | Single bond | —CH₂—CH(n-C [symbol] H [symbol] )—n-C [symbol] H [symbol] |
| X2-1-24 | Me | Single bond | —CH₂—CH(n-C [symbol] H [symbol] )—n-C [symbol] H [symbol] |

[symbol]

indicates data missing or illegible when filed

Specific examples of the unit (X2-2) will be shown below, but the unit (X2-2) is not limited thereto.

| | R²⁰³ | L²⁰² | R²⁰⁴ |
|---|---|---|---|
| X2-2-1 | H | —O—(C═O)— | n-C₆H₁₃ |
| X2-2-2 | H | —O—(C═O)— | n-C₇H₁₅ |
| X2-2-3 | H | —O—(C═O)— | n-C₁₁H₂₃ |
| X2-2-4 | H | —O—(C═O)— | n-C₁₇H₃₅ |
| X2-2-5 | H | —O—(C═O)— | n-C₂₁H₄₃ |
| X2-2-6 | H | —O—(C═O)— | —CH(C₂H₅)—n-C₄H₉ |
| X2-2-7 | H | —O—(C═O)— | —CH(n-C₆H₁₃)—n-C₈H₁₇ |
| X2-2-8 | H | —O—(C═O)— | n-C₂₅H₅₁ |
| X2-2-9 | H | —O—(C═O)— | n-C₂₇H₆₅ |
| X2-2-10 | H | —O—(C═O)— | n-C₂₉H₅₉ |
| X2-2-11 | H | —O— | n-C₁₈H₃₇ |
| X2-2-12 | H | —O— | n-C₂₂H₄₅ |
| X2-2-13 | H | —O—(C═O)O— | n-C₁₈H₃₇ |
| X2-2-14 | H | —O—(C═O)O— | n-C₂₂H₄₅ |
| X2-2-15 | H | —CH₂—O—(C═O)— | n-C₁₇H₃₅ |
| X2-2-16 | H | —CH₂—O—(C═O)— | n-C₂₁H₄₃ |

Specific examples of the unit (X2) other than the unit (X2-1) and the unit (X2-2) will be shown below, but the unit (X2) is not limited thereto.

| | R²⁰¹ | R²⁰² | R²⁰³ | L²⁰¹ | L²⁰² | R [symbol] |
|---|---|---|---|---|---|---|
| X2-E-1 | H | H | H | —O—(C═O)— | Single bond | n-C [symbol] H [symbol] |
| X2-E-2 | H | H | H | —O—(C═O)— | Single bond | n-C [symbol] H [symbol] |
| X2-E-3 | H | H | H | —O—(C═O)— | Single bond | n-C [symbol] H [symbol] |
| X2-E-4 | H | H | H | —O—(C═O)— | Single bond | —CH(n-C [symbol] H [symbol] )-n-C [symbol] H [symbol] |
| X2-E-5 | H | H | H | —O— | Single bond | n-C [symbol] H [symbol] |
| X2-E-6 | H | H | H | —O— | Single bond | n-C [symbol] H [symbol] |
| X2-E-7 | H | H | H | —CH₂—O— | Single bond | n-C [symbol] H [symbol] |
| X2-E-8 | H | H | H | —CH₂—O— | Single bond | n-C [symbol] H [symbol] |

[symbol]

indicates data missing or illegible when filed

The unit (X) of the resin (X) may be used alone or in combination of two or more kinds thereof.

The unit (X2) of the resin (X) may be used alone or in combination of two or more kinds thereof.

The resin (X) may have other constitutional units in addition to the unit (X1) and the unit (X2). Hereinafter, the other constitutional units are also referred to as a unit (X3). The unit (X3) may be used alone or in combination of two or more kinds thereof.

Examples of the unit (X3) include a unit derived from a styrene-based monomer and a unit derived from an acrylic monomer.

Examples of the styrene-based monomer include styrene and vinylnaphthalene; lower alkyl-substituted styrene such as α-methylstyrene, o-methylstyrene, m-methylstyrene, p-methylstyrene, p-ethylstyrene, 2,4-dimethylstyrene, p-n-butylstyrene, or p-tert-butylstyrene; aryl-substituted styrene such as p-phenylstyrene; lower alkoxy-substituted styrene such as p-methoxystyrene; and halogen-substituted styrene such as p-chlorostyrene, 3,4-dichlorostyrene, p-fluorostyrene, or 2,5-difluorostyrene.

Examples of the acrylic monomer include (meth)acrylic acid; (meth)acrylic acid lower alkyl ester such as methyl (meth)acrylate, ethyl (meth)acrylate, propyl (meth)acrylate, isopropyl (meth)acrylate, n-butyl (meth)acrylate, isobutyl (meth)acrylate, or n-pentyl (meth)acrylate; and benzyl (meth)acrylate. The term “(meth)acryl” may denote any of “acryl” or “methacryl”.

Examples of the unit (X3) include units derived from the following monomers.

Examples of the monomers include an olefin such as isoprene, butene, or butadiene; vinyl ether such as vinyl methyl ether or vinyl isobutyl ether; and vinyl ketone such as vinyl methyl ketone, vinyl ethyl ketone, or vinyl isopropenyl ketone.

As the unit (X3), for example, at least one selected from the group consisting of a unit derived from styrene, a unit derived from (meth)acrylic acid, and a unit derived from lower alkyl ester of (meth)acrylic acid is preferable, at least one selected from the group consisting of a unit derived from styrene and a unit derived from lower alkyl ester of (meth)acrylic acid is more preferable, and at least one selected from the group consisting of a unit derived from styrene, a unit derived from methyl (meth)acrylate, and a unit derived from ethyl (meth)acrylate is still more preferable.

The total content of the unit (X1) and the unit (X2) in the resin (X) is, for example, preferably 10% by mole or greater and 95% by mole or less, more preferably 15% by mole or greater and 90% by mole or less, and still more preferably 20% by mole or greater and 80% by mole or less.

That is, the content of the unit (X3) in the resin (X) is, for example, preferably 5% by mole or greater and 90% by mole or less, more preferably 10% by mole or greater and 85% by mole or less, and still more preferably 20% by mole or greater and 80% by mole or less.

The weight-average molecular weight of the resin (X) is, for example, preferably 5,000 or greater and 1,000,000 or less, more preferably 7,000 or greater and 500,000 or less, and still more preferably 10,000 or greater and 200,000 or less.

The molecular weight of the resin (X) is a molecular weight measured by gel permeation chromatography (GPC) in terms of polystyrene. The measurement according to GPC is performed by a method of the related art using, for example, tetrahydrofuran or chloroform as an eluent.

Examples of the method of producing the resin (X) include chain polymerization of a monomer providing a unit (X1), a monomer providing a unit (X2), and a monomer providing a unit (X3). Examples of the method of chain polymerization include radical polymerization, coordination polymerization, and ionic polymerization (such as cationic polymerization or anionic polymerization). Among these, from the viewpoints of polymerization control and the versatility such as the application range, for example, radical polymerization is preferable.

Conductive Substrate

Examples of the conductive substrate include metal plates containing metals (such as aluminum, copper, zinc, chromium, nickel, molybdenum, vanadium, indium, gold, and platinum) or alloys (such as stainless steel), metal drums, metal belts, and the like. Further, examples of the conductive substrate include paper, a resin film, a belt, and the like obtained by being coated, vapor-deposited or laminated with a conductive compound (such as a conductive polymer or indium oxide), a metal (such as aluminum, palladium, or gold) or an alloy. Here, the term “conductive” denotes that the volume resistivity is less than 1×10¹³ Ωcm.

In a case where the electrophotographic photoreceptor is used in a laser printer, for example, it is preferable that the surface of the conductive substrate is roughened such that a centerline average roughness Ra thereof is 0.04 μm or greater and 0.5 μm or less for the purpose of suppressing interference fringes from occurring in a case of irradiation with laser beams. In a case where incoherent light is used as a light source, roughening of the surface to prevent interference fringes is not particularly necessary and is appropriate for longer life because occurrence of defects due to the unevenness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment performed by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by anodization is chemically active in a natural state, is easily contaminated, and has a large resistance fluctuation depending on the environment. Therefore, for example, it is preferable that a sealing treatment is performed on the porous anodized film so that the micropores of the oxide film are closed by volume expansion due to a hydration reaction in pressurized steam or boiling water (a metal salt such as nickel may be added thereto) for a change into a more stable a hydrous oxide.

The film thickness of the anodized film is, for example, preferably 0.3 μm or greater and 15 μm or less. In a case where the film thickness is in the above-described range, the barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. In the blending ratio of phosphoric acid, chromic acid, and hydrofluoric acid to the acidic treatment liquid, for example, the concentration of the phosphoric acid is 10% by mass or greater and 11% by mass or less, the concentration of the chromic acid is 3% by mass or greater and 5% by mass or less, and the concentration of the hydrofluoric acid is 0.5% by mass or greater and 2% by mass or less, and the concentration of all these acids may be 13.5% by mass or greater and 18% by mass or less. The treatment temperature is, for example, preferably 42° C. or higher and 48° C. or lower. The film thickness of the coating film is, for example, preferably 0.3 μm or greater and 15 μm or less.

The boehmite treatment is carried out, for example, by immersing the conductive substrate in pure water at 90° C. or higher and 100° C. or lower for 5 minutes to 60 minutes or by bringing the conductive substrate into contact with heated steam at 90° C. or higher and 120° C. or lower for 5 minutes to 60 minutes. The film thickness of the coating film is, for example, preferably 0.1 μm or greater and 5 μm or less. This coating film may be further subjected to the anodizing treatment using an electrolytic solution having low film solubility, such as adipic acid, boric acid, a borate, a phosphate, a phthalate, a maleate, a benzoate, a tartrate, or a citrate.

Undercoat Layer

The undercoat layer is, for example, a layer containing inorganic particles and a binder resin.

Examples of the inorganic particles include inorganic particles having a powder resistance (volume resistivity) of 1×10² Ωcm or greater and 1×10¹¹ Ωcm or less.

Among these, as the inorganic particles having the above-described resistance value, for example, metal oxide particles such as tin oxide particles, titanium oxide particles, zinc oxide particles, and zirconium oxide particles may be used, and zinc oxide particles are particularly preferable.

The specific surface area of the inorganic particles measured by the BET method may be, for example, 10 m²/g or greater.

The volume average particle diameter of the inorganic particles may be, for example, 50 nm or greater and 2,000 nm or less (for example, preferably 60 nm or greater and 1,000 nm or less).

The content of the inorganic particles is, for example, preferably 10% by mass or greater and 80% by mass or less and more preferably 40% by mass or greater and 80% by mass or less with respect to the amount of the binder resin.

The inorganic particles may be subjected to a surface treatment. As the inorganic particles, inorganic particles subjected to different surface treatments or inorganic particles having different particle diameters may be used in the form of a mixture of two or more kinds thereof.

Examples of the surface treatment agent include a silane coupling agent, a titanate-based coupling agent, an aluminum-based coupling agent, and a surfactant. In particular, for example, a silane coupling agent is preferable, and a silane coupling agent containing an amino group is more preferable.

Examples of the silane coupling agent containing an amino group include 3-aminopropyltriethoxysilane, N-2-(aminoethyl)-3-aminopropyltrimethoxysilane, N-2-(aminoethyl)-3-aminopropylmethyldimethoxysilane, and N,N-bis(2-hydroxyethyl)-3-aminopropyltriethoxysilane, but are not limited thereto.

The silane coupling agent may be used in the form of a mixture of two or more kinds thereof. For example, a silane coupling agent containing an amino group and another silane coupling agent may be used in combination. Examples of other silane coupling agents include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane, but are not limited thereto.

The surface treatment method using a surface treatment agent may be any method as long as the method is a known method, and any of a dry method or a wet method may be used.

The treatment amount of the surface treatment agent is, for example, preferably 0.5% by mass or greater and 10% by mass or less with respect to the amount of the inorganic particles.

Here, the undercoat layer may contain, for example, an electron-accepting compound (acceptor compound) together with the inorganic particles from the viewpoint of enhancing the long-term stability of the electrical properties and the carrier blocking properties.

Examples of the electron-accepting compound include electron-transporting substances, for example, a quinone-based compound such as chloranil or bromanil; a tetracyanoquinodimethane-based compound; a fluorenone compound such as 2,4,7-trinitrofluorenone or 2,4,5,7-tetranitro-9-fluorenone; an oxadiazole-based compound such as 2-(4-biphenyl)-5-(4-t-butylphenyl)-1,3,4-oxadiazole, 2,5-bis(4-naphthyl)-1,3,4-oxadiazole, or 2,5-bis(4-diethylaminophenyl)-1,3,4-oxadiazole; a xanthone-based compound; a thiophene compound; a diphenoquinone compound such as 3,3′,5,5′-tetra-t-butyldiphenoquinone; and a benzophenone compound.

In particular, as the electron-accepting compound, for example, a compound having an anthraquinone structure is preferable. As the compound having an anthraquinone structure, for example, a hydroxyanthraquinone compound, an aminoanthraquinone compound, or an aminohydroxyanthraquinone compound is preferable, and specifically, for example, anthraquinone, alizarin, quinizarin, anthrarufin, or purpurin is preferable.

The electron-accepting compound may be contained in the undercoat layer in a state of being dispersed with inorganic particles or in a state of being attached to the surface of each inorganic particle.

Examples of the method of attaching the electron-accepting compound to the surface of the inorganic particle include a dry method and a wet method.

The dry method is, for example, a method of attaching the electron-accepting compound to the surface of each inorganic particle by adding the electron-accepting compound dropwise to inorganic particles directly or by dissolving the electron-accepting compound in an organic solvent while stirring the inorganic particles with a mixer having a large shearing force and spraying the mixture together with dry air or nitrogen gas. The electron-accepting compound may be added dropwise or sprayed, for example, at a temperature lower than or equal to the boiling point of the solvent. After the dropwise addition or the spraying of the electron-accepting compound, the compound may be further baked at 100° C. or higher. The baking is not particularly limited as long as the temperature and the time are adjusted such that the electrophotographic characteristics can be obtained.

The wet method is, for example, a method of attaching the electron-accepting compound to the surface of each inorganic particle by adding the electron-accepting compound to inorganic particles while dispersing the inorganic particles in a solvent using a stirrer, ultrasonic waves, a sand mill, an attritor, or a ball mill, stirring or dispersing the mixture, and removing the solvent. The solvent removing method is carried out by, for example, filtration or distillation so that the solvent is distilled off. After removal of the solvent, the mixture may be further baked at 100° C. or higher. The baking is not particularly limited as long as the temperature and the time are adjusted such that the electrophotographic characteristics can be obtained. In the wet method, the moisture contained in the inorganic particles may be removed before the electron-accepting compound is added, and examples thereof include a method of removing the moisture while stirring and heating the moisture in a solvent and a method of removing the moisture by azeotropically boiling the moisture with a solvent.

The electron-accepting compound may be attached to the surface before or after the inorganic particles are subjected to a surface treatment with a surface treatment agent or simultaneously with the surface treatment performed on the inorganic particles with a surface treatment agent.

The content of the electron-accepting compound may be, for example, 0.01% by mass or greater and 20% by mass or less and preferably 0.01% by mass or greater and 10% by mass or less with respect to the amount of the inorganic particles.

Examples of the binder resin used for the undercoat layer include known polymer compounds such as an acetal resin (such as polyvinyl butyral), a polyvinyl alcohol resin, a polyvinyl acetal resin, a casein resin, a polyamide resin, a cellulose resin, gelatin, a polyurethane resin, a polyester resin, an unsaturated polyester resin, a methacrylic resin, an acrylic resin, a polyvinyl chloride resin, a polyvinyl acetate resin, a vinyl chloride-vinyl acetate-maleic acid anhydride resin, a silicone resin, a silicone-alkyd resin, a urea resin, a phenol resin, a phenol-formaldehyde resin, a melamine resin, a urethane resin, an alkyd resin, and an epoxy resin, a zirconium chelate compound, a titanium chelate compound, an aluminum chelate compound, a titanium alkoxide compound, an organic titanium compound, and known materials such as a silane coupling agent.

Examples of the binder resin used for the undercoat layer include a charge-transporting resin containing a charge-transporting group, and a conductive resin (such as polyaniline).

Among these, as the binder resin used for the undercoat layer, for example, a resin insoluble in a coating solvent of the upper layer is preferable, and a resin obtained by reaction between a curing agent and at least one resin selected from the group consisting of a thermosetting resin such as a urea resin, a phenol resin, a phenol-formaldehyde resin, a melamine resin, a urethane resin, an unsaturated polyester resin, an alkyd resin, or an epoxy resin; a polyamide resin, a polyester resin, a polyether resin, a methacrylic resin, an acrylic resin, a polyvinyl alcohol resin, and a polyvinyl acetal resin is particularly preferable.

In a case where these binder resins are used in combination of two or more kinds thereof, the mixing ratio thereof is set as necessary.

The undercoat layer may contain various additives for improving the electrical properties, the environmental stability, and the image quality.

Examples of the additives include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for a surface treatment of the inorganic particles as described above, but may be further added to the undercoat layer as an additive.

Examples of the silane coupling agent serving as an additive include vinyltrimethoxysilane, 3-methacryloxypropyl-tris(2-methoxyethoxy)silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in the form of a mixture or a polycondensate of a plurality of compounds.

The undercoat layer may have, for example, a Vickers hardness of 35 or greater.

The surface roughness (ten-point average roughness) of the undercoat layer may be adjusted, for example, to ½ from 1/(4n) (n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. Further, the surface of the undercoat layer may be polished to adjust the surface roughness. Examples of the polishing method include buff polishing, a sandblast treatment, wet honing, and a grinding treatment.

The formation of the undercoat layer is not particularly limited, and a known forming method is used. For example, a coating film of a coating solution for forming an undercoat layer in which the above-described components are added to a solvent is formed, and the coating film is dried and, as necessary, heated.

Examples of the solvent for preparing the coating solution for forming an undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of these solvents include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming an undercoat layer include known methods such as a roll mill, a ball mill, a vibration ball mill, an attritor, a sand mill, a colloid mill, and a paint shaker.

Examples of the method of coating the conductive substrate with the coating solution for forming an undercoat layer include typical coating methods such as a blade coating method, a wire bar coating method, a spray coating method, a dip coating method, a bead coating method, an air knife coating method, and a curtain coating method.

The average thickness of the undercoat layer is, for example, preferably 10 μm or greater and 50 μm or less and more preferably 15 μm or greater and 40 μm or less.

Interlayer

An interlayer may be further provided between the undercoat layer and the photosensitive layer.

The interlayer is, for example, a layer containing a resin. Examples of the resin used for the interlayer include a polymer compound, for example, an acetal resin (such as polyvinyl butyral), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic acid anhydride resin, a silicone resin, a silicone-alkyd resin, a phenol-formaldehyde resin, or a melamine resin.

The interlayer may be a layer containing an organometallic compound. Examples of the organometallic compound used for the interlayer include an organometallic compound containing metal atoms such as zirconium, titanium, aluminum, manganese, and silicon.

The compounds used for the interlayer may be used alone or in the form of a mixture or a polycondensate of a plurality of compounds.

Among these, it is preferable that the interlayer is, for example, a layer containing an organometallic compound having a zirconium atom or a silicon atom.

The formation of the interlayer is not particularly limited, and a known forming method is used. For example, a coating film of a coating solution for forming an interlayer in which the above-described components are added to a solvent is formed, and the coating film is dried and, as necessary, heated.

Examples of the coating method of forming the interlayer include typical coating methods such as a dip coating method, a push-up coating method, a wire bar coating method, a spray coating method, a blade coating method, an air knife coating method, and a curtain coating method.

The average thickness of the interlayer is, for example, preferably 0.1 μm or greater and 3 μm or less. The interlayer may be used as the undercoat layer.

Charge Generation Layer

The charge generation layer is, for example, a layer containing a charge generation material and a binder resin. Further, the charge generation layer may be a deposition layer of the charge generation material. The deposition layer of the charge generation material is, for example, appropriate in a case where an incoherent light source such as a light emitting diode (LED) or an organic electroluminescence (EL) image array is used.

Examples of the charge generation material include an azo pigment such as bisazo or trisazo; a fused ring aromatic pigment such as dibromoanthanthrone; a perylene pigment; a pyrrolopyrrole pigment; a phthalocyanine pigment; zinc oxide; and trigonal selenium.

Among these, for example, a metal phthalocyanine pigment or a metal-free phthalocyanine pigment is preferably used as the charge generation material in order to deal with laser exposure in a near infrared region. Specifically, for example, hydroxygallium phthalocyanine, chlorogallium phthalocyanine, dichloro-tin phthalocyanine, and titanyl phthalocyanine are more preferable.

On the other hand, for example, a fused ring aromatic pigment such as dibromoanthanthrone, a thioindigo-based pigment, a porphyrazine compound, zinc oxide, trigonal selenium, or a bisazo pigment is preferable as the charge generation material in order to deal with laser exposure in a near ultraviolet region.

The above-described charge generation material may also be used even in a case where an incoherent light source such as an LED or an organic EL image array having a center wavelength of light emission at 450 nm or greater and 780 nm or less is used, but from the viewpoint of the resolution, the field intensity in the photosensitive layer is increased, and a decrease in charge due to injection of a charge from the substrate, that is, image defects referred to as so-called black spots are likely to occur in a case where a thin film having a thickness of 20 μm or less is used as the photosensitive layer. The above-described tendency is evident in a case where a p-type semiconductor such as trigonal selenium or a phthalocyanine pigment is used as the charge generation material that is likely to generate a dark current.

On the other hand, in a case where an n-type semiconductor such as a fused ring aromatic pigment, a perylene pigment, or an azo pigment is used as the charge generation material, a dark current is unlikely to be generated, and image defects referred to as black spots can be suppressed even in a case where a thin film is used as the photosensitive layer. The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (a polycondensate of bisphenols and aromatic divalent carboxylic acid), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” denotes that the volume resistivity is 1×10¹³ Ωcm or greater.

These binder resins may be used alone or in the form of a mixture of two or more kinds thereof.

The blending ratio between the charge generation material and the binder resin is, for example, preferably in a range of 10:1 to 1:10 in terms of the mass ratio.

The charge generation layer may also contain other known additives.

The formation of the charge generation layer is not particularly limited, and a known forming method is used. For example, a coating film of a coating solution for forming a charge generation layer in which the above-described components are added to a solvent is formed, and the coating film is dried and, as necessary, heated. The charge generation layer may be formed by vapor deposition of the charge generation material. The formation of the charge generation layer by vapor deposition is, for example, particularly appropriate in a case where a fused ring aromatic pigment or a perylene pigment is used as the charge generation material.

Examples of the solvent for preparing the coating solution for forming a charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. These solvents are used alone or in the form of a mixture of two or more kinds thereof.

As a method of dispersing particles (for example, the charge generation material) in the coating solution for forming a charge generation layer, for example, a media disperser such as a ball mill, a vibration ball mill, an attritor, a sand mill, or a horizontal sand mill, or a medialess disperser such as a stirrer, an ultrasonic disperser, a roll mill, or a high-pressure homogenizer is used. Examples of the high-pressure homogenizer include a collision type homogenizer in which a dispersion liquid is dispersed by a liquid-liquid collision or a liquid-wall collision in a high-pressure state, and a penetration type homogenizer in which a dispersion liquid is dispersed by penetrating the liquid through a micro-flow path in a high-pressure state.

During the dispersion, it is effective to set the average particle diameter of the charge generation material in the coating solution for forming a charge generation layer to 0.5 μm or less, for example, preferably 0.3 μm or less, and more preferably 0.15 μm or less.

Examples of the method of coating the undercoat layer (or the interlayer) with the coating solution for forming a charge generation layer include typical methods such as a blade coating method, a wire bar coating method, a spray coating method, a dip coating method, a bead coating method, an air knife coating method, and a curtain coating method.

The average thickness of the charge generation layer is, for example, preferably 0.1 μm or greater and 5.0 μm or less and more preferably 0.2 μm or greater and 2.0 μm or less.

Charge Transport Layer

The charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, or anthraquinone; a tetracyanoquinodimethane-based compound; a fluorenone compound such as 2,4,7-trinitrofluorenone; a xanthone compound; a benzophenone-based compound; a cyanovinyl-based compound; and an electron-transporting compound such as an ethylene-based compound. Examples of the charge transport material include a positive hole-transporting compound such as a triarylamine-based compound, a benzidine-based compound, an arylalkane-based compound, an aryl-substituted ethylene-based compound, a stilbene-based compound, an anthracene-based compound, or a hydrazone-based compound. These charge transport materials may be used alone or in combination of two or more kinds thereof, but are not limited thereto.

Examples of the polymer charge transport material include known compounds having charge transport properties, such as poly-N-vinylcarbazole and polysilane. For example, a polyester-based polymer charge transport material is preferable. The polymer charge transport material may be used alone or in combination with a binder resin.

Examples of the charge transport material or the polymer charge transport material include a polycyclic aromatic compound, an aromatic nitro compound, an aromatic amine compound, a heterocyclic compound, a hydrazone compound, a styryl compound, an enamine compound, a benzidine compound, a triarylamine compound (particularly, a triphenylamine compound), a diamine compound, an oxadiazole compound, a carbazole compound, an organic polysilane compound, a pyrazoline compound, an indole compound, an oxazole compound, an isoxazole compound, a thiazole compound, a thiadiazole compound, an imidazole compound, a pyrazole compound, a triazole compound, a cyano compound, a benzofuran compound, an aniline compound, a butadiene compound, and a resin containing a group derived from any of these substances. Specific examples thereof include compounds described in paragraphs 0078 to 0080 of JP2021-117377A, paragraphs 0046 to 0048 of JP2019-035900A, paragraphs 0052 and 0053 of JP2019-012141A, paragraphs 0122 to 0134 of JP2021-071565A, paragraphs 0101 to 0110 of JP2021-015223A, paragraph 0116 of JP2013-097300A, paragraphs 0309 to 0316 of WO2019/070003A, paragraphs 0103 to 0107 of JP2018-159087A, and paragraphs 0102 to 0113 of JP2021-148818A.

From the viewpoint of the charge mobility, it is preferable that the charge transport material contains, for example, at least one selected from the group consisting of a compound (D1) represented by Formula (D1), a compound (D2) represented by Formula (D2), a compound (D3) represented by Formula (D3), and a compound (D4) represented by Formula (D4).

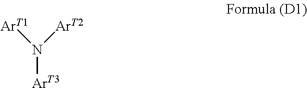

In Formula (D1), Ar^{T1}, Ar^{T2}, and Ar^{T3} each independently represent an aryl group, —C₆H₄—C(R^{T4})═C(R^{T5})(R^{T6}) or —C₆H₄—CH═CH—CH═C(R^{T7})(R^{T8}), and R^{T4}, R^{T5}, R^{T6}, R^{T7}, and R^{T8} each independently represent a hydrogen atom, an alkyl group, or an aryl group. In a case where R^{T5} and R^{T6} represent an aryl group, the aryl groups may be linked via a divalent group of —C(R⁵¹)(R⁵²)— and/or —C(R⁶¹)═C(R⁶²)—. R⁵¹, R⁵², R⁶¹, and R⁶² each independently represent a hydrogen atom or an alkyl group having 1 or more and 3 or less carbon atoms.

The group in Formula (D1) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the compound (D1), for example, a compound containing at least one of an aryl group or —C₆H₄—CH═CH—CH═C(R^{T7})(R^{T8}) is preferable, and a compound (D′1) represented by Formula (D′1) is more preferable.

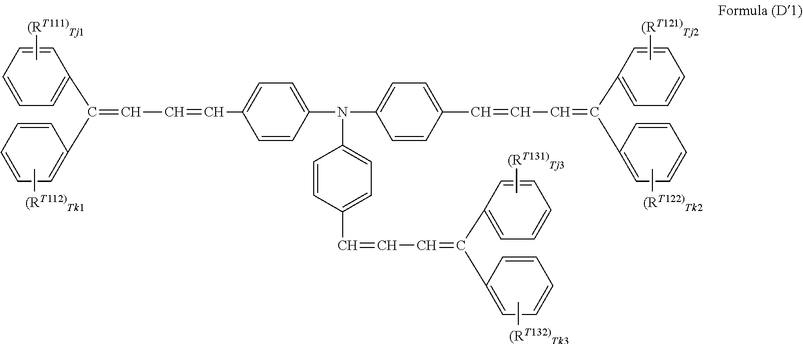

In Formula (D′1), R^{T111}, R^{T112}, R^{T121}, R^{T122}, R^{T131}, and R^{T132} each independently represent a hydrogen atom, a halogen atom, an alkyl group (for example, preferably an alkyl group having 1 or more and 3 or less carbon atoms), an alkoxy group (for example, preferably an alkoxy group having 1 or more and 3 or less carbon atoms), a phenyl group, or a phenoxy group. Tj1, Tj2, Tj3, Tk1, Tk2, and Tk3 each independently represent 0, 1, or 2.

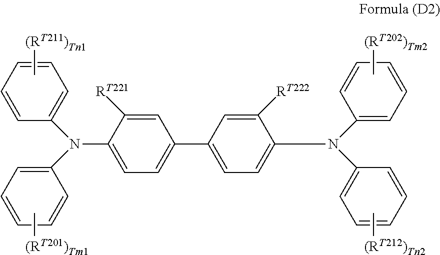

In Formula (D2), R^{T201}, R^{T202}, R^{T211}, and R^{T212} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T21})═C(R^{T22})(R^{T23}), or —CH═CH—CH═C(R^{T24})(R^{T25}). R^{T21}, R^{T22}, R^{T23}, R^{T24}, and R^{T25} each independently represent a hydrogen atom, an alkyl group, or an aryl group. R^{T221} and R^{T222} each independently represent a hydrogen atom, a halogen atom, an alkyl group having 1 or more and 5 or less carbon atoms, or an alkoxy group having 1 or more and 5 or less carbon atoms. Tm1, Tm2, Tn1, and Tn2 each independently represent 0, 1, or 2.

The group in Formula (D2) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

From the viewpoint of the charge mobility, as the compound (D2), for example, a compound containing at least one of an alkyl group, an aryl group, or —CH═CH—CH═C(R^{T24})(R^{T25}) is preferable, and a compound containing two of an alkyl group, an aryl group, or —CH═CH—CH═C(R^{T24})(R^{T25}) is more preferable.

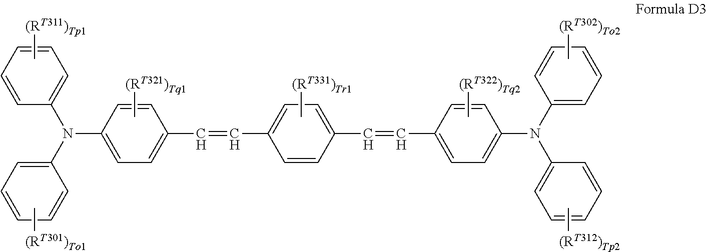

In Formula (D3), R^{T301}, R^{T302}, R^{T311}, and R^{T312} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T31})═C(R^{T32})(R^{T33}), or —CH═CH—CH═C(R^{T34})(R^{T35}), R^{T31}, R^{T32}, R^{T33}, R^{T34}, and R^{T35} each independently represent a hydrogen atom, an alkyl group, or an aryl group. R^{T321}, R^{T322}, and R^{T331} each independently represent a hydrogen atom, a halogen atom, an alkyl group having 1 or more and 5 or less carbon atoms, or an alkoxy group having 1 or more and 5 or less carbon atoms. To1, To2, Tp1, Tp2, Tq1, Tq2, and Tr1 each independently represent 0, 1, or 2.

The group in Formula (D3) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

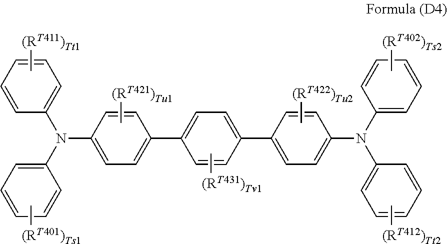

In Formula (D4), R^{T401}, R^{T402}, R^{T411}, and R^{T412} each independently represent a halogen atom, an alkyl group having 1 or more and 5 or less carbon atoms, an alkoxy group having 1 or more and 5 or less carbon atoms, an amino group substituted with an alkyl group having 1 or 2 carbon atoms, an aryl group, —C(R^{T41})═C(R^{T42})(R^{T43}), or —CH═CH—CH═C(R^{T44})(R^{T45}). R^{T41}, R^{T42}, R^{T43}, R^{T44}, and R^{T45} each independently represent a hydrogen atom, an alkyl group, or an aryl group. R^{T421}, R^{T422}, and R^{T431} each independently represent a hydrogen atom, a halogen atom, an alkyl group having 1 or more and 5 or less carbon atoms, or an alkoxy group having 1 or more and 5 or less carbon atoms. Ts1, Ts2, Tt1, Tt2, Tu1, Tu2, and Tv1 each independently represent 0, 1, or 2.

The group in Formula (D4) may be substituted with a halogen atom, an alkyl group having 1 or more and 5 or less carbon atoms, an alkoxy group having 1 or more and 5 or less carbon atoms, or a substituted amino group substituted with an alkyl group having 1 or more and 3 or less carbon atoms.

The content of the charge transport material contained in the charge transport layer is, for example, preferably 20% by mass or greater and 70% by mass or less with respect to the total mass of the charge transport layer.

The charge transport layer contains at least one of a polyester resin (PEz) or a polycarbonate resin (PCz) as a binder resin and, for example, preferably at least a polyester resin (PEz). The total proportion of the polyester resin (PEz) and the polycarbonate resin (PCz) in the total amount of the binder resin contained in the charge transport layer is, for example, preferably 60% by mass or greater, more preferably 70% by mass or greater, still more preferably 80% by mass or greater, and particularly preferably 90% by mass or greater.

The charge transport layer may contain other binder resins in addition to the polyester resin (PEz) and the polycarbonate resin (PCz). Examples of other binder resins include a polyester resin other than the polyester resin (PEz), a polycarbonate resin other than the polycarbonate resin (PCz), a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic acid anhydride copolymer, a silicone resin, a silicone alkyd resin, a phenol-formaldehyde resin, a styrene-alkyd resin, poly-N-vinylcarbazole, and polysilane. These binder resins may be used alone or in combination of two or more kinds thereof.

The charge transport layer may also contain other known additives. Examples of the additives include an antioxidant, a leveling agent, an antifoaming agent, a filler, and a viscosity adjuster.

The formation of the charge transport layer is not particularly limited, and a known forming method is used. For example, a coating film of a coating solution for forming a charge transport layer in which the above-described components are added to a solvent is formed, and the coating film is dried and, as necessary, heated.

Examples of the solvent for preparing the coating solution for forming a charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. These solvents are used alone or in the form of a mixture of two or more kinds thereof.

Examples of the coating method of coating the charge generation layer with the coating solution for forming a charge transport layer include typical methods such as a blade coating method, a wire bar coating method, a spray coating method, a dip coating method, a bead coating method, an air knife coating method, and a curtain coating method.

The average thickness of the charge transport layer is greater than 30 μm and less than 50 μm, for example, preferably greater than 32 μm and less than 48 μm, more preferably greater than 35 μm and less than 45 μm, and still more preferably greater than 38 μm and less than 43 μm.

Single Layer Type Photosensitive Layer

The single layer type photosensitive layer (charge generation/charge transport layer) is a layer containing a charge generation material, a charge transport material, a binder resin, and as necessary, other additives. These materials are the same as the materials described in the sections of the charge generation layer and the charge transport layer.

The single layer type photosensitive layer contains at least one of a polyester resin (PEz) or a polycarbonate resin (PCz) as a binder resin and, for example, preferably at least a polyester resin (PEz). The proportion of the total amount of the polyester resin (PEz) and the polycarbonate resin (PCz) in the total amount of the binder resin contained in the single layer type photosensitive layer is, for example, preferably 60% by mass or greater, more preferably 70% by mass or greater, still more preferably 80% by mass or greater, and particularly preferably 90% by mass or greater.

The content of the charge generation material in the single layer type photosensitive layer may be, for example, 0.1% by mass or greater and 10% by mass or less and preferably 0.8% by mass or greater and 5% by mass or less with respect to the total solid content.

The content of the charge transport material contained in the single layer type photosensitive layer may be, for example, 40% by mass or greater and 60% by mass or less with respect to the total solid content.

The method of forming the single layer type photosensitive layer is the same as the method of forming the charge generation layer or the charge transport layer.

The average thickness of the single layer type photosensitive layer is greater than 30 μm and less than 50 μm, for example, preferably greater than 32 μm and less than 48 μm, more preferably greater than 35 μm and less than 45 μm, and still more preferably greater than 38 μm and less than 43 μm.

Protective Layer

A protective layer is provided on the photosensitive layer as necessary. The protective layer is provided, for example, for the purpose of preventing a chemical change in the photosensitive layer during charging and further improving the mechanical strength of the photosensitive layer.

Therefore, for example, a layer formed of a cured film (crosslinked film) may be applied to the protective layer. Examples of these layers include the layers described in the items 1) and 2) below.
1) A layer formed of a cured film of a composition containing a reactive group-containing charge transport material having a reactive group and a charge-transporting skeleton in an identical molecule (that is, a layer containing a polymer or a crosslinked body of the reactive group-containing charge transport material)
2) A layer formed of a cured film of a composition containing a non-reactive charge transport material and a reactive group-containing non-charge transport material containing a reactive group without having a charge-transporting skeleton (that is, a layer containing the non-reactive charge transport material and a polymer or crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization and is, for example, a functional group containing a group having at least a carbon double bond. Specific examples thereof include a vinyl group, a vinyl ether group, a vinyl thioether group, a phenyl vinyl group, a vinyl phenyl group, an acryloyl group, a methacryloyl group, and a group containing at least one selected from derivatives thereof. Among these, from the viewpoint that the reactivity is excellent, for example, a vinyl group, a phenylvinyl group, a vinylphenyl group, an acryloyl group, a methacryloyl group, and a group containing at least one selected from derivatives thereof are preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, or a hydrazone-based compound. Among these, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming a protective layer in which the above-described components are added to a solvent is formed, and the coating film is dried and, as necessary, subjected to a curing treatment such as heating.

Examples of the solvent for preparing the coating solution for forming a protective layer include an aromatic solvent such as toluene or xylene; a ketone-based solvent such as methyl ethyl ketone, methyl isobutyl ketone, or cyclohexanone; an ester-based solvent such as ethyl acetate or butyl acetate; an ether-based solvent such as tetrahydrofuran or dioxane; a cellosolve-based solvent such as ethylene glycol monomethyl ether; and an alcohol-based solvent such as isopropyl alcohol or butanol. These solvents are used alone or in the form of a mixture of two or more kinds thereof.

The coating solution for forming a protective layer may be a solvent-less coating solution.

Examples of the method of coating the photosensitive layer (such as the charge transport layer) with the coating solution for forming a protective layer include typical coating methods such as a dip coating method, a push-up coating method, a wire bar coating method, a spray coating method, a blade coating method, an air knife coating method, and a curtain coating method.

The average thickness of the protective layer is, for example, preferably 1 μm or greater and 20 μm or less and more preferably 2 μm or greater and 10 μm or less.

Image Forming Apparatus and Process Cartridge

An image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. Further, the electrophotographic photoreceptor according to the present exemplary embodiment is employed as the electrophotographic photoreceptor.

As the image forming apparatus according to the present exemplary embodiment, known image forming apparatuses such as an apparatus including a fixing device that fixes a toner image transferred to the surface of a recording medium; a direct transfer type apparatus that transfers a toner image formed on the surface of an electrophotographic photoreceptor directly to a recording medium; an intermediate transfer type apparatus that primarily transfers a toner image formed on the surface of an electrophotographic photoreceptor to the surface of an intermediate transfer member and secondarily transfers the toner image transferred to the surface of the intermediate transfer member to the surface of a recording medium; an apparatus including a cleaning device that cleans the surface of an electrophotographic photoreceptor after the transfer of a toner image and before the charging; an apparatus including a destaticizing device that destaticizes the surface of an electrophotographic photoreceptor by irradiating the surface with destaticizing light after the transfer of a toner image and before the charging; and an apparatus including an electrophotographic photoreceptor heating member for increasing the temperature of an electrophotographic photoreceptor and decreasing the relative temperature are employed.

In a case of the intermediate transfer type apparatus, the transfer device is, for example, configured to include an intermediate transfer member having a surface onto which the toner image is transferred, a primary transfer device primarily transferring the toner image formed on the surface of the electrophotographic photoreceptor to the surface of the intermediate transfer member, and a secondary transfer device secondarily transferring the toner image transferred to the surface of the intermediate transfer member to the surface of the recording medium.

The image forming apparatus according to the present exemplary embodiment may be any of a dry development type image forming apparatus or a wet development type (development type using a liquid developer) image forming apparatus.

In the image forming apparatus according to the present exemplary embodiment, for example, the portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. Further, the process cartridge may include, for example, at least one selected from the group consisting of a charging device, an electrostatic latent image forming device, a developing device, and a transfer device in addition to the electrophotographic photoreceptor.

Hereinafter, an example of the image forming apparatus according to the present exemplary embodiment will be described, but the present exemplary embodiment is not limited thereto. Further, main parts shown in the figures will be described, but description of other parts will not be provided.

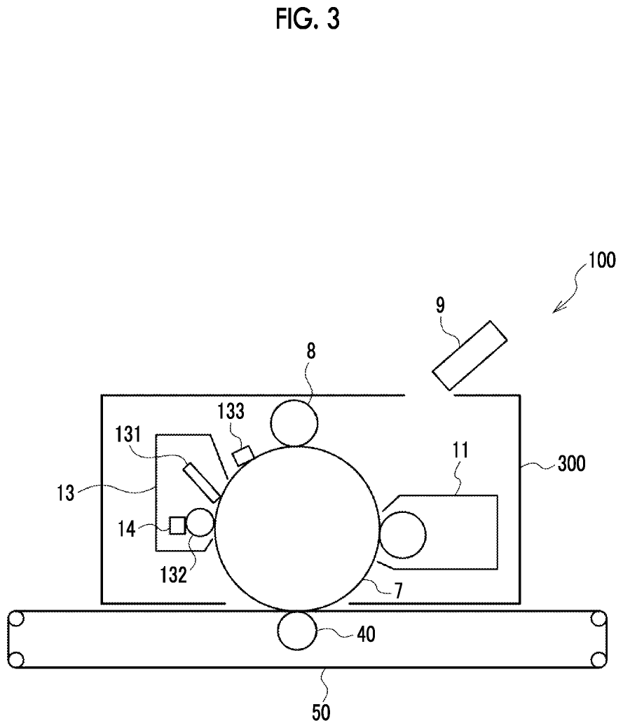

FIG. 3 is a schematic configuration view showing an example of an image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of an electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300, the transfer device 40 is disposed at a position that faces the electrophotographic photoreceptor 7 via the intermediate transfer member 50, and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). Further, the intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of the cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists cleaning, but these are disposed as necessary.

Hereinafter, each configuration of the image forming apparatus according to the present exemplary embodiment will be described.

Charging Device

As the charging device 8, for example, a contact-type charger formed of a conductive or semi-conductive charging roller, a charging brush, a charging film, a charging rubber blade, a charging tube, or the like is used. Further, a known charger such as a non-contact type roller charger, or a scorotron charger or a corotron charger using corona discharge is also used.

Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. The wavelength of the light source is within the spectral sensitivity region of the electrophotographic photoreceptor. As the wavelength of a semiconductor laser, near infrared, which has an oscillation wavelength in the vicinity of 780 nm, is mostly used. However, the wavelength is not limited thereto, and a laser having an oscillation wavelength at a level of 600 nm or a laser having an oscillation wavelength of 400 nm or greater and 450 nm or less as a blue laser may also be used. Further, a surface emission type laser light source capable of outputting a multi-beam is also effective for forming a color image.

Developing Device

Examples of the developing device 11 include a typical developing device that performs development in contact or non-contact with the developer. The developing device 11 is not particularly limited as long as the developing device has the above-described functions, and is selected depending on the purpose thereof. Examples of the developing device include known developing machines having a function of attaching a one-component developer or a two-component developer to the electrophotographic photoreceptor 7 using a brush, a roller, or the like. Among these, for example, a developing device formed of a developing roller having a surface on which a developer is held is preferably used.

The developer used in the developing device 11 may be a one-component developer containing only a toner or a two-component developer containing a toner and a carrier. Further, the developer may be magnetic or non-magnetic. Known developers are employed as these developers.

Cleaning Device

As the cleaning device 13, a cleaning blade type device including the cleaning blade 131 is used. In addition to the cleaning blade type device, a fur brush cleaning type device or a simultaneous development cleaning type device may be employed.

Transfer Device

Examples of the transfer device 40 include a known transfer charger such as a contact-type transfer charger using a belt, a roller, a film, a rubber blade, or the like, or a scorotron transfer charger or a corotron transfer charger using corona discharge.

Intermediate Transfer Member

As the intermediate transfer member 50, a belt-like intermediate transfer member (intermediate transfer belt) containing semi-conductive polyimide, polyamide-imide, polycarbonate, polyarylate, polyester, rubber, or the like is used. Further, as the form of the intermediate transfer member, a drum-like intermediate transfer member may be used in addition to the belt-like intermediate transfer member.

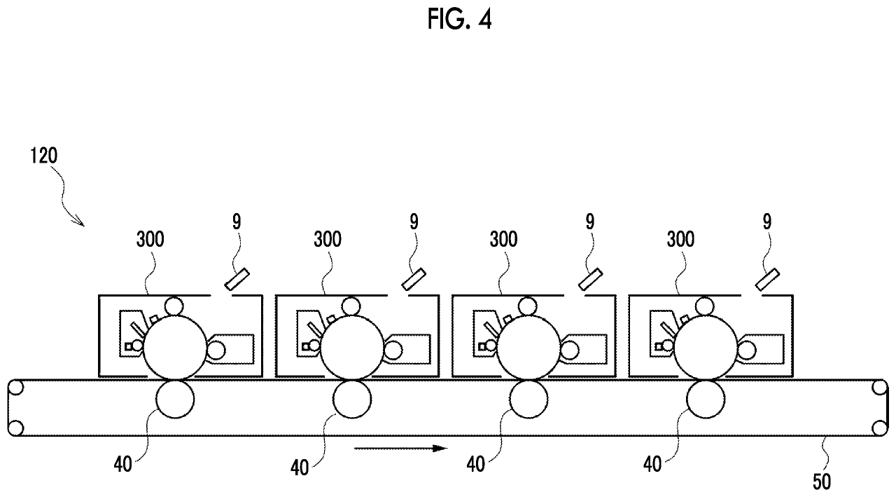

FIG. 4 is a schematic configuration view showing an example of an image forming apparatus according to the present exemplary embodiment.

An image forming apparatus 120 shown in FIG. 4 is a tandem type multicolor image forming apparatus on which four process cartridges 300 are mounted. The image forming apparatus 120 is formed such that four process cartridges 300 are arranged in parallel on the intermediate transfer member 50, and one electrophotographic photoreceptor is used for each color. The image forming apparatus 120 has the same configuration as the image forming apparatus 100 except that the image forming apparatus 120 is of a tandem type.

### EXAMPLES

Hereinafter, exemplary embodiments of the invention will be described in detail based on examples, but the exemplary embodiments of the invention are not limited to the examples.

In the following description, “parts” and “%” are on a mass basis unless otherwise specified.

In the following description, the synthesis, the treatment, the production, and the like are carried out at room temperature (25° C.±3° C.) unless otherwise specified.

Production of Resin for Photosensitive Layer

Polyester Resin

A polyester resin (PEz1) or the like, which is a polyester resin (PEz), is produced.

Tables 1 to 3 and 5 show units and compositions constituting the polyester resin (PEz1) and the like.

Tables 1 to 3 and 5 show “constitutional unit:compositional ratio” (for example, A3-2:50). The compositional ratio is in units of % by mole of each of the dicarboxylic acid unit and the diol unit.

A3-2 and the like listed in Table 1 and the like are specific examples of the dicarboxylic acid unit (A) described above.

B4-4 and the like listed in Table 1 and the like are specific examples of the diol unit (B) described above.

Z1-1-15 and the like listed in Table 1 and the like are specific examples of the structure (Z1) described above.

Z2-1-1 and the like listed in Table 1 and the like are specific examples of the structure (Z2) described above.

A polyester resin (PEc1) that does not have the structure (Z1) and the structure (Z2) at a terminal is produced as a comparative polyester resin. Table 1 and the like show units and compositions constituting the polyester resin (PEc1).

Polycarbonate Resin

A polycarbonate resin (PC-1) or the like, which is a polycarbonate resin (PCz), is produced. Table 4 shows units and compositions constituting the polycarbonate resin (PC-1).

Table 4 shows “constitutional unit:compositional ratio” (for example, Cb6-3:100). The compositional ratio of each constitutional unit is in units of % by mole.

Cb6-3 and the like listed in Table 4 are specific examples of the constitutional unit (C) described above.

Z1-1-15 listed in Table 4 is a specific example of the structure (Z1) described above.

A polycarbonate resin (SC-2) that does not have the structure (Z1) and the structure (Z2) at a terminal is produced as a comparative polycarbonate resin. Table 4 shows units and compositions constituting the polycarbonate resin (SC-2).

Lubricating Resin

A resin (X1-1a) or the like, which is the resin (X), is produced. Tables 1 to 5 show units and compositions constituting the resin (X).

Tables 1 to 5 show “constitutional unit:compositional ratio” (for example, X1-1-14:15). The compositional ratio of each constitutional unit is in units of % by mole.

X1-1-14 and the like listed in Table 1 and the like are specific examples of the structure (X1) described above.

X2-1-10 and the like listed in Table 1 and the like are specific examples of the structure (X2) described above.

The unit (X3) constituting the resin (X) is a constitutional unit derived from the following monomers.

X3-1: methyl methacrylate

X3-2: styrene

XC-1 used in the comparative example is a polycarbonate resin having a siloxane structure at a terminal and has the repeating unit and the terminal structure described below.

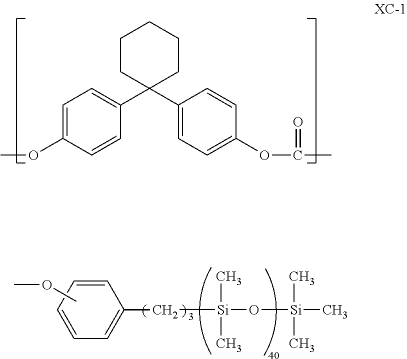

Production of Photoreceptor Including Lamination Type Photosensitive Layer Example S1

An aluminum cylindrical tube having an outer diameter of 30 mm, a length of 250 mm, and a thickness of 1 mm is prepared as a conductive substrate.

Formation of Undercoat Layer

100 parts of zinc oxide (average particle diameter of 70 nm, specific surface area of 15 m²/g, manufactured by Tayca Corporation) is stirred and mixed with 500 parts of toluene, 1.3 parts of a silane coupling agent (trade name: KBM603, manufactured by Shin-Etsu Chemical Co., Ltd., N-2-(aminoethyl)-3-aminopropyltrimethoxysilane) is added thereto, and the mixture is stirred for 2 hours. Thereafter, toluene is distilled off under reduced pressure and baked at 120° C. for 3 hours to obtain zinc oxide subjected to a surface treatment with a silane coupling agent.

110 parts of the surface-treated zinc oxide is stirred and mixed with 500 parts of tetrahydrofuran, a solution obtained by dissolving 0.6 part of alizarin in 50 parts of tetrahydrofuran is added thereto, and the mixture is stirred at 50° C. for 5 hours. Thereafter, the solid content is separated by filtration by carrying out filtration under reduced pressure and dried at 60° C. under reduced pressure, thereby obtaining zinc oxide with alizarin.

0 parts of a solution obtained by dissolving 60 parts of the zinc oxide with alizarin, 13.5 parts of a curing agent (blocked isocyanate, trade name: SUMIDUR 3175, manufactured by Sumitomo Bayer Urethane Co., Ltd.), and 15 parts of a butyral resin (trade name: S-LEC BM-1, manufactured by Sekisui Chemical Co., Ltd.) in 68 parts of methyl ethyl ketone is mixed with 5 parts of methyl ethyl ketone, and the solution is dispersed in a sand mill for 2 hours using 1 mmφ glass beads, thereby obtaining a dispersion liquid. 0.005 part of dioctyltin dilaurate as a catalyst and 4 parts of silicone resin particles (trade name: TOSPEARL 145, manufactured by Momentive Performance Materials Inc.) are added to the dispersion liquid, thereby obtaining a coating solution for forming an undercoat layer. The outer peripheral surface of the conductive substrate is coated with the coating solution for forming an undercoat layer by a dip coating method, and dried and cured at 170° C. for 40 minutes to form an undercoat layer. The average thickness of the undercoat layer is 25 μm.

Formation of Charge Generation Layer

A mixture of 15 parts of hydroxygallium phthalocyanine as a charge generation material (Bragg angle (2θ+0.2°) of the X-ray diffraction spectrum using Cuka characteristic X-ray has diffraction peaks at positions at least of 7.5°, 9.9°, 12.5, 16.3°, 18.6°, 25.1°, and 28.3°), 10 parts of a vinyl chloride-vinyl acetate copolymer resin (trade name: VMCH, Nippon Unicar Company Limited) as a binder resin, and 200 parts of n-butyl acetate is dispersed in a sand mill for 4 hours using glass beads having a diameter of 1 mm. 175 parts of n-butyl acetate and 180 parts of methyl ethyl ketone are added to the dispersion liquid, and the mixture is stirred, thereby obtaining a coating solution for forming a charge generation layer. The undercoat layer is immersed in and coated with the coating solution for forming a charge generation layer, and dried at room temperature (25° C. 3° C.) to form a charge generation layer having an average thickness of 0.18 μm.

Formation of Charge Transport Layer

5 parts of the polyester resin (PEz1), 5 parts of the resin (X1-1a), and 40 parts of the charge transport material CTM-1 are dissolved in 270 parts of tetrahydrofuran and 30 parts of toluene, thereby obtaining a coating solution for forming a charge transport layer. The charge generation layer is immersed in and coated with the coating solution for forming a charge transport layer, and dried at 145° C. for 30 minutes to form a charge transport layer. The average thickness of the charge transport layer is as listed in Table 1.

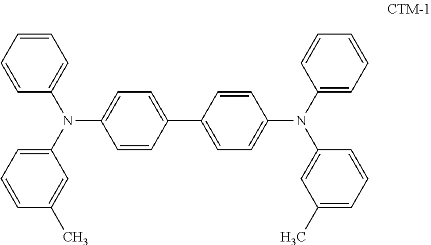 [SMILES: Cc1cccc(N(c2ccccc2)c2ccc(-c3ccc(N(c4ccccc4)c4cccc(C)c4)cc3)cc2)c1]

### Examples S2 to S37 and S40 to S43 and Comparative Examples SC1 to SC8

Each photoreceptor is prepared in the same manner as in Example Si except that the kind and the content of the resin of the charge transport layer, the kind of the charge transport material of the charge transport layer, and the average thickness of the charge transport layer are changed to the specifications listed in Table 1. The charge transport materials CTM-2 to CTM-5 are the following compounds.

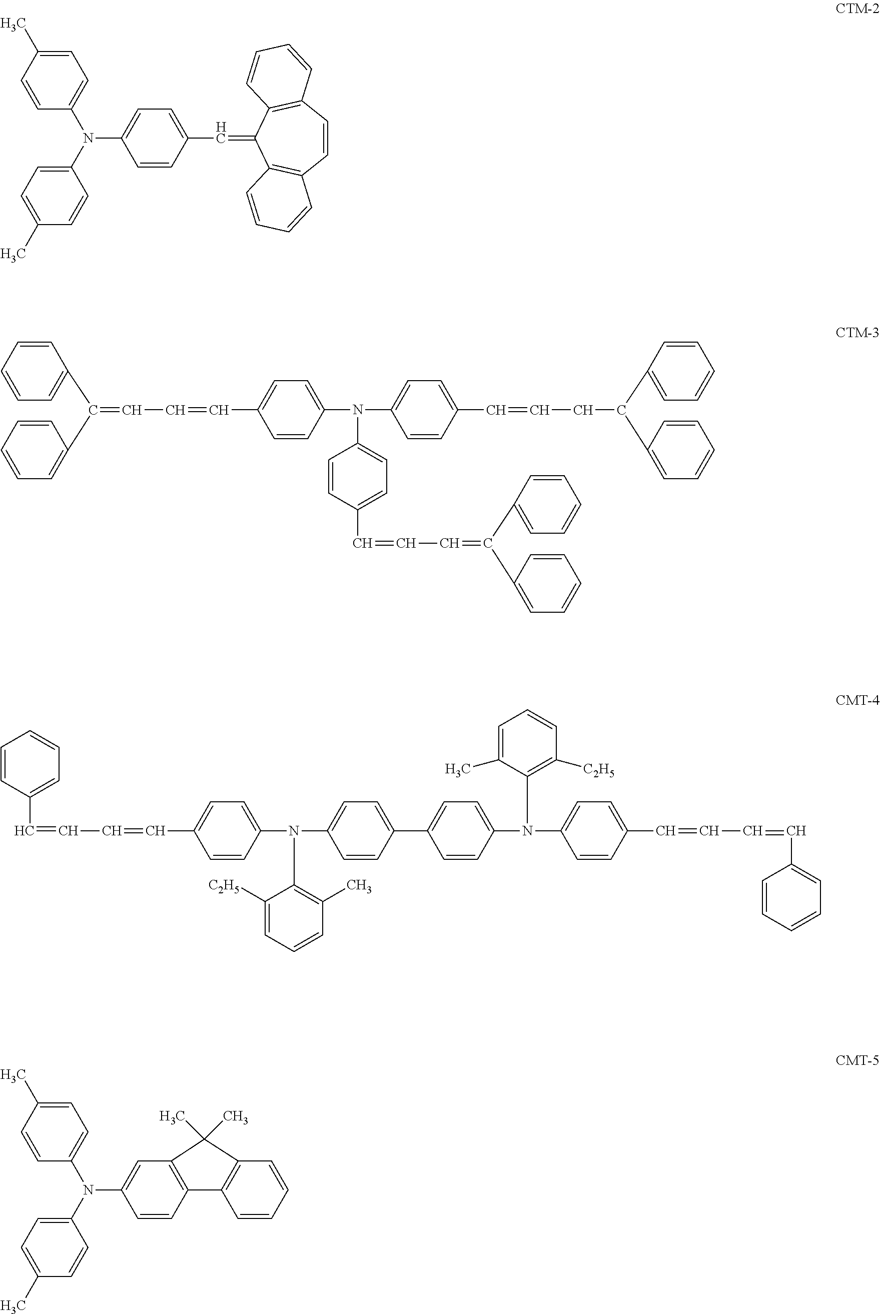 [SMILES: Cc1ccc(N(c2ccc(C)cc2)c2ccc(C=C3c4ccccc4C=Cc4ccccc43)cc2)cc1 ; C(=Cc1ccc(N(c2ccc(C=CC=C(c3ccccc3)c3ccccc3)cc2)c2ccc(C=CCC(c3ccccc3)c3ccccc3)cc2)cc1)C=C(c1ccccc1)c1ccccc1 ; CCc1cccc(C)c1N(c1ccc(C=CC=Cc2ccccc2)cc1)c1ccc(-c2ccc(N(c3ccc(C=CC=Cc4ccccc4)cc3)c3c(C)cccc3CC)cc2)cc1 ; Cc1ccc(N(c2ccc(C)cc2)c2ccc3c(c2)C(C)(C)c2ccccc2-3)cc1]

### Example S38

A photoreceptor is prepared in the same manner as in Example S3 except that alizarin is changed to 2,3,4-trihydroxybenzophenone in the formation of the undercoat layer and the average thickness of the charge transport layer is changed.

### Example S39

A photoreceptor is prepared in the same manner as in Example S2 except that zinc oxide (average particle diameter of 70 nm, specific surface area of 15 m²/g, manufactured by Tayca Corporation) is changed to titanium oxide (MT-500B, average particle diameter of 35 nm, manufactured by Tayca Corporation) in the formation of the undercoat layer and the average thickness of the charge transport layer is changed.

Production of Photoreceptor Including Single Layer Type Photosensitive Layer

### Example T1

An aluminum cylindrical tube having an outer diameter of 30 mm, a length of 250 mm, and a thickness of 1 mm is prepared as a conductive substrate.

Formation of Single Layer Type Photosensitive Layer

42.25 parts of the polyester resin (PC-1), 3.5 parts of the resin (X1-1a), 1.25 parts of V-type hydroxygallium phthalocyanine as a charge generation material (Bragg angle (2θ+0.2°) of the X-ray diffraction spectrum using Cuka characteristic X-ray has diffraction peaks at positions of at least 7.3°, 16.0°, 24.9°, and 28.0°), 9 parts of ETM-1 as an electron transport material, 44 parts of CTM-1 as a charge transport material, and 175 parts of tetrahydrofuran and 75 parts of toluene as solvents are mixed, and the mixture is subjected to a dispersion treatment in a sand mill for 4 hours using glass beads having a diameter of 1 mm, thereby obtaining a coating solution for forming a photosensitive layer. The outer peripheral surface of the conductive substrate is immersed in and coated with the coating solution for forming a photosensitive layer and dried and cured at a temperature of 110° C. for 40 minutes, thereby forming a single layer type photosensitive layer. The average thickness of the single layer type photosensitive layer is as listed in Table 5.

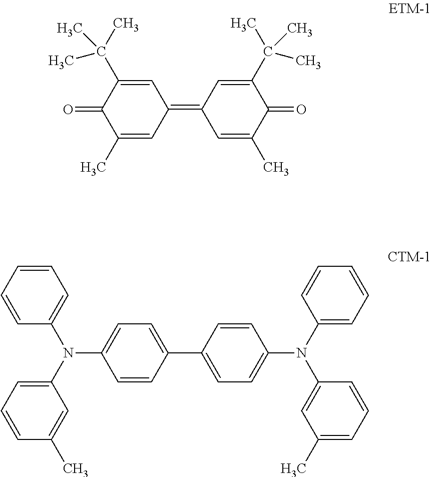 [SMILES: CC1=C/C(=C2\C=C(C)C(=O)C(C(C)(C)C)=C2)C=C(C(C)(C)C)C1=O ; Cc1cccc(N(c2ccccc2)c2ccc(-c3ccc(N(c4ccccc4)c4cccc(C)c4)cc3)cc2)c1]

### Examples T2 to T13 and Comparative Examples TC1 to TC3

Each photoreceptor is prepared in the same manner as in Example T1 except that the kind and the content of the resin of the single layer type photosensitive layer and the average thickness of the single layer type photosensitive layer are changed to the specifications listed in Table 5.

Performance Evaluation of Photoreceptor and Image Forming Apparatus

Each photoreceptor of the examples or the comparative examples is mounted on an image forming apparatus Apeos C7070 (manufactured by FUJIFILM Business Innovation Corporation). The image quality stability is evaluated from the following three viewpoints.

Environmental Stability

A black solid image with an image density (area coverage) of 100% is continuously output onto 500 sheets of A4 size plain paper in an environment of a temperature of 10° C. and a relative humidity of 15% (low temperature and low humidity), and an entire surface halftone image with an image density of 30% is output onto one sheet of A4 size plain paper. The entire surface halftone image is visually observed, and streak image defects are classified into the following A to E.

The same evaluation as described above is performed in an environment of a temperature of 28° C. and a relative humidity of 85% (high temperature and high humidity).

The results are listed in Tables 6 to 10.
A: Streak defects are not found and the image quality is not problematic at all.
B: Minor streak defects are found at an acceptable level in practical use.
C: Streak defects are found in a part of the image at a level that cannot be ignored in terms of the image quality.
D: Streak defects are found in more than half of the image at a level that cannot be ignored in terms of the image quality.
E: Streak defects are found in the entire image at an unacceptable level in practical use.

Image Density Stability

A chart image with an image density (area coverage) of 10% is continuously output onto 5,000 sheets of A4 size plain paper in an environment of a temperature of 28° C. and a relative humidity of 85% (high temperature and high humidity), and an entire surface halftone image with an image density of 30% is output onto one sheet of A4 size plain paper. The entire surface halftone image is observed visually and with a loupe, and the graininess of the image is classified into the following A to E.

The same evaluation as described above is performed by changing the chart image to a chart image with an image density (area coverage) of 1%. As the image density (area coverage, AC) decreases, the amount of the external additive supplied to the surface of the photoreceptor from the toner decreases and friction between the photoreceptor and the cleaning blade increases.

The results are listed in Tables 6 to 10.
A: Image defects are not found.
B: A trace amount of image defects are found in a case where the images are viewed with a loupe, but the amount of image defects is within a practically acceptable range.
C: Image defects are visually observed.
D: Image defects are visually observed in an elongated streak shape.
E: Image defects are visually observed in an elongated streak shape. Density unevenness is clearly confirmed.

Environmental Stability in Long-Term Traveling

A black solid image with an image density (area coverage) of 100% is continuously output onto 50,000 sheets of A4 size plain paper in an environment of a temperature of 10° C. and a relative humidity of 15% (low temperature and low humidity), and an entire surface halftone image with an image density of 30% is output onto one sheet of A4 size plain paper. The entire surface halftone image is visually observed, and streak image defects are classified into the following A to E.

The same evaluation as described above is performed in an environment of a temperature of 28° C. and a relative humidity of 85% (high temperature and high humidity).

The results are listed in Tables 6 to 10.
A: Streak defects are not found and the image quality is not problematic at all.
B: Minor streak defects are found at an acceptable level in practical use.
C: Streak defects are found in a part of the image at a level that cannot be ignored in terms of the image quality.
D: Streak defects are found in more than half of the image at a level that cannot be ignored in terms of the image quality.
E: Streak defects are found in the entire image at an unacceptable level in practical use.

In Tables 1 to 5, the structure (Z1) and the structure (Z2) are collectively referred to as “structure (Z)”.

In Tables 1 to 5, “content” of each resin is the mass proportion of each resin in the total solid content of the charge transport layer or the single layer type photosensitive layer.

In Tables 1 to 5, “proportion of resin (X)” is the mass proportion of the resin (X) in the total amount of the polyester resin, the polycarbonate resin, and the resin (X) in the charge transport layer or the single layer type photosensitive layer.

In the comparative example in which XC-1 is used in place of the resin (X), “proportion of the resin (X)” and “M_{Z}/M_{X}×100” are calculated by regarding XC-1 as the resin (X).

TABLE 1

| | Charge transport layer | | | | | | | | |
|---|---|---|---|---|---|---|---|---|---|
| | | | | | | | Resin (X) or other | | |
| | Polyester resin | | | | | | lubricating resins | | |
| | | Unit | Unit | Structure | | | | Unit | Unit |
| | Resin | (A) | (B) | (Z) | Mw | Content | Resin | (X1) | (X2) |
| | No. | mol % | mol % | — | ×10000 | mass % | No. | mol % | mol % |
| Comparative | PEc1 | A3-2:50 | B4-4:50 | None | 9.5 | 55.00 | X1-1a | X1-1-14:15 | — |
| example SC1 | | | | | | | | X1-1-15:15 | |
| Comparative | PEz1 | A3-2:50 | B4-4:50 | Z1-1-15 | 10.0 | 55.00 | XC-1 | — | — |
| example SC2 | | | | | | | | | |
| Comparative | PEz1 | A3-2:50 | B4-4:50 | Z1-1-15 | 10.0 | 55.00 | X1-1b | X1-1-14:15 | — |
| example SC3 | | | | | | | | X1-1-15:15 | |
| Example S1 | PEz1 | A3-2:50 | B4-4:50 | Z1-1-15 | 10.0 | 55.00 | X1-1b | X1-1-14:15 | — |
| | | | | | | | | X1-1-15:15 | |
| Example S2 | PEz2 | A2-3:50 | B1-4:50 | Z1-1-15 | 11.5 | 55.00 | X1-1a | X1-1-14:15 | — |
| | | | | | | | | X1-1-15:15 | |
| Example S3 | PEz2 | A2-3:50 | B1-4:50 | Z1-1-15 | 11.5 | 55.00 | X1-1b | X1-1-14:15 | — |
| | | | | | | | | X1-1-15:15 | |
| Example S4 | PEz2 | A2-3:50 | B1-4:50 | Z1-1-15 | 11.5 | 55.00 | X1-1b | X1-1-14:15 | — |
| | | | | | | | | X1-1-15:15 | |
| Example S5 | PEz2 | A2-3:50 | B1-4:50 | Z1-1-15 | 11.5 | 55.00 | X1-1a | X1-1-14:15 | — |
| | | | | | | | | X1-1-15:15 | |
| Example S6 | PEz2 | A2-3:50 | B1-4:50 | Z1-1-15 | 11.5 | 55.00 | X1-1b | X1-1-14:15 | — |
| | | | | | | | | X1-1-15:15 | |
| Example S7 | PEz2 | A2-3:50 | B1-4:50 | Z1-1-15 | 11.5 | 55.00 | X1-1a | X1-1-14:15 | — |
| | | | | | | | | X1-1-15:15 | |
| Comparative | PEz2 | A2-3:50 | B1-4:50 | Z1-1-15 | 11.5 | 59.75 | X1-1a | X1-1-14:15 | — |
| example SC4 | | | | | | | | X1-1-15:15 | |
| Comparative | PEz2 | A2-3:50 | B1-4:50 | Z1-1-15 | 11.5 | 40.00 | X1-1a | X1-1-14:15 | — |
| example SC5 | | | | | | | | X1-1-15:15 | |
| Example S8 | PEz3 | A2-3:50 | B1-4:50 | Z1-1-7 | 11.5 | 55.00 | X1-1b | X1-1-14:15 | — |
| | | | | | | | | X1-1-15:15 | |
| Example S9 | PEz4 | A2-3:50 | B1-4:50 | Z1-1-4 | 11.5 | 55.00 | X1-1a | X1-1-14:15 | — |
| | | | | | | | | X1-1-15:15 | |
| Example S10 | PEz5 | A2-3:50 | B1-4:50 | Z2-1-1 | 11.5 | 55.00 | X1-1a | X1-1-14:15 | — |
| | | | | | | | | X1-1-15:15 | |
| Example S11 | PEz6 | A2-3:50 | B1-4:50 | Z2-E-2 | 11.5 | 55.00 | X1-1b | X1-1-14:15 | — |
| | | | | | | | | X1-1-15:15 | |

| | Charge transport layer | | | | | | |
|---|---|---|---|---|---|---|---|
| | Resin (X) or other lubricating resins | | | Proportion | | Charge | Average |
| | Unit | | | of resin | Mz/Mx × | transport | layer |
| | (X3) | Mw | Content | (X) | 100 | material | thickness |
| | mol % | ×10000 | mass % | mass % | — | — | μm |
| Comparative | X3-1:70 | 15.0 | 5.00 | 8.3 | 0 | CTM-1 | 37 |
| example SC1 | | | | | | | |
| Comparative | — | 13.0 | 5.00 | 8.3 | 5.5 | CTM-1 | 37 |
| example SC2 | | | | | | | |
| Comparative | X3-2:70 | 15.0 | 5.00 | 8.3 | 5.5 | CTM-1 | 30 |
| example SC3 | | | | | | | |
| Example S1 | X3-2:70 | 15.0 | 5.00 | 8.3 | 5.5 | CTM-1 | 37 |
| Example S2 | X3-1:70 | 15.0 | 5.00 | 8.3 | 5.5 | CTM-1 | 31 |
| Example S3 | X3-2:70 | 15.0 | 5.00 | 8.3 | 5.5 | CTM-1 | 34 |
| Example S4 | X3-2:70 | 15.0 | 5.00 | 8.3 | 5.5 | CTM-1 | 36 |
| Example S5 | X3-1:70 | 15.0 | 5.00 | 8.3 | 5.5 | CTM-1 | 40 |
| Example S6 | X3-2:70 | 15.0 | 5.00 | 8.3 | 5.5 | CTM-1 | 44 |
| Example S7 | X3-1:70 | 15.0 | 5.00 | 8.3 | 5.5 | CTM-1 | 47 |
| Comparative | X3-1:70 | 15.0 | 0.25 | 0.4 | 119.5 | CTM-1 | 40 |
| example SC4 | | | | | | | |
| Comparative | X3-1:70 | 15.0 | 20.00 | 33.3 | 1.0 | CTM-1 | 40 |
| example SC5 | | | | | | | |
| Example S8 | X3-2:70 | 15.0 | 5.00 | 8.3 | 5.5 | CTM-1 | 40 |
| Example S9 | X3-1:70 | 15.0 | 5.00 | 8.3 | 5.5 | CTM-1 | 40 |
| Example S10 | X3-1:70 | 15.0 | 5.00 | 8.3 | 5.5 | CTM-1 | 40 |
| Example S11 | X3-2:70 | 15.0 | 5.00 | 8.3 | 5.5 | CTM-1 | 40 |

TABLE 2

| | Charge transport layer | | | | | | | | |
|---|---|---|---|---|---|---|---|---|---|
| | | | | | | | Resin (X) or other | | |
| | Polyester resin | | | | | | lubricating resins | | |
| | | Unit | Unit | Structure | | | | Unit | Unit |
| | Resin | (A) | (B) | (Z) | Mw | Content | Resin | (X1) | (X2) |
| | No. | mol % | mo1% | — | ×10000 | mass % | No. | mol % | mol % |
| Example | PEz2 | A2-3:50 | B1-4:50 | Z1-1-15 | 11.5 | 55.00 | X1-1c | X1-1-14:15 | — |
| S12 | | | | | | | | X1-1-15:15 | |
| Example | PEz2 | A2-3:50 | B1-4:50 | Z1-1-15 | 11.5 | 55.00 | X1-1d | X1-1-6:30 | — |
| S13 | | | | | | | | | |
| Example | PEz2 | A2-3:50 | B1-4:50 | Z1-1-15 | 11.5 | 55.00 | X1-1e | X1-1-23:15 | — |
| S14 | | | | | | | | X1-1-24:15 | |
| Example | PEz2 | A2-3:50 | B1-4:50 | Z1-1-15 | 11.5 | 55.00 | X1-1f | X1-2-9:30 | — |
| S15 | | | | | | | | | |
| Example | PEz2 | A2-3:50 | B1-4:50 | Z1-1-15 | 11.5 | 55.00 | X1-1g | — | X2-1-10:30 |
| S16 | | | | | | | | | |
| Example | PEz2 | A2-3:50 | B1-4:50 | Z1-1-15 | 11.5 | 55.00 | X1-1h | — | X2-1-4:30 |
| S17 | | | | | | | | | |
| Example | PEz2 | A2-3:50 | B1-4:50 | Z1-1-15 | 11.5 | 55.00 | X1-1i | — | X2-1-2:30 |
| S18 | | | | | | | | | |
| Example | PEz2 | A2-3:50 | B1-4:50 | Z1-1-15 | 11.5 | 55.00 | X1-1j | — | X2-1-24:30 |
| S19 | | | | | | | | | |
| Example | PEz2 | A2-3:50 | B1-4:50 | Z1-1-15 | 11.5 | 55.00 | X1-1k | — | X2-2-4:30 |
| S20 | | | | | | | | | |
| Example | PEz2 | A2-3:50 | B1-4:50 | Z1-1-15 | 11.5 | 55.00 | X1-1n | — | X2-2-7:30 |
| S21 | | | | | | | | | |
| Example | PEz2 | A2-3:50 | B1-4:50 | Z1-1-15 | 11.5 | 42.00 | X1-1b | X1-1-14:15 | — |
| S22 | | | | | | | | X1-1-15:15 | |
| Example | PEz17 | A2-3:50 | B1-4:50 | Z1-1-15 | 6.5 | 59.70 | X1-1b | X1-1-14:15 | — |
| S23 | | | | | | | | X1-1-15:15 | |

| | Charge transport layer | | | | | | |
|---|---|---|---|---|---|---|---|
| | Resin (X) or other lubricating resins | | | Proportion | | Charge | Average |
| | Unit | | | of resin | Mz/Mx × | transport | layer |
| | (X3) | Mw | Content | (X) | 100 | material | thickness |
| | mol % | ×10000 | mass % | mass % | — | — | μm |
| Example | X3-1:70 | 40.0 | 5.00 | 8.3 | 5.5 | CTM-1 | 40 |
| S12 | | | | | | | |
| Example | X3-2:70 | 11.0 | 5.00 | 8.3 | 5.5 | CTM-1 | 40 |
| S13 | | | | | | | |
| Example | X3-2:70 | 15.0 | 5.00 | 8.3 | 5.5 | CTM-1 | 40 |
| S14 | | | | | | | |
| Example | X3-2:70 | 15.0 | 5.00 | 8.3 | 5.5 | CTM-1 | 40 |
| S15 | | | | | | | |
| Example | X3-2:70 | 15.0 | 5.00 | 8.3 | 5.5 | CTM-1 | 40 |
| S16 | | | | | | | |
| Example | X3-1:70 | 15.0 | 5.00 | 8.3 | 5.5 | CTM-1 | 40 |
| S17 | | | | | | | |
| Example | X3-1:70 | 15.0 | 5.00 | 8.3 | 5.5 | CTM-1 | 40 |
| S18 | | | | | | | |
| Example | X3-1:70 | 15.0 | 5.00 | 8.3 | 5.5 | CTM-1 | 40 |
| S19 | | | | | | | |
| Example | X3-2:70 | 15.0 | 5.00 | 8.3 | 5.5 | CTM-1 | 40 |
| S20 | | | | | | | |
| Example | X3-2:70 | 15.0 | 5.00 | 8.3 | 5.5 | CTM-1 | 40 |
| S21 | | | | | | | |
| Example | X3-2:70 | 15.0 | 18.00 | 30 | 0.9 | CTM-1 | 40 |
| S22 | | | | | | | |
| Example | X3-2:70 | 15.0 | 0.30 | 0.5 | 417.9 | CTM-1 | 40 |
| S23 | | | | | | | |

TABLE 3

| | Charge transport layer | | | | | | | | |
|---|---|---|---|---|---|---|---|---|---|
| | | | | | | | Resin (X) or other | | |
| | Polyester resin | | | | | | lubricating resins | | |
| | | Unit | Unit | Structure | | | | Unit | Unit |
| | Resin | (A) | (B) | (Z) | Mw | Content | Resin | (X1) | (X2) |
| | No. | mol % | mol % | — | ×10000 | mass % | No. | mo1% | mol% |
| Example | PEz7 | A2-3:50 | B5-1:50 | Z1-1-15 | 10.5 | 55.00 | X1-1a | X1-1-14:15 | — |
| S24 | | | | | | | | X1-1-15:15 | |
| Example | PEz8 | A2-3:50 | B1-2:50 | Z1-1-15 | 11.0 | 55.00 | X1-1a | X1-1-14:15 | — |
| S25 | | | | | | | | X1-1-15:15 | |
| Example | PEz9 | A2-3:50 | B2-6:50 | Z1-1-15 | 10.0 | 55.00 | X1-1b | X1-1-14:15 | — |
| S26 | | | | | | | | X1-1-15:15 | |
| Example | PEz10 | A3-2:50 | B1-2:50 | Z1-1-15 | 11.0 | 55.00 | X1-1a | X1-1-14:15 | — |
| S27 | | | | | | | | X1-1-15:15 | |
| Example | PEz11 | A3-2:40 | B6-4:50 | Z1-1-15 | 9.5 | 55.00 | X1-1a | X1-1-14:15 | — |
| S28 | | A4-3:10 | | | | | | X1-1-15:15 | |
| Example | PEz12 | A1-1:25 | B4-3:50 | Z1-1-15 | 9.0 | 55.00 | X1-1b | X1-1-14:15 | — |
| S29 | | A1-7:25 | | | | | | X1-1-15:15 | |
| Example | PEz13 | A2-3:40 | B1-2:50 | Z1-1-15 | 12.0 | 55.00 | X1-1a | X1-1-14:15 | — |
| S30 | | A3-2:10 | | | | | | X1-1-15:15 | |
| Example | PEz14 | A2-3:40 | B5-4:50 | Z1-1-15 | 9.0 | 55.00 | X1-1b | X1-1-14:15 | — |
| S31 | | A4-3:10 | | | | | | X1-1-15:15 | |
| Example | PEz15 | A2-3:40 | B2-6:50 | Z1-1-15 | 9.0 | 55.00 | X1-1a | X1-1-14:15 | — |
| S32 | | A1-7:10 | | | | | | X1-1-15:15 | |
| Example | PEz16 | A3-2:50 | B3-3:40 | Z1-1-15 | 9.5 | 55.00 | X1-1b | X1-1-14:15 | — |
| S33 | | | B7:2:10 | | | | | X1-1-15:15 | |
| Example | PEz2 | A2-3:50 | B1-4:50 | Z1-1-15 | 11.5 | 55.00 | X1-1a | X1-1-14:15 | — |
| S34 | | | | | | | | X1-1-15:15 | |
| Example | PEz2 | A2-3:50 | B1-4:50 | Z1-1-15 | 11.5 | 55.00 | X1-1b | X1-1-14:15 | — |
| S35 | | | | | | | | X1-1-15:15 | |
| Example | PEz2 | A2-3:50 | B1-4:50 | Z1-1-15 | 11.5 | 55.00 | X1-1a | X1-1-14:15 | — |
| S36 | | | | | | | | X1-1-15:15 | |
| Example | PEz2 | A2-3:50 | B1-4:50 | Z1-1-15 | 11.5 | 55.00 | X1-1a | X1-1-14:15 | — |
| S37 | | | | | | | | X1-1-15:15 | |
| Example | PEz2 | A2-3:50 | B1-4:50 | Z1-1-15 | 11.5 | 55.00 | X1-1b | X1-1-14:15 | — |
| S38 | | | | | | | | X1-1-15:15 | |
| Example | PEz2 | A2-3:50 | B1-4:50 | Z1-1-15 | 11.5 | 55.00 | X1-1a | X1-1-14:15 | — |
| S39 | | | | | | | | X1-1-15:15 | |

| | Charge transport layer | | | | | | |
|---|---|---|---|---|---|---|---|
| | Resin (X) or other lubricating resins | | | Proportion | | Charge | Average |
| | Unit | | | of resin | Mz/Mx × | transport | layer |
| | (X3) | Mw | Content | (X) | 100 | material | thickness |
| | mol % | ×10000 | mass % | mass % | — | — | μm |
| Example | X3-1:70 | 15.0 | 5.00 | 8.3 | 5.5 | CTM-1 | 41 |
| S24 | | | | | | | |
| Example | X3-1:70 | 15.0 | 5.00 | 8.3 | 5.5 | CTM-1 | 41 |
| S25 | | | | | | | |
| Example | X3-2:70 | 15.0 | 5.00 | 8.3 | 5.5 | CTM-1 | 41 |
| S26 | | | | | | | |
| Example | X3-1:70 | 15.0 | 5.00 | 8.3 | 5.5 | CTM-1 | 41 |
| S27 | | | | | | | |
| Example | X3-1:70 | 15.0 | 5.00 | 8.3 | 5.5 | CTM-1 | 41 |
| S28 | | | | | | | |
| Example | X3-2:70 | 15.0 | 5.00 | 8.3 | 5.5 | CTM-1 | 41 |
| S29 | | | | | | | |
| Example | X3-1:70 | 15.0 | 5.00 | 8.3 | 5.5 | CTM-1 | 41 |
| S30 | | | | | | | |
| Example | X3-2:70 | 15.0 | 5.00 | 8.3 | 5.5 | CTM-1 | 41 |
| S31 | | | | | | | |
| Example | X3-1:70 | 15.0 | 5.00 | 8.3 | 5.5 | CTM-1 | 41 |
| S32 | | | | | | | |
| Example | X3-2:70 | 15.0 | 5.00 | 8.3 | 5.5 | CTM-1 | 41 |
| S33 | | | | | | | |
| Example | X3-1:70 | 15.0 | 5.00 | 8.3 | 5.5 | CTM-2 | 40 |
| S34 | | | | | | | |
| Example | X3-2:70 | 15.0 | 5.00 | 8.3 | 5.5 | CTM-3 | 40 |
| S35 | | | | | | | |
| Example | X3-1:70 | 15.0 | 5.00 | 8.3 | 5.5 | CTM-4 | 40 |
| S36 | | | | | | | |
| Example | X3-1:70 | 15.0 | 5.00 | 8.3 | 5.5 | CTM-5 | 40 |
| S37 | | | | | | | |
| Example | X3-2:70 | 15.0 | 5.00 | 8.3 | 5.5 | CTM-1 | 39 |
| S38 | | | | | | | |
| Example | X3-1:70 | 15.0 | 5.00 | 8.3 | 5.5 | CTM-1 | 39 |
| S39 | | | | | | | |

TABLE 4

| | Charge transport layer | | | | | | | | |
|---|---|---|---|---|---|---|---|---|---|
| | | | | | | | Resin (X) or other | | |
| | Polycarbonate resin | | | | | | lubricating resins | | |
| | | | | Unit | | | | Unit | Unit |
| | Resin | Unit (C) | | (Z) | Mw | Content | Resin | (X1) | (X2) |
| | No. | mol % | mol % | — | ×10000 | mass % | No. | mol % | mol % |
| Comparative | SC-2 | Cb6-3:100 | — | None | 9.0 | 55.00 | X1-1a | X1-1-14:15 | — |
| Example | | | | | | | | X1-1-15:15 | |
| SC6 | | | | | | | | | |
| Comparative | PC-1 | Cb6-3:100 | — | Z1-1-15 | 9.0 | 55.00 | XC-1 | — | — |
| Example | | | | | | | | | |
| SC7 | | | | | | | | | |
| Comparative | PC-1 | Cb6-3:100 | — | Z1-1-15 | 9.0 | 55.00 | X1-1b | X1-1-14:15 | — |
| Example | | | | | | | | X1-1-15:15 | |
| SC8 | | | | | | | | | |
| Example | PC-1 | Cb6-3:100 | — | Z1-1-15 | 9.0 | 55.00 | X1-1b | X1-1-14:15 | — |
| S40 | | | | | | | | X1-1-15:15 | |
| Example | PC-2 | Cb6-3:80 | Cb7-1:20 | Z1-1-15 | 9.0 | 55.00 | X1-1b | X1-1-14:15 | — |
| S41 | | | | | | | | X1-1-15:15 | |
| Example | PC-3 | Cb6-3:75 | Cb7-2:25 | Z1-1-15 | 9.0 | 55.00 | X1-1a | X1-1-14:15 | — |
| S42 | | | | | | | | X1-1-15:15 | |
| Example | PC-4 | Cb6-4:60 | Cb7-2:40 | Z1-1-15 | 9.0 | 55.00 | X1-1b | X1-1-14:15 | — |
| S43 | | | | | | | | X1-1-15:15 | |

| | Charge transport layer | | | | | | |
|---|---|---|---|---|---|---|---|
| | Resin (X) or other lubricating resins | | | Proportion | | Charge | Average |
| | Unit | | | of resin | Mz/Mx × | transport | layer |
| | (X3) | Mw | Content | (X) | 100 | material | thickness |
| | mol % | ×10000 | mass % | mass % | — | — | μm |
| Comparative | X3-1:70 | 15.0 | 5.00 | 8.3 | 0 | CTM-1 | 38 |
| Example | | | | | | | |
| SC6 | | | | | | | |
| Comparative | — | 13.0 | 5.00 | 8.3 | 7.7 | CTM-1 | 38 |
| Example | | | | | | | |
| SC7 | | | | | | | |
| Comparative | X3-2:70 | 15.0 | 5.00 | 8.3 | 7.7 | CTM-1 | 30 |
| Example | | | | | | | |
| SC8 | | | | | | | |
| Example | X3-2:70 | 15.0 | 5.00 | 8.3 | 7.7 | CTM-1 | 38 |
| S40 | | | | | | | |
| Example | X3-2:70 | 15.0 | 5.00 | 8.3 | 7.7 | CTM-1 | 40 |
| S41 | | | | | | | |
| Example | X3-1:70 | 15.0 | 5.00 | 8.3 | 7.7 | CTM-1 | 40 |
| S42 | | | | | | | |
| Example | X3-2:70 | 15.0 | 5.00 | 8.3 | 7.7 | CTM-1 | 40 |
| S43 | | | | | | | |

TABLE 5

| | Single layer type photosensitive layer | | | | | | | | |
|---|---|---|---|---|---|---|---|---|---|
| | | | | | | | Resin (X) or other | | |
| | Polyester resin | | | | | | lubricating resins | | |
| | | Unit | Unit | Structure | | | | Unit | Unit |
| | Resin | (A) | (B) | (Z) | Mw | Content | Resin | (X1) | (X2) |
| | No. | mol% | mol % | — | ×10000 | mass % | No. | mol % | mol % |
| Comparative | PEc1 | A3-2:50 | B4-4:50 | None | 9.5 | 42.25 | X1-1a | X1-1-14:15 | — |
| Example | | | | | | | | X1-1-15:15 | |
| TC1 | | | | | | | | | |
| Comparative | PEz1 | A3-2:50 | B4-4:50 | Z1-1-15 | 10.0 | 42.25 | XC-1 | — | — |
| Example | | | | | | | | | |
| TC2 | | | | | | | | | |
| Comparative | PEz1 | A3-2:50 | B4-4:50 | Z1-1-15 | 10.0 | 42.25 | X1-1b | X1-1-14:15 | — |
| Example | | | | | | | | X1-1-15:15 | |
| TC3 | | | | | | | | | |
| Example T1 | PEz1 | A3-2:50 | B4-4:50 | Z1-1-15 | 10.0 | 42.25 | X1-1b | X1-1-14:15 | — |
| | | | | | | | | X1-1-15:15 | |
| Example T2 | PEz2 | A2-3:50 | B1-4:50 | Z1-1-15 | 11.5 | 42.25 | X1-1a | X1-1-14:15 | — |
| | | | | | | | | X1-1-15:15 | |
| Example T3 | PEz2 | A2-3:50 | B1-4:50 | Z1-1-15 | 11.5 | 42.25 | X1-1d | X1-1-6:30 | — |
| Example T4 | PEz2 | A2-3:50 | B1-4:50 | Z1-1-15 | 11.5 | 42.25 | X1-1f | X1-2-9:30 | — |
| Example T5 | PEz2 | A2-3:50 | B1-4:50 | Z1-1-15 | 11.5 | 42.25 | X1-1g | — | X2-1-10:30 |
| Example T6 | PEz2 | A2-3:50 | B1-4:50 | Z1-1-15 | 11.5 | 42.25 | X1-1k | — | X2-2-4:30 |
| Example T7 | PEz7 | A2-3:50 | B5-1:50 | Z1-1-15 | 10.5 | 42.25 | X1-1a | X1-1-14:15 | — |
| | | | | | | | | X1-1-15:15 | |
| Example T8 | PEz8 | A2-3:50 | B1-2:50 | Z1-1-15 | 11.0 | 42.25 | X1-1a | X1-1-14:15 | — |
| | | | | | | | | X1-1-15:15 | |
| Example T9 | PEz9 | A2-3:50 | B2-6:50 | Z1-1-15 | 10.0 | 42.25 | X1-1b | X1-1-14:15 | — |
| | | | | | | | | X1-1-15:15 | |
| Example | PEz10 | A3-2:50 | B1-2:50 | Z1-1-15 | 11.0 | 42.25 | X1-1a | X1-1-14:15 | — |
| T10 | | | | | | | | X1-1-15:15 | |
| Example | PEz11 | A3-2:40 | B6-4:50 | Z1-1-15 | 9.5 | 42.25 | X1-1a | X1-1-14:15 | — |
| T11 | | A4-3:10 | | | | | | X1-1-15:15 | |
| Example | PEz13 | A2-3:40 | B1-2:50 | Z1-1-15 | 12.0 | 42.25 | X1-1a | X1-1-14:15 | — |
| T12 | | A3-2:10 | | | | | | X1-1-15:15 | |
| Example | PEz2 | A2-3:50 | B1-4:50 | Z1-1-15 | 11.5 | 42.25 | X1-1b | X1-1-14:15 | — |
| T13 | | | | | | | | X1-1-15:15 | |

| | Single layer type photosensitive layer | | | | | | |
|---|---|---|---|---|---|---|---|
| | Resin (X) or other lubricating resins | | | Proportion | | Charge | Average |
| | Unit | | | of resin | Mz/Mx × | transport | layer |
| | (X3) | Mw | Content | (X) | 100 | material | thickness |
| | mol % | ×10000 | mass % | mass % | — | — | μm |
| Comparative | X3-1:70 | 15.0 | 3.50 | 7.7 | 0 | CTM-1 | 37 |
| Example | | | | | | | |
| TC1 | | | | | | | |
| Comparative | — | 13.0 | 3.50 | 7.7 | 6.0 | CTM-1 | 37 |
| Example | | | | | | | |
| TC2 | | | | | | | |
| Comparative | X3-2:70 | 15.0 | 3.50 | 7.7 | 6.0 | CTM-1 | 30 |
| Example | | | | | | | |
| TC3 | | | | | | | |
| Example T1 | X3-2:70 | 15.0 | 3.50 | 7.7 | 6.0 | CTM-1 | 37 |
| Example T2 | X3-1:70 | 15.0 | 3.50 | 7.7 | 6.0 | CTM-1 | 40 |
| Example T3 | X3-2:70 | 11.0 | 3.50 | 7.7 | 6.0 | CTM-1 | 40 |
| Example T4 | X3-2:70 | 15.0 | 3.50 | 7.7 | 6.0 | CTM-1 | 40 |
| Example T5 | X3-2:70 | 15.0 | 3.50 | 7.7 | 6.0 | CTM-1 | 40 |
| Example T6 | X3-2:70 | 15.0 | 3.50 | 7.7 | 6.0 | CTM-1 | 40 |
| Example T7 | X3-1:70 | 15.0 | 3.50 | 7.7 | 6.0 | CTM-1 | 41 |
| Example T8 | X3-1:70 | 15.0 | 3.50 | 7.7 | 6.0 | CTM-1 | 41 |
| Example T9 | X3-2:70 | 15.0 | 3.50 | 7.7 | 6.0 | CTM-1 | 41 |
| Example | X3-1:70 | 15.0 | 3.50 | 7.7 | 6.0 | CTM-1 | 41 |
| T10 | | | | | | | |
| Example | X3-1:70 | 15.0 | 3.50 | 7.7 | 6.0 | CTM-1 | 41 |
| T11 | | | | | | | |
| Example | X3-1:70 | 15.0 | 3.50 | 7.7 | 6.0 | CTM-1 | 41 |
| T12 | | | | | | | |
| Example | X3-2:70 | 15.0 | 3.50 | 7.7 | 6.0 | CTM-3 | 40 |
| T13 | | | | | | | |

TABLE 6

| | Evaluation of image quality | | | | | |
|---|---|---|---|---|---|---|
| | Environmental stability | | | | Long-term environmental stability | |
| | Low-temperature | High-temperature | Image density stability | | Low-temperature | High-temperature |
| | and low-humidity | and high-humidity | AC 10% | AC 1% | and low-humidity | and high-humidity |
| Comparative | D | D | D | D | D | D |
| Example SC1 | | | | | | |
| Comparative | D | D | D | D | D | D |
| Example SC2 | | | | | | |
| Comparative | B | B | B | C | D | D |
| Example SC3 | | | | | | |
| Example S1 | A | A | A | A | B | B |
| Example S2 | A | A | A | A | C | B |
| Example S3 | A | A | A | A | B | B |
| Example S4 | A | A | A | A | B | A |
| Example S5 | A | A | A | A | A | A |
| Example S6 | B | A | A | A | A | A |
| Example S7 | B | B | A | A | A | A |
| Comparative | E | D | D | E | D | D |
| Example SC4 | | | | | | |
| Comparative | C | D | C | D | E | E |
| Example SC5 | | | | | | |
| Example S8 | A | A | A | A | A | A |
| Example S9 | A | A | A | A | B | A |
| Example S10 | A | A | A | A | B | B |
| Example S11 | A | A | A | A | C | B |

TABLE 7

| | Evaluation of image quality | | | | | |
|---|---|---|---|---|---|---|
| | Environmental stability | | | | Long-term environmental stability | |
| | Low-temperature | High-temperature | Image density stability | | Low-temperature | High-temperature |
| | and low-humidity | and high-humidity | AC 10% | AC 1% | and low-humidity | and high-humidity |
| Example S12 | A | A | A | B | A | A |
| Example S13 | A | A | A | B | A | A |
| Example S14 | A | A | A | A | B | A |
| Example S15 | A | A | A | A | A | A |
| Example S16 | A | A | A | A | A | A |
| Example S17 | A | A | A | A | A | B |
| Example S18 | A | A | A | B | A | B |
| Example S19 | A | A | A | A | A | A |
| Example S20 | A | A | A | A | A | A |
| Example S21 | A | A | A | A | A | A |
| Example S22 | A | A | A | A | B | B |
| Example S23 | A | A | A | B | B | A |

TABLE 8

| | Evaluation of image quality | | | | | |
|---|---|---|---|---|---|---|
| | Environmental stability | | | | Long-term environmental stability | |
| | Low-temperature | High-temperature | Image density stability | | Low-temperature | High-temperature |
| | and low-humidity | and high-humidity | AC 10% | AC 1% | and low-humidity | and high-humidity |
| Example S24 | A | A | A | A | B | A |
| Example S25 | A | A | A | A | A | A |
| Example S26 | A | A | A | A | A | A |
| Example S27 | A | A | A | A | A | B |
| Example S28 | B | A | A | A | A | A |
| Example S29 | A | A | A | A | B | B |
| Example S30 | A | A | A | A | B | A |
| Example S31 | B | A | A | A | B | B |
| Example S32 | A | A | A | B | B | A |
| Example S33 | A | A | A | A | B | A |
| Example S34 | A | A | A | A | A | A |
| Example S35 | A | A | A | A | A | A |
| Example S36 | A | A | A | A | A | A |
| Example S37 | A | A | A | A | A | A |
| Example S38 | A | A | A | A | A | A |
| Example S39 | A | A | A | A | A | A |

TABLE 9

| | Evaluation of image quality | | | | | |
|---|---|---|---|---|---|---|
| | Environmental stability | | | | Long-term environmental stability | |
| | Low-temperature | High-temperature | Image density stability | | Low-temperature | High-temperature |
| | and low-humidity | and high-humidity | AC 10% | AC 1% | and low-humidity | and high-humidity |
| Comparative | D | D | D | D | D | D |
| Example SC6 | | | | | | |
| Comparative | D | D | D | D | D | D |
| Example SC7 | | | | | | |
| Comparative | B | B | B | C | D | D |
| Example SC8 | | | | | | |
| Example S40 | A | A | A | A | B | B |
| Example S41 | A | A | A | A | B | B |
| Example S42 | A | A | A | A | B | B |
| Example S43 | A | A | A | A | B | B |

TABLE 10

| | Evaluation of image quality | | | | | |
|---|---|---|---|---|---|---|
| | Environmental stability | | | | Long-term environmental stability | |
| | Low-temperature | High-temperature | Image density stability | | Low-temperature | High-temperature |
| | and low-humidity | and high-humidity | AC 10% | AC 1% | and low-humidity | and high-humidity |
| Comparative | E | D | D | E | E | D |
| Example TC1 | | | | | | |
| Comparative | E | D | D | E | D | D |
| Example TC2 | | | | | | |
| Comparative | D | B | C | D | D | D |
| Example TC3 | | | | | | |
| Example T1 | A | A | A | B | B | B |
| Example T2 | B | A | A | B | B | A |
| Example T3 | B | B | A | B | B | A |
| Example T4 | B | A | A | B | B | A |
| Example T5 | A | B | A | B | B | A |
| Example T6 | A | B | A | B | A | B |
| Example T7 | A | B | A | B | B | B |
| Example T8 | A | B | A | B | B | A |
| Example T9 | A | B | B | B | A | A |
| Example T10 | A | B | A | B | B | B |
| Example T11 | B | B | A | B | B | A |
| Example T12 | A | B | A | B | B | B |
| Example T13 | A | B | A | B | B | A |

(((1)))

An electrophotographic photoreceptor comprising:
a conductive substrate; and
a lamination type photosensitive layer disposed on the conductive substrate and including a charge generation layer and a charge transport layer,
wherein the charge transport layer contains
   a charge transport material,
   at least one of a polyester resin (PEz) or a polycarbonate resin (PCz) that has at least one of a structure (Z1) represented by Formula (Z1) or a structure (Z2) represented by Formula (Z2) at at least one terminal, and
   a resin (X) that has at least one of a unit (X1) represented by Formula (X1) or a unit (X2) represented by Formula (X2),
a mass proportion of the resin (X) in a total amount of the polyester resin (PEz), the polycarbonate resin (PCz), and the resin (X) in the charge transport layer is 0.5% by mass or greater and 30% by mass or less, and
the charge transport layer has an average thickness of greater than 30 μm and less than 50 μm.
(((2)))

The electrophotographic photoreceptor according to (((1))),
wherein the charge transport layer has an average thickness of greater than 35 μm and less than 45 μm.
(((3)))

The electrophotographic photoreceptor according to (((1))) or (((2))),
wherein in a case where a mass of the resin (X) in the charge transport layer is defined as M_{X} and a total mass of the structure (Z1) and the structure (Z2) of the polyester resin (PEz) and the polycarbonate resin (PCz) in the charge transport layer is defined as M_{Z}, M_{Z}/M_{X}×100 is 1 or greater and 400 or less.
(((4)))

The electrophotographic photoreceptor according to any one of (((1))) to (((3))),
wherein in Formula (X1), n represents an integer of 5 or greater and 150 or less.
(((5)))

The electrophotographic photoreceptor according to any one of (((1))) to (((4))),
wherein the unit (X1) represented by Formula (X1) includes at least one of a unit (X1-1) represented by Formula (X1-1) or a unit (X1-2) represented by Formula (X1-2), and
the unit (X2) represented by Formula (X2) includes at least one of a unit (X2-1) represented by Formula (X2-1) or a unit (X2-2) represented by Formula (X2-2).
(((6)))

The electrophotographic photoreceptor according to (((5))),
wherein in Formula (X1-1), n represents an integer of 5 or greater and 150 or less, and
in Formula (X1-2), n represents an integer of 5 or greater and 150 or less.
(((7)))

The electrophotographic photoreceptor according to any one of (((1))) to (((6))),
wherein the structure (Z1) represented by Formula (Z1) includes a structure (Z1-1) represented by Formula (Z1-1), and
the structure (Z2) represented by Formula (Z2) includes a structure (Z2-1) represented by Formula (Z2-1).
(((8)))

The electrophotographic photoreceptor according to any one of (((1))) to (((7))),
wherein the polyester resin (PEz) includes a polyester resin (1z) having a dicarboxylic acid unit (A) represented by Formula (A) and a diol unit (B) represented by Formula (B) and having at least one of the structure (Z1) or the structure (Z2) at at least one terminal.
(((9)))

The electrophotographic photoreceptor according to (((8))),
wherein the dicarboxylic acid unit (A) represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), and a dicarboxylic acid unit (A4) represented Formula (A4).
(((10)))

The electrophotographic photoreceptor according to (((8))) or (((9))),
wherein the diol unit (B) represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).
(((11)))

The electrophotographic photoreceptor according to any one of (((1))) to (((10))),
wherein the polycarbonate resin (PCz) includes a polycarbonate resin (1z) having a constitutional unit (C) represented by Formula (C) and having at least one of the structure (Z1) or the structure (Z2) at at least one terminal.
(((12)))

The electrophotographic photoreceptor according to (((11))),
wherein the constitutional unit (C) represented by Formula (C) includes at least one selected from the group consisting of a constitutional unit (Cb1) represented by Formula (Cb1), a constitutional unit (Cb2) represented by Formula (Cb2), a constitutional unit (Cb3) represented by Formula (Cb3), a constitutional unit (Cb4) represented by Formula (Cb4), a constitutional unit (Cb5) represented by Formula (Cb5), a constitutional unit (Cb6) represented by Formula (Cb6), a constitutional unit (Cb7) represented by Formula (Cb7), and a constitutional unit (Cb8) represented by Formula (Cb8).
(((13)))

The electrophotographic photoreceptor according to any one of (((1))) to (((12))),
wherein the charge transport layer contains the polyester resin (PEz).
(((14)))

An electrophotographic photoreceptor comprising:
a conductive substrate; and
a single layer type photosensitive layer disposed on the conductive substrate,
wherein the single layer type photosensitive layer contains
   a charge transport material,
   at least one of a polyester resin (PEz) or a polycarbonate resin (PCz) that has at least one of a structure (Z1) represented by Formula (Z1) or a structure (Z2) represented by Formula (Z2) at at least one terminal, and
   a resin (X) that has at least one of a unit (X1) represented by Formula (X1) or a unit (X2) represented by Formula (X2),
a mass proportion of the resin (X) in a total amount of the polyester resin (PEz), the polycarbonate resin (PCz), and the resin (X) in the single layer type photosensitive layer is 0.5% by mass or greater and 30% by mass or less, and
the single layer type photosensitive layer has an average thickness of greater than 30 m and less than 50 μm.
(((15)))

The electrophotographic photoreceptor according to (((14))),
wherein the single layer type photosensitive layer has an average thickness of greater than 35 μm and less than 45 μm.
(((16)))

The electrophotographic photoreceptor according to (((14))) or (((15))),
wherein in a case where a mass of the resin (X) in the single layer type photosensitive layer is defined as M_{X} and a total mass of the structure (Z1) and the structure (Z2) of the polyester resin (PEz) and the polycarbonate resin (PCz) in the single layer type photosensitive layer is defined as M_{Z}, M_{Z}/M_{X}×100 is 1 or greater and 400 or less.
(((17)))

The electrophotographic photoreceptor according to any one of (((14))) to (((16))),
wherein in Formula (X1), n represents an integer of 5 or greater and 150 or less.
(((18)))

The electrophotographic photoreceptor according to any one of (((14))) to (((17))),
wherein the unit (X1) represented by Formula (X1) includes at least one of a unit (X1-1) represented by Formula (X1-1) or a unit (X1-2) represented by Formula (X1-2), and
the unit (X2) represented by Formula (X2) includes at least one of a unit (X2-1) represented by Formula (X2-1) or a unit (X2-2) represented by Formula (X2-2).
(((19)))

The electrophotographic photoreceptor according to (((18))),
wherein in Formula (X1-1), n represents an integer of 5 or greater and 150 or less, and
in Formula (X1-2), n represents an integer of 5 or greater and 150 or less.
(((20)))

The electrophotographic photoreceptor according to any one of (((14))) to (((19))),
wherein the structure (Z1) represented by Formula (Z1) includes a structure (Z1-1) represented by Formula (Z1-1), and
the structure (Z2) represented by Formula (Z2) includes a structure (Z2-1) represented by Formula (Z2-1).
(((21)))

The electrophotographic photoreceptor according to any one of (((14) to (((20))),
wherein the polyester resin (PEz) includes a polyester resin (1z) having a dicarboxylic acid unit (A) represented by Formula (A) and a diol unit (B) represented by Formula (B) and having at least one of the structure (Z1) or the structure (Z2) at at least one terminal.
(((22)))

The electrophotographic photoreceptor according to (((21))),
wherein the dicarboxylic acid unit (A) represented by Formula (A) includes at least one selected from the group consisting of a dicarboxylic acid unit (A1) represented by Formula (A1), a dicarboxylic acid unit (A2) represented by Formula (A2), a dicarboxylic acid unit (A3) represented by Formula (A3), and a dicarboxylic acid unit (A4) represented Formula (A4).
(((23)))

The electrophotographic photoreceptor according to (((21))) or (((22))),
wherein the diol unit (B) represented by Formula (B) includes at least one selected from the group consisting of a diol unit (B1) represented by Formula (B1), a diol unit (B2) represented by Formula (B2), a diol unit (B3) represented by Formula (B3), a diol unit (B4) represented by Formula (B4), a diol unit (B5) represented by Formula (B5), a diol unit (B6) represented by Formula (B6), a diol unit (B7) represented by Formula (B7), and a diol unit (B8) represented by Formula (B8).
(((24)))

The electrophotographic photoreceptor according to any one of (((14)))) to (((23))),
wherein the polycarbonate resin (PCz) includes a polycarbonate resin (1z) having a constitutional unit (C) represented by Formula (C) and having at least one of the structure (Z1) or the structure (Z2) at at least one terminal.
(((25)))

The electrophotographic photoreceptor according to (((24))),
wherein the constitutional unit (C) represented by Formula (C) includes at least one selected from the group consisting of a constitutional unit (Cb1) represented by Formula (Cb1), a constitutional unit (Cb2) represented by Formula (Cb2), a constitutional unit (Cb3) represented by Formula (Cb3), a constitutional unit (Cb4) represented by Formula (Cb4), a constitutional unit (Cb5) represented by Formula (Cb5), a constitutional unit (Cb6) represented by Formula (Cb6), a constitutional unit (Cb7) represented by Formula (Cb7), and a constitutional unit (Cb8) represented by Formula (Cb8).
(((26)))

The electrophotographic photoreceptor according to any one of (((14))) to (((25))),
wherein the single layer type photosensitive layer contains the polyester resin (PEz).

(((27)))

A process cartridge comprising:
the electrophotographic photoreceptor according to any one of (((1))) to (((26))),
wherein the process cartridge is attachable to and detachable from an image forming apparatus.
(((28)))

An image forming apparatus comprising:
the electrophotographic photoreceptor according to any one of (((1))) to (((26)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate; and
a lamination type photosensitive layer disposed on the conductive substrate and including a charge generation layer and a charge transport layer,
wherein the charge transport layer contains
a charge transport material,
at least one of a polyester resin (PEz) or a polycarbonate resin (PCz) that has at least one of a structure (Z1) represented by Formula (Z1) or a structure (Z2) represented by Formula (Z2) at at least one terminal, and
a resin (X) that has at least one of a unit (X1) represented by Formula (X1) or a unit (X2) represented by Formula (X2),
a mass proportion of the resin (X) in a total amount of the polyester resin (PEz), the polycarbonate resin (PCz), and the resin (X) in the charge transport layer is 0.5% by mass or greater and 30% by mass or less, and
the charge transport layer has an average thickness of greater than 30 μm and less than 50 μm, 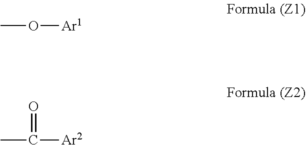
in Formula (Z1), Ar¹ represents an aromatic ring that may have a substituent,
in Formula (Z2), Ar² represents an aromatic ring that may have a substituent, 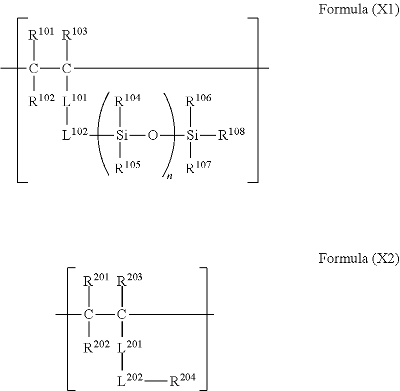
in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), R¹⁰⁹, R¹¹, R¹¹¹, R¹¹², and R¹¹³ each independently represent an alkyl group having 1 or more and 5 or less carbon atoms, and m represents an integer of 0 or greater and 20 or less,
in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

2. The electrophotographic photoreceptor according to claim 1,
wherein the charge transport layer has an average thickness of greater than 35 μm and less than 45 μm.

3. The electrophotographic photoreceptor according to claim 1,
wherein in a case where a mass of the resin (X) in the charge transport layer is defined as M_{X} and a total mass of the structure (Z1) and the structure (Z2) of the polyester resin (PEz) and the polycarbonate resin (PCz) in the charge transport layer is defined as M_{Z}, M_{Z}/M_{X}×100 is 1 or greater and 400 or less.

4. The electrophotographic photoreceptor according to claim 1,
wherein in Formula (X1), n represents an integer of 5 or greater and 150 or less.

5. The electrophotographic photoreceptor according to claim 1,
wherein the unit (X1) represented by Formula (X1) includes at least one of a unit (X1-1) represented by Formula (X1-1) or a unit (X1-2) represented by Formula (X1-2), and
the unit (X2) represented by Formula (X2) includes at least one of a unit (X2-1) represented by Formula (X2-1) or a unit (X2-2) represented by Formula (X2-2), 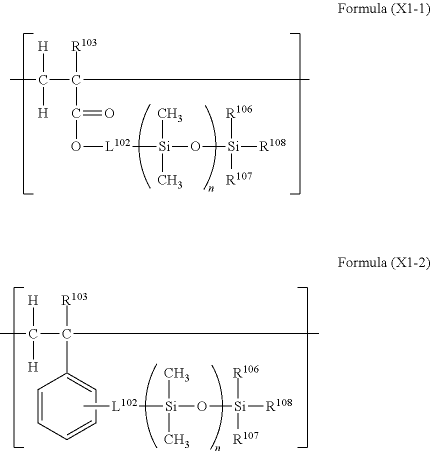
in Formulae (X1-1) and (X1-2), R¹⁰³ represents a hydrogen atom or a methyl group, L¹⁰² represents a single bond, an alkylene group having 1 or more and 5 or less carbon atoms, —O—, —C(═O)—, —C(═O)O—, or a combination thereof, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹⁰⁰)O]ₘ—Si(R¹¹¹)(R¹¹²)(R¹¹³), and R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less, 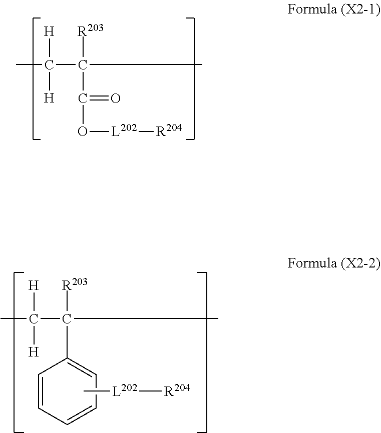
in Formulae (X2-1) and (X2-2), R²⁰³ represents a hydrogen atom or a methyl group, L²⁰² represents a single bond, an alkylene group having 1 or more and 5 or less carbon atoms, —O—, —C(═O)—, —C(═O)O—, or a combination thereof, and R²⁰⁴ represents an alkyl group having 6 or more and 30 or less carbon atoms.

6. The electrophotographic photoreceptor according to claim 5,
wherein in Formula (X1-1), n represents an integer of 5 or greater and 150 or less, and
in Formula (X1-2), n represents an integer of 5 or greater and 150 or less.

7. The electrophotographic photoreceptor according to claim 1,
wherein the structure (Z1) represented by Formula (Z1) includes a structure (Z1-1) represented by Formula (Z1-1), and
the structure (Z2) represented by Formula (Z2) includes a structure (Z2-1) represented by Formula (Z2-1), 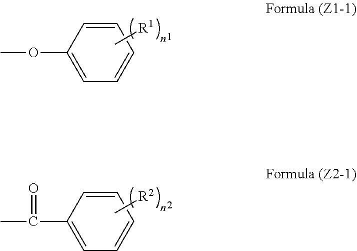
in Formula (Z1-1), n¹ represents an integer of 0 or greater and 5 or less, and n¹ number of R¹'s each independently represent an alkyl group having 1 or more and 5 or less carbon atoms, an alkoxy group having 1 or more and 5 or less carbon atoms, or a phenyl group,
in Formula (Z2-1), n² represents an integer of 0 or greater and 5 or less, and n² number of R²'s each independently represent an alkyl group having 1 or more and 5 or less carbon atoms, an alkoxy group having 1 or more and 5 or less carbon atoms, or a phenyl group.

8. The electrophotographic photoreceptor according to claim 1,
wherein the polyester resin (PEz) includes a polyester resin (1z) having a dicarboxylic acid unit (A) represented by Formula (A) and a diol unit (B) represented by Formula (B) and having at least one of the structure (Z1) or the structure (Z2) at at least one terminal, 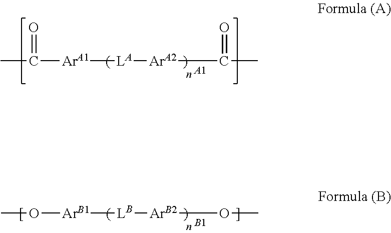
in Formula (A), Ar^{A1} and Ar^{A2} each independently represent an aromatic ring that may have a substituent, L^{A} represents a single bond or a divalent linking group, and n^{A1} represents 0, 1, or 2,
in Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2, where Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

9. The electrophotographic photoreceptor according to claim 1,
wherein the polycarbonate resin (PCz) includes a polycarbonate resin (1z) having a constitutional unit (C) represented by Formula (C) and having at least one of the structure (Z1) or the structure (Z2) at at least one terminal, 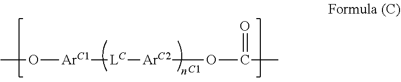
in Formula (C), Ar^{C1} and Ar^{C2} each independently represent an aromatic ring that may have a substituent, L^{C} represents a single bond or a divalent linking group, and n^{C1} represents 0, 1, or 2.

10. An electrophotographic photoreceptor comprising:
a conductive substrate; and
a single layer type photosensitive layer disposed on the conductive substrate,
wherein the single layer type photosensitive layer contains
a charge transport material,
at least one of a polyester resin (PEz) or a polycarbonate resin (PCz) that has at least one of a structure (Z1) represented by Formula (Z1) or a structure (Z2) represented by Formula (Z2) at at least one terminal, and
a resin (X) that has at least one of a unit (X1) represented by Formula (X1) or a unit (X2) represented by Formula (X2),
a mass proportion of the resin (X) in a total amount of the polyester resin (PEz), the polycarbonate resin (PCz), and the resin (X) in the single layer type photosensitive layer is 0.5% by mass or greater and 30% by mass or less, and
the single layer type photosensitive layer has an average thickness of greater than 30 μm and less than 50 μm, 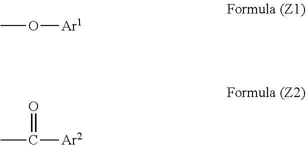
in Formula (Z1), Ar¹ represents an aromatic ring that may have a substituent,
in Formula (Z2), Ar² represents an aromatic ring that may have a substituent, 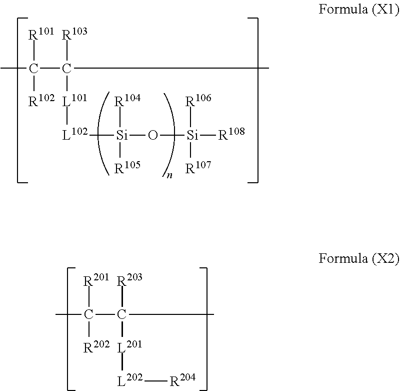
in Formula (X1), R¹⁰¹, R¹⁰², and R¹⁰³ each independently represent a hydrogen atom or an alkyl group having 1 or more and 5 or less carbon atoms, L¹⁰¹ represents a single bond, an alkylene group having 1 or more and 5 or less carbon atoms, —O—, —C(═O)—, —C(═O)O—, an aromatic ring that may have a substituent, or a combination thereof, L¹⁰² represents a single bond, an alkylene group having 1 or more and 5 or less carbon atoms, —O—, —C(═O)—, —C(═O)O—, or a combination thereof, R¹⁰⁴ and R¹⁰⁵ each independently represent an alkyl group having 1 or more and 5 or less carbon atoms, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹¹⁰)O]ₘ—Si(R¹¹¹)(R¹¹²)(R¹¹³), R¹⁰⁹, R¹¹⁰, R¹¹¹, R¹², and R¹¹³ each independently represent an alkyl group having 1 or more and 5 or less carbon atoms, and m represents an integer of 0 or greater and 20 or less,
in Formula (X2), R²⁰¹, R²⁰², and R²⁰³ each independently represent a hydrogen atom or an alkyl group having 1 or more and 5 or less carbon atoms, L²⁰¹ represents a single bond, an alkylene group having 1 or more and 5 or less carbon atoms, —O—, —C(═O)—, —C(═O)O—, an aromatic ring that may have a substituent, or a combination thereof, L²⁰² represents a single bond, an alkylene group having 1 or more and 5 or less carbon atoms, —O—, —C(═O)—, —C(═O)O—, or a combination thereof, and R²⁰⁴ is an alkyl group having 6 or more and 30 or less carbon atoms.

11. The electrophotographic photoreceptor according to claim 10,
wherein the single layer type photosensitive layer has an average thickness of greater than 35 μm and less than 45 μm.

12. The electrophotographic photoreceptor according to claim 10,
wherein in a case where a mass of the resin (X) in the single layer type photosensitive layer is defined as M_{X} and a total mass of the structure (Z1) and the structure (Z2) of the polyester resin (PEz) and the polycarbonate resin (PCz) in the single layer type photosensitive layer is defined as M_{Z}, M_{Z}/M_{X}×100 is 1 or greater and 400 or less.

13. The electrophotographic photoreceptor according to claim 10,
wherein in Formula (X1), n represents an integer of 5 or greater and 150 or less.

14. The electrophotographic photoreceptor according to claim 10,
wherein the unit (X1) represented by Formula (X1) includes at least one of a unit (X1-1) represented by Formula (X1-1) or a unit (X1-2) represented by Formula (X1-2), and
the unit (X2) represented by Formula (X2) includes at least one of a unit (X2-1) represented by Formula (X2-1) or a unit (X2-2) represented by Formula (X2-2), 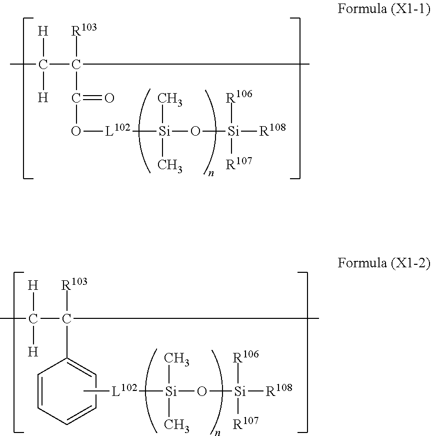
in Formulae (X1-1) and (X1-2), R¹⁰³ represents a hydrogen atom or a methyl group, L¹⁰² represents a single bond, an alkylene group having 1 or more and 5 or less carbon atoms, —O—, —C(═O)—, —C(═O)O—, or a combination thereof, n represents an integer of 0 or greater and 300 or less, R¹⁰⁶, R¹⁰⁷, and R¹⁰⁸ each independently represent an alkyl group having 1 or more and 5 or less carbon atoms or —O—[Si(R¹⁰⁹)(R¹⁰⁰)O]ₘ—Si(R¹¹¹)(R¹¹²)(R¹¹³), and R¹⁰⁹, R¹¹⁰, R¹¹¹, R¹¹², and R¹¹³ each independently represent an alkyl group having 1 or more and 5 or less carbon atoms, and m represents an integer of 0 or greater and 20 or less, 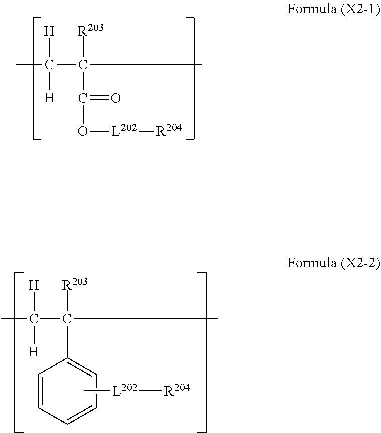
in Formulae (X2-1) and (X2-2), R²⁰³ represents a hydrogen atom or a methyl group, L²⁰² represents a single bond, an alkylene group having 1 or more and 5 or less carbon atoms, —O—, —C(═O)—, —C(═O)O—, or a combination thereof, and R²⁰⁴ represents an alkyl group having 6 or more and 30 or less carbon atoms.

15. The electrophotographic photoreceptor according to claim 14,
wherein in Formula (X1-1), n represents an integer of 5 or greater and 150 or less, and
in Formula (X1-2), n represents an integer of 5 or greater and 150 or less.

16. The electrophotographic photoreceptor according to claim 10,
wherein the structure (Z1) represented by Formula (Z1) includes a structure (Z1-1) represented by Formula (Z1-1), and
the structure (Z2) represented by Formula (Z2) includes a structure (Z2-1) represented by Formula (Z2-1), 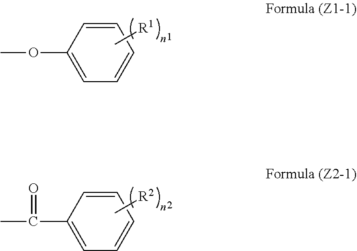
in Formula (Z1-1), n¹ represents an integer of 0 or greater and 5 or less, and n¹ number of R¹'s each independently represent an alkyl group having 1 or more and 5 or less carbon atoms, an alkoxy group having 1 or more and 5 or less carbon atoms, or a phenyl group,
in Formula (Z2-1), n² represents an integer of 0 or greater and 5 or less, and n² number of R²'s each independently represent an alkyl group having 1 or more and 5 or less carbon atoms, an alkoxy group having 1 or more and 5 or less carbon atoms, or a phenyl group.

17. The electrophotographic photoreceptor according to claim 10,
wherein the polyester resin (PEz) includes a polyester resin (1z) having a dicarboxylic acid unit (A) represented by Formula (A) and a diol unit (B) represented by Formula (B) and having at least one of the structure (Z1) or the structure (Z2) at at least one terminal, 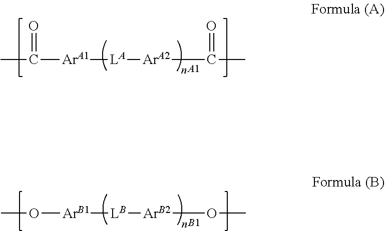
in Formula (A), Ar^{A1} and Ar^{A2} each independently represent an aromatic ring that may have a substituent, L^{A} represents a single bond or a divalent linking group, and n^{A1} represents 0, 1, or 2,
in Formula (B), Ar^{B1} and Ar^{B2} each independently represent an aromatic ring that may have a substituent, L^{B} represents a single bond, an oxygen atom, a sulfur atom, or —C(Rb¹)(Rb²)—, and n^{B1} represents 0, 1, or 2, where Rb¹ and Rb² each independently represent a hydrogen atom, an alkyl group having 1 or more and 20 or less carbon atoms, an aryl group having 6 or more and 12 or less carbon atoms, or an aralkyl group having 7 or more and 20 or less carbon atoms, and Rb¹ and Rb² may be bonded to each other to form a cyclic alkyl group.

18. The electrophotographic photoreceptor according to claim 10,
wherein the polycarbonate resin (PCz) includes a polycarbonate resin (1z) having a constitutional unit (C) represented by Formula (C) and having at least one of the structure (Z1) or the structure (Z2) at at least one terminal, 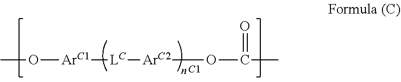
in Formula (C), Arci and Ar^{C2} each independently represent an aromatic ring that may have a substituent, L^{C} represents a single bond or a divalent linking group, and n^{C1} represents 0, 1, or 2.

19. A process cartridge comprising:
the electrophotographic photoreceptor according to claim 1,
wherein the process cartridge is attachable to and detachable from an image forming apparatus.

20. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
